(19) United States
(12) Patent Application Publication
(10) Pub. No.: US 2013/0141484 A1
(43) Pub. Date: Jun. 6, 2013

(54) LIQUID EJECTION INSPECTION DEVICE AND LIQUID EJECTION INSPECTION METHOD

(71) Applicant: Seiko Epson Corporation, Tokyo (JP)

(72) Inventors: Tsuneo KASAI, Suwa (JP); Osamu SHINKAWA, Chino (JP); Toshio KUMAGAI, Shiojiri (JP); Yasuhiro HOSOKAWA, Shiojiri (JP); Toshiyuki SUZUKI, Shiojiri (JP); Seiji IZUO, Suwa (JP)

(73) Assignee: SEIKO EPSON CORPORATION, Tokyo (JP)

(21) Appl. No.: 13/683,533

(22) Filed: Nov. 21, 2012

(30) Foreign Application Priority Data
Nov. 25, 2011 (JP) 2011-257169
Nov. 25, 2011 (JP) 2011-257998
Nov. 25, 2011 (JP) 2011-257999

(51) Int. Cl. B41J 2/125

(52) U.S. Cl. CPC B41J 2/125
USPC 347/14

(57) ABSTRACT

A liquid ejection device includes a head, a first sensor, a second sensor, a recovery unit, and a controller. The head is configured to eject liquid on a medium. The first sensor is configured to detect liquid ejection of the head by using a first principle. The second sensor is configured to detect the liquid ejection by using a second principle being different from the first principle. The recovery unit is configured to recover the liquid ejection of the head. The controller is configured to control the first sensor and the second sensor, and control the recovery unit based on a first detection result by the first sensor and a second detection result by the second detector.

### CROSS-REFERENCE TO RELATED APPLICATIONS

This application claims priority to Japanese Patent Application No. 2011-257169 filed on Nov. 25, 2011, Japanese Patent Application No. 2011-257998 filed on Nov. 25, 2011, and Japanese Patent Application No. 2011-257999 filed on Nov. 25, 2011. The entire disclosure of Japanese Patent Application Nos. 2011-257169, 2011-257998 and 2011-257999 is hereby incorporated herein by reference.

### BACKGROUND

1. Technical Field

The present invention relates to a liquid ejection inspection device and a liquid ejection inspection method.

2. Background Technology

Printing devices such as inkjet printers or the like which have a head for forming a printed image by ejecting a liquid such as ink or the like on various types of media such as paper, film, or the like, and a sensor for reading the printed image formed by the head (e.g. a scanner or the like) are known (see Patent Document 1, for example).

Japanese Laid-open Patent Application No. 2010-240911 (Patent Document 1) is an example of the related art.

### SUMMARY

### Problems to Be Solved by the Invention

With this inkjet printer, there are cases when the nozzle becomes clogged and the liquid drops cannot be sprayed (ejection failure). Because of this, dot omission occurs, causing a degradation of the printed image.

As one ejection inspection for detecting this kind of ejection failure, there is ejection inspection which reads the printed image with a scanner, compares the read data read using the scanner with reference data, and detects nozzle ejection failure. However, with this ejection inspection, though it is possible to inspect during printing, it was difficult to do inspection for each nozzle because printed images with a plurality of colors of dots overlapping were read by the scanner.

The invention was created taking into consideration these circumstances, and an advantage is to compensate for the disadvantages of the ejection inspection using a sensor that performs inspection using one certain principle.

### Means Used to Solve the Above-Mentioned Problems

The invention was created to address at least a portion of the problems described above, and it can be realized as the following modes or application examples.

A liquid ejection device includes a head, a first sensor, a second sensor, a recovery unit, and a controller. The head is configured to eject liquid on a medium. The first sensor is configured to detect liquid ejection of the head by using a first principle. The second sensor is configured to detect the liquid ejection by using a second principle being different from the first principle. The recovery unit is configured to recover the liquid ejection of the head. The controller is configured to control the first sensor and the second sensor, and control the recovery unit based on a first detection result by the first sensor and a second detection result by the second detector.

### BRIEF DESCRIPTION OF THE DRAWINGS

Referring now to the attached drawings which form a part of this original disclosure:

FIG. 1 is a block diagram showing the printer configuration;

FIG. 2 is a schematic diagram showing the printer configuration;

FIG. 3 is a drawing showing the array of a plurality of heads;

FIG. 4 is a cross section view of a head;

FIG. 5 is a drawing showing the nozzle array of the head;

FIG. 6 is a drawing for describing the nozzle array and the dot formation state;

FIG. 7 is a drawing showing a printed image when ejection failure occurred;

FIG. 8 is an enlarged view of the dot failure location enclosed by a square frame in FIG. 7;

FIG. 9 is a drawing for describing read data for which a printed image is read by a scanner when the scan rate is 7 ms;

FIG. 10 is a drawing showing the read image for which a printed image shown in FIG. 7 was read by scanner 71;

FIG. 11 is an enlarged view of the dot failure location enclosed by a square frame in FIG. 10;

FIG. 12 is a drawing explaining an example of a second detection unit;

With FIG. 13, FIG. 13A shows signals output according to the residual vibration of a piezoelement, FIG. 13B shows signals output after the operating amp output has passed through a high pass filter consisting of capacitors and resistors, and FIG. 13C shows signals output after passing through a comparator;

With FIG. 14, FIG. 14A shows the state when air bubbles are mixed in, FIG. 14B shows the state when dried and thickened, and FIG. 14C shows the state with paper dust adhered to the nozzle;

FIG. 15 is a flow chart showing an operating example of dot omission detection;

FIG. 16 is a drawing for describing the judgment conditions for the dot omission detection operation;

With FIG. 17, FIG. 17A through FIG. 17D are drawings showing a comparison of the arrangement of abnormal nozzles with the first detection process and the arrangement of abnormal nozzles with the second detection process;

With FIG. 18, FIG. 18A is a block diagram for describing another example of a second inspection unit 80, and FIG. 18B is a block diagram for describing a detection control unit 87;

With FIG. 19, FIG. 19A is a drawing showing the drive signal, and FIG. 19B and FIG. 19C are drawings for describing voltage signals output from an amplifier;

FIG. 20 is a block diagram showing an example of a printer configuration;

FIG. 21 is a schematic diagram showing an example of a printer configuration;

FIG. 22 is a drawing showing an array of a plurality of heads;

With FIG. 23, FIG. 23A is a drawing showing a cross section of a head, and

FIG. 23B is a drawing showing a nozzle array;

FIG. 24 is a drawing for describing an inspection unit within a head;

With FIG. 25, FIG. 25A is a drawing showing signals output according to the residual vibration of a piezoelement, FIG. 25B is a drawing showing signals output after the operating amp output has passed through a high pass filter consisting of capacitors and resistors, and FIG. 25C is a drawing showing signals output after passing through a comparator;

With FIG. 26, FIG. 26A is a block diagram for describing a head external inspection unit, and FIG. 26B is a block diagram for describing a detection control unit;

With FIG. 27, FIG. 27A is a drawing showing a drive signal, and FIG. 27B and FIG. 27C are drawings for describing the voltage signal output from an amplifier;

FIG. 28 is a flow chart showing an example of the dot omission inspection operation;

With FIG. 29, FIG. 29A is a drawing showing the state with air bubbles mixed in, FIG. 29B shows the dried and thickened state, and FIG. 29C is a drawing showing a state with paper dust adhered to the nozzle;

FIG. 30 is a schematic drawing showing another printer configuration example;

With FIG. 31, FIG. 31A is a drawing showing an example of an inspection pattern, and FIG. 31B is a drawing of the inspection pattern shown in FIG. 31A seen macroscopically;

FIG. 32 is a block diagram showing an example of a printer configuration;

With FIG. 33, FIG. 33A is a drawing showing the cross section of a head, and

FIG. 33B is a drawing showing an array of nozzles;

With FIG. 34, FIG. 34A to FIG. 34C are drawings showing the positional relationship of the head and the ink suction unit;

FIG. 35 is a schematic plan view showing a cap configuration;

With FIG. 36, FIG. 36A and FIG. 36B are drawings showing the positional relationship between a head and a wiping unit;

FIG. 37 is a drawing for describing an inspection unit within a head;

With FIG. 38, FIG. 38A is a drawing showing signals output according to the residual vibration of a piezoelement, FIG. 38B is a drawing showing signals output after operating amp output passes through a high pass filter consisting of capacitors and resistors, and FIG. 38C is a drawing showing signals output after passing through a comparator;

With FIG. 39, FIG. 39A is a block diagram for describing a head external inspection unit, and FIG. 39B is a block diagram for describing a detection control unit;

With FIG. 40, FIG. 40A is a drawing showing drive signals, and FIG. 40B and FIG. 40C are drawings for describing voltage signals output from an amplifier;

With FIG. 41, FIG. 41A is a drawing showing the state with air bubbles mixed in, FIG. 41B is a drawing showing the dried and thickened state, FIG. 41C is a drawing showing the state with paper dust adhered to a nozzle, and FIG. 41D is a drawing showing the state with paper dust adhered near a nozzle;

FIG. 42 is a flow chart showing an example of the dot omission inspection operation; and

FIG. 43 is a drawing for describing the judgment conditions for the dot omission inspection operation.

### DETAILED DESCRIPTION OF EXEMPLARY EMBODIMENTS

Following, we will describe embodiments of the invention while referring to the drawings.

### First Embodiment

### Liquid Ejection Inspection Device

The liquid ejection inspection device is used in a state incorporated in the printing device. For in-process use, it can also be constituted as a dedicated device. With embodiment 1 described hereafter, we will describe a liquid ejection inspection device incorporated in a printing device. In specific terms, we will describe an example of an inkjet printer 1 (hereafter also simply called “printer 1”). In this case, the printer 1 is an example of a printing device, and is also an example of a liquid ejection inspection device.

### Printer 1 Configuration Example

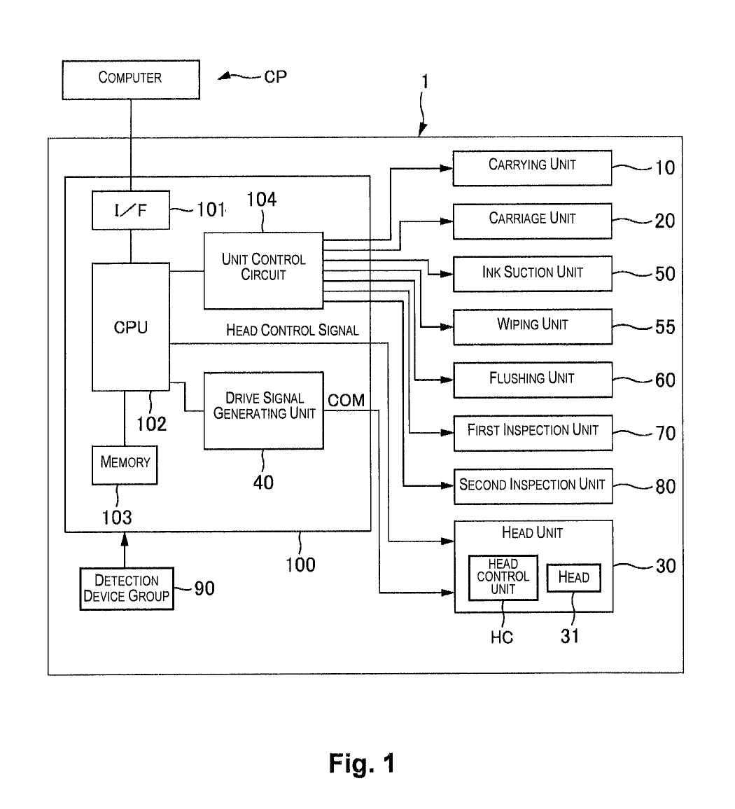

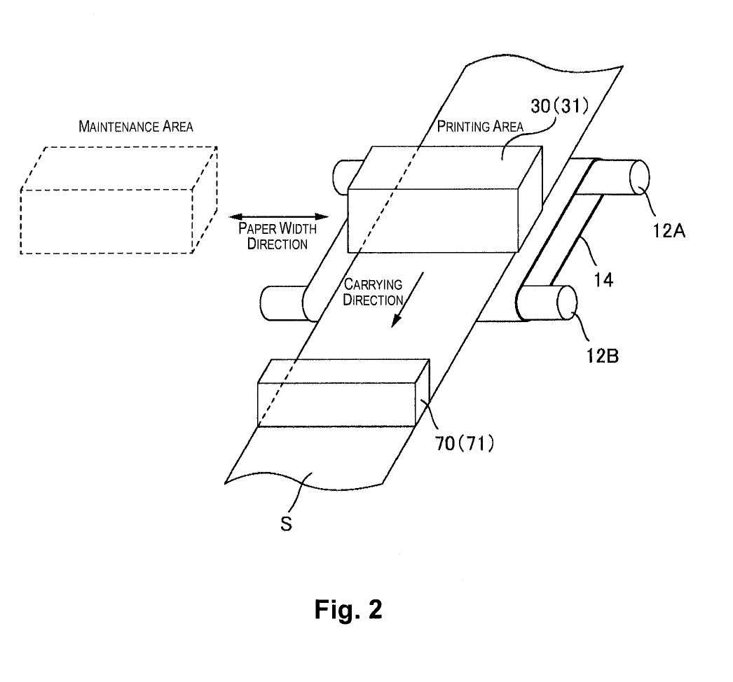

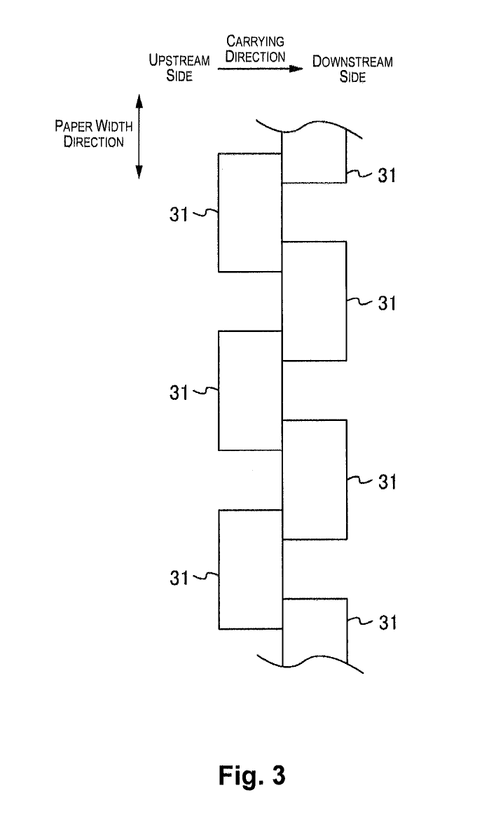

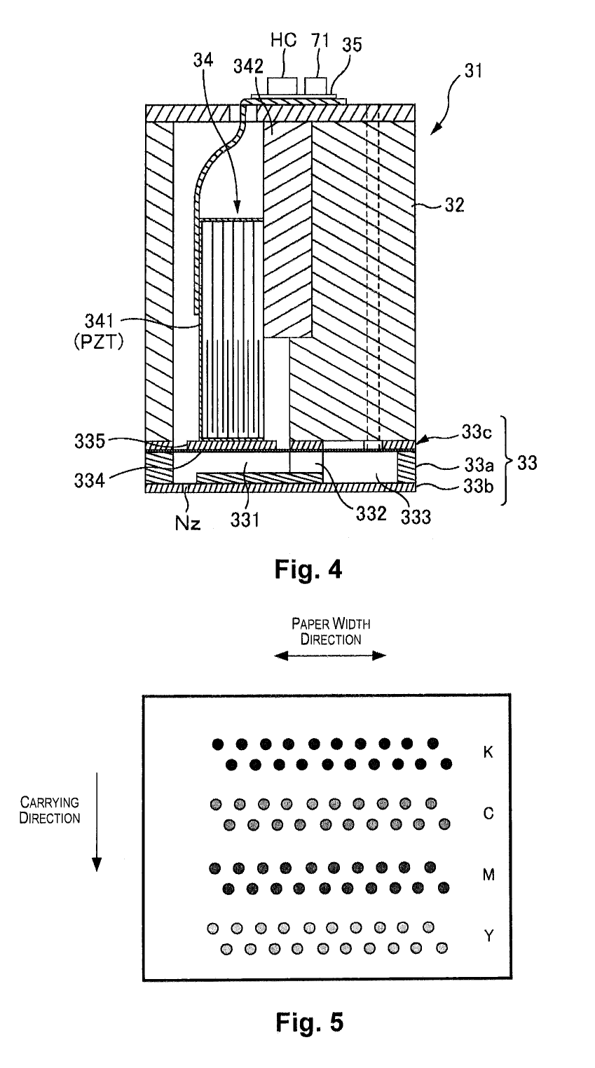

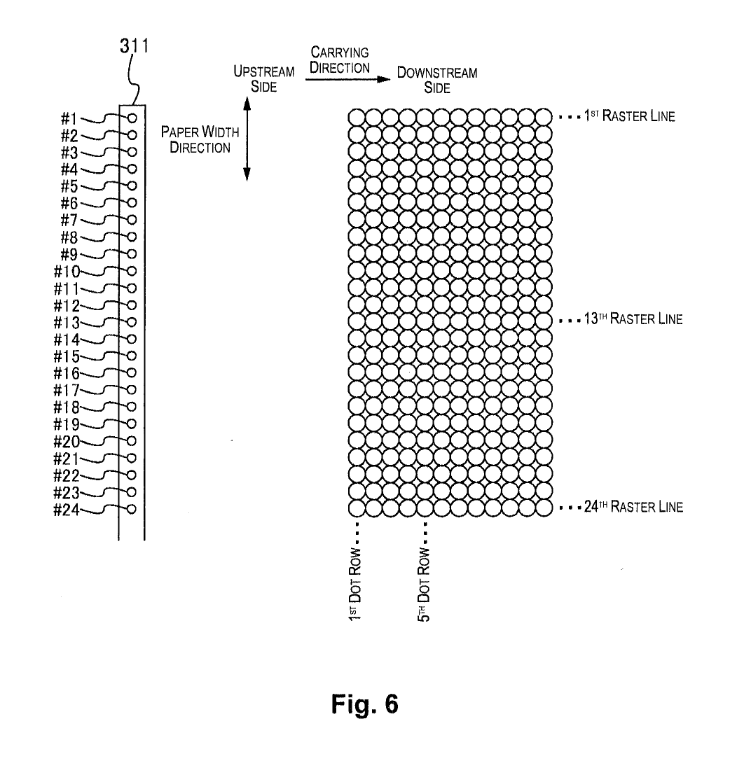

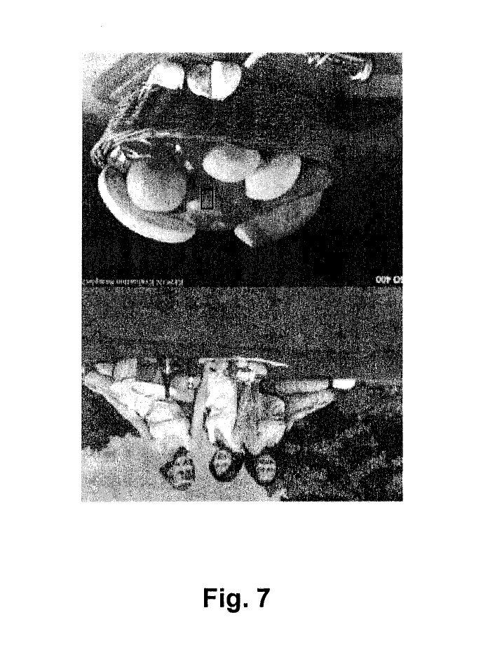

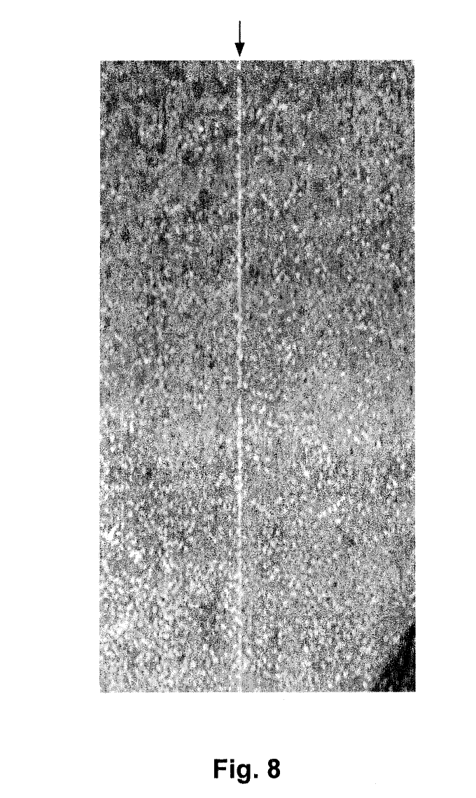

We will describe the printer 1 configuration example using FIG. 1 through FIG. 8. FIG. 1 is a block diagram of the printer 1. FIG. 2 is a schematic diagram showing the configuration of the printer 1. FIG. 3 is a drawing showing an array of a plurality of heads 31. FIG. 4 is a cross section diagram of the head 31. FIG. 5 is a drawing showing a nozzle array of the head 31. FIG. 6 is an explanatory drawing showing the nozzle arrangement and dot formation state for a simplified explanation. FIG. 7 is a drawing showing the printed image when ejection failure occurs. FIG. 8 is an enlarged view of the dot failure location enclosed by a square frame in FIG. 7.

The printer 1 ejects ink as an example of a liquid toward a medium such as paper, cloth, film, or the like, and is connected so as to be able to communicate with a computer CP. In order to have the printer 1 print an image, the computer CP can send printing data according to that image to the printer 1.

As shown in FIG. 1, the printer 1 of this embodiment has a carrier unit 10, a carriage unit 20, a head unit 30, a drive signal generating unit 40, an ink suction unit 50, a wiping unit 55, a flushing unit 60, a first inspection unit 70, a second inspection unit 80, a detection device group 90, and a controller 100 that controls these units and the like, and manages their operation as the printer 1.

The carrier unit 10 is for carrying a medium (e.g. continuous form S or the like) in a designated direction (hereafter referred to as the “carrier direction”). As shown in FIG. 2, this carrier unit 10 has an upstream side roller 12A, a downstream side roller 12B, and a belt 14. When a carrier motor (not illustrated) rotates, the upstream side roller 12A and the downstream side roller 12B rotate, so the belt 14 rotates. The paper-fed continuous form S is carried to an area at which it is possible to execute the printing process, in other words, to an area facing opposite the head unit 30 (head 31) (hereafter called the “printing area”). By the belt 14 carrying the continuous form S, the continuous form S is moved in the carrying direction toward the head 31. The continuous form S that has passed through the printing area is carried toward the downstream side first inspection unit 70 (scanner 71) by the belt 14. The continuous form S being carried is either electrostatically adhered or vacuum suctioned to the belt 14.

The carriage unit 20 is for moving the head unit 30 (head 31). This carriage unit 20 has a carriage (not illustrated) supported to be able to move back and forth in the paper width direction of the continuous form S along a guide rail (not illustrated), and a carriage motor (not illustrated). The carriage is constituted so as to move as an integrated unit with the head 31 by the drive of the carriage motor. The position of the carriage (head 31) on the guide rail (position in the paper width direction) can be found by the controller 100 detecting the rising edge and falling edge of the pulse signal output from the encoder provided on the carriage motor, and counting the edges. With this embodiment 1, when the second detection processing described later is performed, by the carriage moving in the paper width direction, the head 31 that was positioned in the printing area becomes positioned at a maintenance area separated away from there (area at which it is possible to execute recovery processing) (see FIG. 2).

The head unit 30 ejects ink toward the continuous form S carried to the printing area by the carrier unit 10. The head unit 30 forms dots on the continuous form S by ejecting ink toward the continuous form S during carrying, printing an image on the continuous form S.

The printer 1 of this embodiment 1 is a line printer, and the head unit 30 is capable of forming a paper width of dots at one time. Also, as shown in FIG. 3, the head unit 30 has a plurality of heads 31 aligned in zigzag form along the paper width direction, and a head control unit HC (see FIG. 1) for controlling the head 31 based on the head control signals from the controller 100.

As shown in FIG. 4, each head 31 has a case 32, a flow path unit 33, and a piezoelement unit 34. The case 32 is a member for housing and fixing piezoelements PZT and the like, and for example is produced using a non-conductive resin material such as epoxy resin or the like.

The flow path unit 33 has a flow path forming substrate 33a, a nozzle plate 33b, and a vibration plate 33c. On one surface of the flow path forming substrate 33a, the nozzle plate 33b is joined, and on the other surface, the vibration plate 33c is joined. On the flow path forming substrate 33a, a pressure chamber 331, an ink supply path 332, and a hollow part or groove that becomes a common ink chamber 333 are formed. This flow path forming substrate 33a is produced using a silicon substrate, for example. A nozzle group consisting of a plurality of nozzles Nz is provided on the nozzle plate 33b. This nozzle plate 33b is produced using a plate shaped member having conductivity, for example, a thin metal plate. A diaphragm part 334 is provided on the part corresponding to each pressure chamber 331 on the vibration plate 33c. This diaphragm part 334 is deformed by the piezoelement PZT, changing the capacity of the pressure chamber 331. By interposing a vibration plate 33c, an adhesive layer, or the like, the piezoelement PZT and the nozzle plate 33b are in an electrically insulated state.

The piezoelement unit 34 has a piezoelement group 341 and a clamping plate 342. The piezoelement group 341 has a comb tooth shape. Also, each individual comb tooth is a piezoelement PZT.

The tip end surface of each piezoelement PZT is adhered to an island part 335 that the corresponding diaphragm part 334 has. The clamping plate 342 supports the piezoelement group 341, and also is an attachment part to the case 32. The piezoelement PZT is an example of an electromechanical conversion element, and when the drive signal COM is applied, expands, and contracts in the lengthwise direction, and gives a pressure change to the liquid within the pressure chamber 331. A pressure change occurs in the ink within the pressure chamber 331 due to changes in the capacity of the pressure chamber 331. Using this pressure change, it is possible to eject ink drops from the nozzle Nz. Instead of the piezoelement PZT as the electromechanical conversion element, it is also possible to constitute this by ejecting ink drops by generating air bubbles according to the applied drive signal COM.

As shown in FIG. 5, each head 31 has on its bottom surface a black ink nozzle row K, a cyan ink nozzle row C, a magenta ink nozzle row M, and a yellow ink nozzle row Y, and respectively different colored inks are ejected toward the continuous form S from each of the nozzle rows. The plurality of nozzles constituting each nozzle row are aligned at a fixed nozzle pitch along the paper width direction.

Specifically, a nozzle group of one paper width is constituted by the nozzle rows of each head 31. The head 31 of this embodiment 1 can be equipped with one row each for the nozzle row for each ink color, or can be equipped with a plurality of rows each. In other words, for example, it is possible to form a certain raster line using a plurality of black ink nozzle rows K. It is also possible for the head 31 of this embodiment 1 to be equipped with a nozzle row of only a certain specific ink color.

Here, the relationship between the nozzle array and dot formation is described using FIG. 6. As shown in FIG. 6, here, nozzle groups of a designated nozzle pitch are constituted by nozzle rows of each head 31 on the head unit 30. As shown in FIG. 5, for the actual nozzle position, the carrying direction position is different, but by making the ejection timing different, it is also possible to consider nozzle groups constituted from nozzle rows of each head 31 as nozzles aligned in one row as shown in FIG. 6. Also, to make the description simpler, only the black ink nozzle group 311 is provided.

This nozzle group 311 is constituted from nozzles aligned in the paper width direction at intervals of 1/720 inch. Numbers are given to each nozzle in sequence from the top in the drawing.

By intermittently ejecting ink drops from each nozzle on the continuous form S that is being carried, the nozzle group 311 forms a raster line on the continuous form S. For example, nozzle #1 forms a first raster line on the continuous form S, and nozzle #2 forms a second raster line on the continuous form S. Each raster line is formed along the carrying direction. With the description hereafter, the raster line direction is called the raster direction.

On the other hand, if ink drops are not suitably ejected due to a nozzle clogging or the like, suitable dots are not formed on the continuous form S. With the description hereafter, dots that are not suitably formed are referred to as dot failure. So then, when nozzle ejection failure occurs once, since ejection recovery almost never occurs naturally during printing, the ejection failure occurs continuously. Thus, dot failure occurs continuously in the raster direction on the continuous form S, and on the printed image, dot failure is observed as a white or bright band. For example, as shown in FIG. 7, when ejection failure occurs at a nozzle, dot failure occurs in the printed image. Specifically, when the dot failure location enclosed by a square frame in FIG. 7 is enlarged, as shown by the arrow in FIG. 8, a vertical white band is observed.

The drive signal generating unit 40 is for generating drive signals COM. When the drive signal COM is applied to the piezoelement PZT, the piezoelement expands and contracts, and the capacity of the pressure chamber 331 corresponding to each nozzle Nz changes. Because of that, the drive signals COM are applied to the head 31 during print processing, during the second detection processing described later, during flushing processing performed on nozzles Nz with dot omission, and the like.

The ink suction unit 50 is for suctioning ink within the head from the nozzles Nz of the head 31 and exhausting it to outside the head. This ink suction unit 50 operates a suction pump (not illustrated) in a state with a cap (not illustrated) adhered to the bottom surface (nozzle surface) of the head 31, and by setting the cap space to negative pressure, the ink within the head is suctioned together with air bubbles mixed in within the head (within the nozzle). By doing this, it is possible to recover the dot omission nozzles.

The wiping unit 55 is for removing foreign matter such as paper dust or the like adhered to the nozzle surface of the head 31. This wiping unit 55 has a wiper (not illustrated) capable of contacting the nozzle surface of the head 31. The wiper is constituted by an elastic member having flexibility. When the carriage (head 31) is moved in the paper width direction by the driving of the carriage motor, the tip end part of the wiper contacts the nozzle surface of the head 31 and is bent, and does cleaning (wiping) of the surface of the nozzle surface. By doing this, the wiping unit 55 removes foreign matter such as paper dust or the like adhered to the nozzle surface, making it possible to properly eject ink from the nozzle that was clogged by that foreign matter.

The flushing unit 60 is for receiving and storing ink that is ejected by the head 31 performing the flushing operation. This flushing operation is an operation with which a drive signal unrelated to the image being printed is applied to the drive element (piezoelement), and ink drops are forcefully and continuously ejected from the nozzle. By doing this, it is possible to prevent the ink inside the head (inside the nozzles) from thickening and drying so that a suitable ink volume is not ejected, so it is possible to recover from a clogged nozzle being in a non-ejecting state.

The first inspection unit 70 is for inspecting ejection failure based on the state of the printed image formed on the continuous form S. Specifically, it functions as a first sensor for reading the image printed on the continuous form S carried by the carrier unit 10. The specific constitution and the like of this first inspection unit 70 will be described in detail later. Also, the “first sensor” noted in the claims includes the first sensor in this embodiment 1.

The second inspection unit 80 is for inspecting ejection failure for each nozzle based on the state of the ink inside the head 31. Specifically, this second inspection unit 80 functions as a second sensor for detecting whether or not there is ejection failure of the ink for each nozzle during the second ejection inspection described later. The specific constitution and the like of this second inspection unit 80 will be described in detail later. Also, the “second sensor” noted in the claims includes the second sensor of this embodiment 1.

The controller 100 is a control unit for performing control of the printer 1. As shown in FIG. 1, this controller 100 has an interface unit 101, a CPU 102, a memory 103, and a unit control circuit 104. The interface unit 101 is for performing sending and receiving of data between the host computer CP which is an external device and the printer 1. The CPU 102 is an arithmetic processing device for performing control of the overall printer 1. The memory 103 is for ensuring the area for storing the CPU 102 programs, work areas, and the like. The CPU 102 controls each unit using the unit control circuit 104 according to the program stored in the memory 103.

The detection device group 90 is for observing the status within the printer 1, for example, there are a rotary encoder used to control carrying of the medium or the like, a paper detection sensor for detecting whether or not there is a medium being carried, a linear encoder for detecting the position of the movement direction of the carriage (or the head 31) and the like.

### First Inspection Unit 70

Next, we will describe the first inspection unit 70. The first inspection unit 70 is a sensor for reading the printed image printed on the continuous form S according to the movement along the carrying direction of the continuous form S during the first detection process described later.

### Configuration

As shown in FIG. 2, this first inspection unit 70 is provided at a position further to the downstream side of the carrying direction than the head unit 30 (head 31), and has a scanner 71 that can read the printed image of a paper width amount of the continuous form S at one time. This scanner 71 has a light source unit for radiating illumination light on the continuous form S and a photosensitive unit for receiving of the reflected light reflected by the continuous form S, and is able to read the printed image printed by the printer 1 for each scanner color. The light source unit has a substrate on which a plurality of white LEDs are arranged. The photosensitive unit has an image sensor such as a CCD or the like, and a lens for converging the reflected light on the image sensor, and outputs voltage of a size according to the intensity of the received reflected light.

### Ejection Inspection Principle

The scanner 71 of embodiment 1 has the raster direction reading resolution read so as to be lower than the resolution of the image printed on the continuous form S. For example, if the continuous form S carrying speed is 254 mm/s, and the time needed to read 1 reading line (1 scan cycle) is 7 ms, then the continuous form S is carried 1.78 mm during the reading time. Specifically, the line width of one read line is 1.78 mm. In other words, if the raster direction printing resolution is set as 1440 dpi, then 1 reading line correlates to an amount of 1.78 mm×1440 dpi=100.8 dots. In other words, the raster direction reading resolution of the read data correlates to an image compressed to approximately 1/100 from the printed image. Each read line of the read data is constituted by a pixel value for which the pixel values of approximately 100 dots of the printed image are averaged in the raster direction for each color.

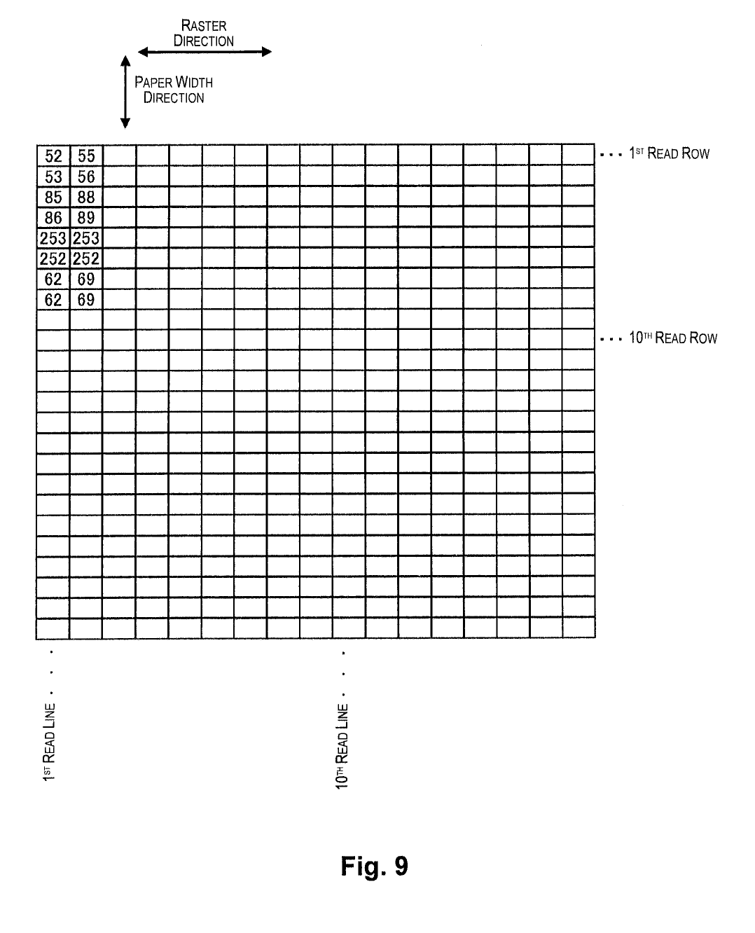

FIG. 9 is a drawing for describing the read data when the printed image is read by the scanner 71 when the scan rate is 7 ms. As shown in the drawing, the read data is data which has an association between the cell position and the pixel value read at that position for cells for which a plane is divided into grid form in the raster direction and the paper width direction. Following, for purposes of description, as shown in the drawing, numbers are given to the raster direction rows in sequence as the first read row to the 1440th read row, and the to the paper width direction lines in sequence of reading by the scanner 71 from the first read line to the Nth read line.

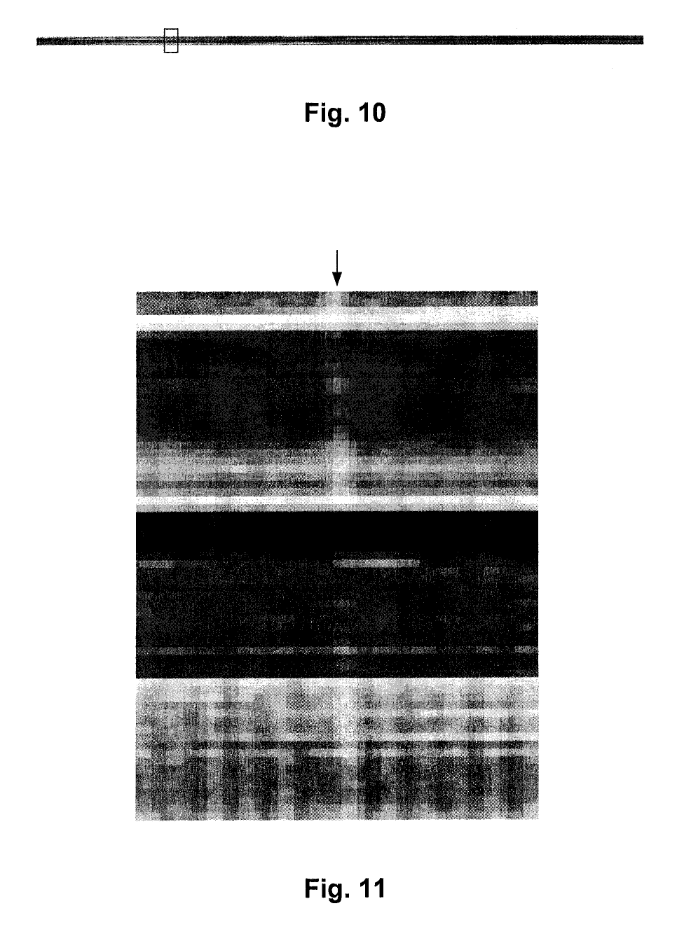

Also, FIG. 10 is a drawing showing the image for which the printed image shown in FIG. 7 is read by the scanner 71. As shown in FIG. 10, the image read by the scanner 71 becomes an image compressed to approximately 1/100 in the raster direction. On the other hand, FIG. 11 is an enlarged view of the dot failure location enclosed by a square frame in FIG. 10. As shown by the arrow in FIG. 11, a vertical white band is observed.

The controller 100 fetches data of the image read by the scanner 71 (read data) and image data from the computer CP. Then, the controller 100 creates reference data that is the same resolution as the read resolution of the read data based on the image data resolution, and compares the read data and the reference data to detect nozzle ejection failure.

### Operation During Inspection

First, the controller 100 starts print processing on the continuous form S based on image data received from the computer CP. In parallel with the print processing, the scanner 71 reads the image printed on the continuous form S so that the read resolution is lower than the resolution of the image data in the raster direction. In specific terms, the scan rate is set to 7 ms, and so that 1 read line correlates to an amount of 100.8 dots, from the first read line to the Nth read line are read. Specifically, the printed image is read such that an amount of approximately 100 dots in the printed mage carrying direction is 1 pixel.

The controller 100 fetches the image data from the computer CP and by doing digital processing of that image data, reference data is created which has the same resolution as the read resolution of the read data. In specific terms, for the raster direction, 1 read line correlates to an amount of 100.8 dots, so a dot corresponding to 1 read line can be created by adding a value for which the pixel value of the 101st dot is multiplied by 8/10 to the sum of the pixel values of the 1st dot to the 100th dot according to each head 31, and dividing that value by 100.8. The reference data is created for each color of the scanner.

By deducting the pixel value of the read data from the pixel value of the reference data for each read line from the 1st read line to the Nth read line, the controller 100 calculates the difference in the pixel value for each color from the 1st to 1440th read row. For each read line from the 1st read line to the Nth read line, the controller 100 determines the dot failure location of each color based on the calculated difference in the pixel value. In specific terms, if the difference in pixel values is a designated value a or less, it is determined that there is no dot failure location, and if the difference in pixel values is greater than the designated value a, it is determined that there is a dot failure location.

If there is no nozzle ejection failure and the dots are formed exactly according to the image data, based on logic, the difference in the pixel values between the reference data and the read data is zero. On the other hand, if there is ejection failure in a nozzle of the printer 1 and that nozzle has not formed dots, based on logic, the pixel value of the read data at that dot failure location is zero, and the pixel value of the reference data remains as is, expressed as a difference. Specifically, if the difference in pixel values in terms of logic is not zero, it is possible that there is dot failure.

However, when a printed image for which dots formed by each head 31 are overlapped is read by the scanner 71, it is difficult to specify the nozzle that is the cause of the dot failure location. Also, depending on the effect of reading error by the scanner 71 or debris adhered on the continuous form S, or the intensity of the illumination light or the like, it is also possible that even without ejection failure, the difference will not be zero. In light of that, with this embodiment 1, the existence of dot failure will be judged for each read row with a certain value between the pixel value of the reference data which is the logical difference when there is a dot failure and zero which is the logical difference when there is no dot failure as the designated value a. The designated value a can be a fixed value or can be a designated percentage (e.g. 80%) of the pixel value of the reference data.

Next, the dot failure location determined for each read line from the 1st read line to the Nth read line is tallied for each read row. The controller 100 determines that there is a dot failure in a read row when there was a dot failure location in a designated percentage (e.g. 5%) of the read lines among the N rows of read lines for each read row. At this time, the controller 100 is not possible to specify the nozzle at which the ejection failure has occurred due to being affected by overlapping dots of each head 31 or read errors by the scanner 71 or the like, so it estimates the nozzle corresponding to the read row for which that dot failure exists. In specific terms, the mth nozzle corresponding to the nth read row for which there is a dot failure is estimated by the formula 1 below.

m=n×(printed image resolution/read resolution) (Formula 1)

As described above, with this embodiment 1, as shown in FIG. 8, when a nozzle ejection failure occurs, the dot failure raster line is observed as a white band or bright band. Also, as shown in FIG. 11, even when the scanner 71 collectively reads 100 dots in the raster direction, the image is only compressed in the raster direction and is still observed as a white band or bright band. Focusing on this kind of point, when read by the scanner 71, by compressing the data volume in the raster direction (by lowering the read resolution for the raster direction), it is possible to reduce the processed data volume with ejection failure detection.

### Second Inspection Unit 80

Here, we will describe the second inspection unit 80. The second inspection unit 80 is a sensor for detecting ejection failure based on the ink status inside the head 31 at the time of the second detection processing described later.

### Ejection Inspection Principle

As shown in FIG. 4, when the drive signal COM is applied to the piezoelement PZT, the piezoelement bends, and the vibration plate 33c vibrates. Even when application of the drive signals COM to the piezoelement PZT is stopped, residual vibration occurs at the vibration plate 33c. Thus, by having residual vibration occur at the vibration plate 33c, and detecting a signal that occurs at the piezoelement PZT at that time, it is possible to find the characteristics (frequency characteristics) of each piezoelement PZT.

In specific terms, when the drive signal COM output from the drive signal generating unit 40 is applied to the corresponding piezoelement PZT, the vibration plate 33c in contact with that piezoelement PZT vibrates. The vibration of that vibration plate 33c does not stop immediately, and residual vibration occurs. Because of this, the piezoelement PZT vibrates according to the residual vibration and outputs a signal (reverse voltage). Then, that signal is input to the second inspection unit 80. The second inspection unit 80 detects the frequency characteristics of that piezoelement PZT based on the input signal. If this process is performed in sequence for the piezoelements PZT corresponding to each nozzle, it is possible to detect the frequency characteristics of each piezoelement PZT. The frequency characteristics detected in this way differ according to the state of the ink inside the head 31 (normal, air bubbles mixed in, ink thickened, paper dust adhered). Specifically, the vibration pattern of the residual vibration differs according to the state of the ink within the head 31 (normal, air bubbles mixed in, ink thickened, paper dust adhered).

### Configuration

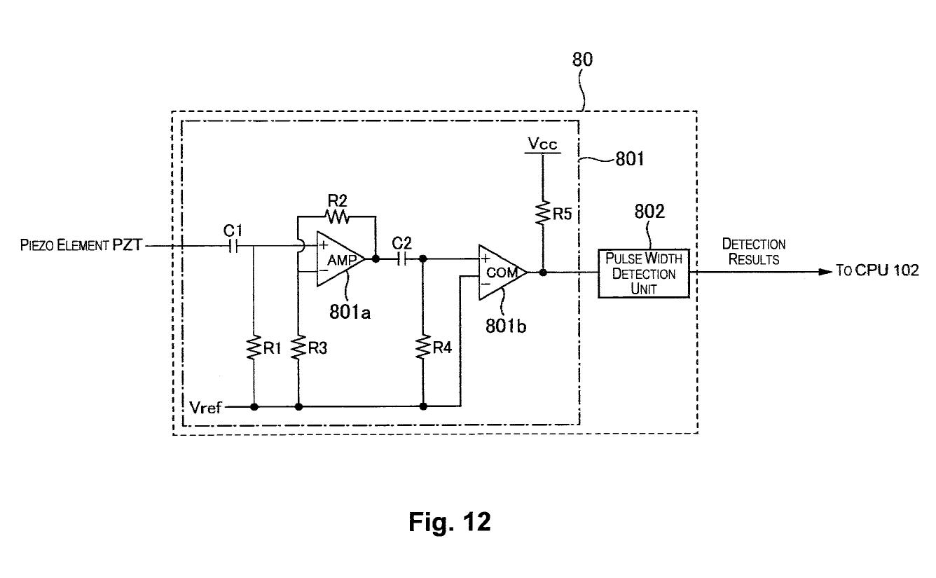

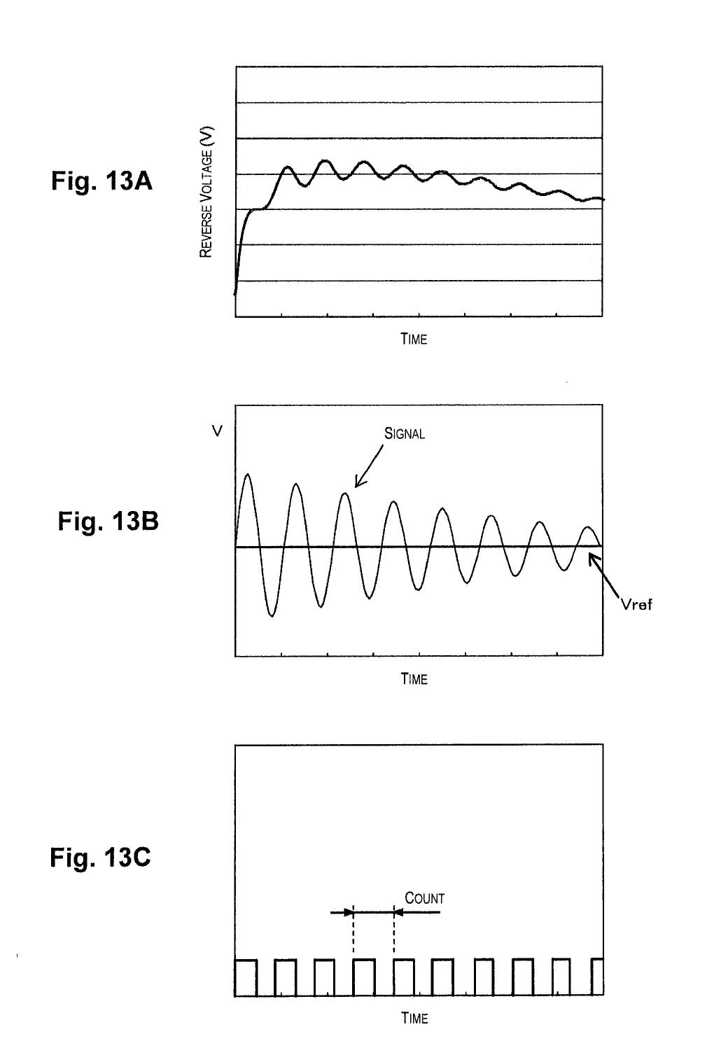

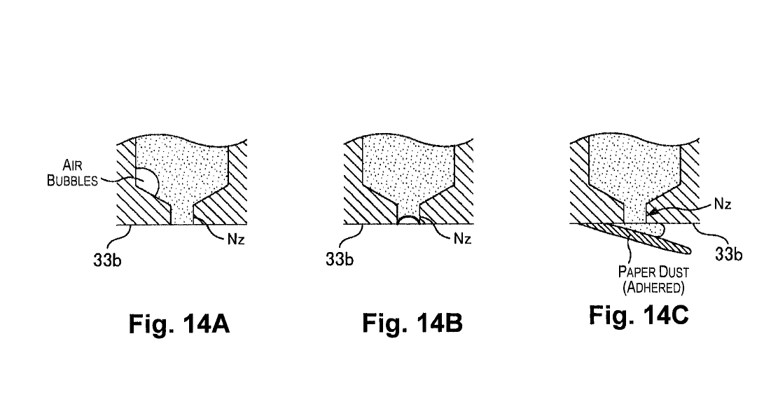

FIG. 12 is an explanatory drawing of the configuration of the second inspection unit 80. The second inspection unit 80 has an amplifier 801 and a pulse width detection unit 802.

With the amplifier 801, the low frequency elements contained in the signals from the piezoelement 341 are removed by a high pass filter consisting of a capacitor C1 and a resistor R1, and this is amplified at a designated amplification rate by the operating amp 801. Next, by the output of the operating amp 801a passing through a high pass filter consisting of a capacitor C2 and a resistor R4, this is converted to a signal that vibrates up and down with the reference voltage Vref at the center. Then, this is compared with the reference voltage Vref using the comparator 801b, and the signal is binarized depending on whether or not it is higher than the reference voltage Vref.

### Operation During Inspection

FIG. 13A is a drawing showing the signals output by the piezoelement PZT according to the residual vibration. The frequency characteristics differ according to the state of the ink within the head (normal, air bubbles mixed in, ink thickened, paper dust adhered), so a unique voltage waveform (vibration pattern) is output corresponding to the respective ink state.

FIG. 13B is a drawing showing the signals after the output of the operating amp 801a passes through a high pass filter consisting of the capacitor C2 and the resistor R4, and the reference voltage Vref. Specifically, these are signals input to the comparator 801b.

FIG. 13C is a drawing showing the output signals from the comparator 801b. Specifically, these are signals input to the pulse width detection unit 802.

When the pulse shown in FIG. 13C is input, the pulse width detection unit 802 resets the count value at the rise of the pulse, increments the count value for each clock signal after that, and outputs the count value at the rise of the next pulse to the CPU 102 of the controller 100. The CPU 102 is able to detect the cycle of the signals output by the piezoelement PZT based on the count value output by the pulse width detection unit 802, specifically, based on the detection results output from the second inspection unit 80.

As described above, by the second inspection unit 80 outputting the vibration pattern having frequency characteristics according to the residual vibration, the controller 100 is able to specify the state of the ink within the head (whether it is normal, whether ejection failure is occurring due to air bubbles mixing in within the head, whether ejection failure is occurring due to ink thickening, or whether foreign matter such as paper dust has adhered to the nozzle Nz). As a result, it is possible to perform a suitable recovery operation (also called recovery processing) corresponding to the respective ink state.

### Printer 1 Operation Example

### Overall Operation

Here, we will describe the overall operation of the printer 1. With the printer 1 of this embodiment 1, the controller 100 controls the control subjects (carrier unit 10, carriage unit 20, head unit 30, drive signal generating unit 40, ink suction unit 50, wiping unit 55, flushing unit 60, first inspection unit 70, and second inspection unit 80) and performs each process according to the computer program stored in the memory 103. Therefore, this computer program has a code for controlling the control subjects to execute these processes.

The controller 100 performs print processing and dot omission inspection processing. In specific terms, the controller 100 performs receiving of printing instructions, the paper feed operation, the dot forming operation, carrying operation, print end judgment, first inspection operation, second inspection operation, and recovery operation. Following, we will give a brief description of each process.

Receiving of the printing instructions is a process of receiving printing instructions from the computer CP. With this process, the controller 100 receives printing instructions via the interface unit 101.

The paper feed operation is an operation with which the continuous form S which is the printing subject is moved, and positioned at a printing start position (so-called cueing position). With this operation, the controller 100 moves the continuous form S by driving the carrying motor.

The dot forming operation is an operation for forming dots on the continuous form S. With this operation, the controller 100 outputs control signals to the head 31. At this time, by the drive signal COM generated by the drive signal generating unit 40 being applied to the piezoelement PZT, ink is ejected from the nozzle Nz. By doing this, ink is intermittently ejected from the nozzles Nz of the head 31, and dots are formed on the continuous form S.

The carrying operation is an operation of moving the continuous form S in the carrying direction. The controller 100 is able to form dots at positions different from the dots formed by the previous dot forming operation by driving the carrying motor.

The print end judgment is a judgment of whether or not to continue printing. The controller 100 performs the print end judgment based on the presence or absence of print data on the continuous form S which is the printing subject.

The dot omission inspection operation is an operation for inspecting the presence or absence of ejection failure (dot omission). The controller 100 performs the first detection processing using the first inspection unit 70 in parallel with the printing process, and when there was an ejection failure from the detection results of the first detection processing, it performs the second detection processing using the second inspection unit 80. Then, the controller 100 selects a suitable recovery operation from among a plurality of preset types of recovery operation based on the detection results of the second detection processing. We will give a detailed description of this dot omission inspection operation later. The “detection processing of the first sensor” noted in the claims includes the first detection processing of this embodiment 1.

The recovery operation is an operation of recovering a certain head 31 in an ejection failure state to a state in which it can eject ink normally. The controller 100 performs any of the operations including the flushing operation, the ink suction operation, and the wiping operation according to the cause of the ejection failure.

Here, with the printer 1 of this embodiment 1, performing the recovery operation according to the cause of the ejection failure has advantages such as the following.

When respectively performing the flushing operation, the ink suction operation, and the wiping operation, the volume of ink consumed for recovery differs respectively. For example, since the wiping operation is an operation of cleaning (wiping) the nozzle surface with a wiper 56, the ink volume consumed for recovery is a minimum amount. On the other hand, since the flushing operation is an operation of spitting out ink within the head together with thickened and dried ink, the volume of ink consumed for recovery is greater than the consumed ink volume during the wiping operation. Also, the ink suction operation is an operation of suctioning the ink within the head together with the mixed in air bubbles, and the volume of ink consumed for recovery is even greater than the consumed ink volume during the flushing operation. Because of this, for example, when ejection failure occurs due to paper dust adhering to the nozzle surface, if the flushing operation or ink suction operation is selected despite being able to do recovery by selecting the wiping operation, there is a waste of ink volume consumed for recovery.

Because of this, with the printer 1 of this embodiment 1, when it is determined that there is ejection failure from the detection results of the first inspection unit 70, by selecting a suitable recovery operation from among the preset plurality of types of recovery operations based on the detection results of the second inspection unit 80, it is possible to suppress the wasted ink consumption.

### Dot Omission Detection Operation

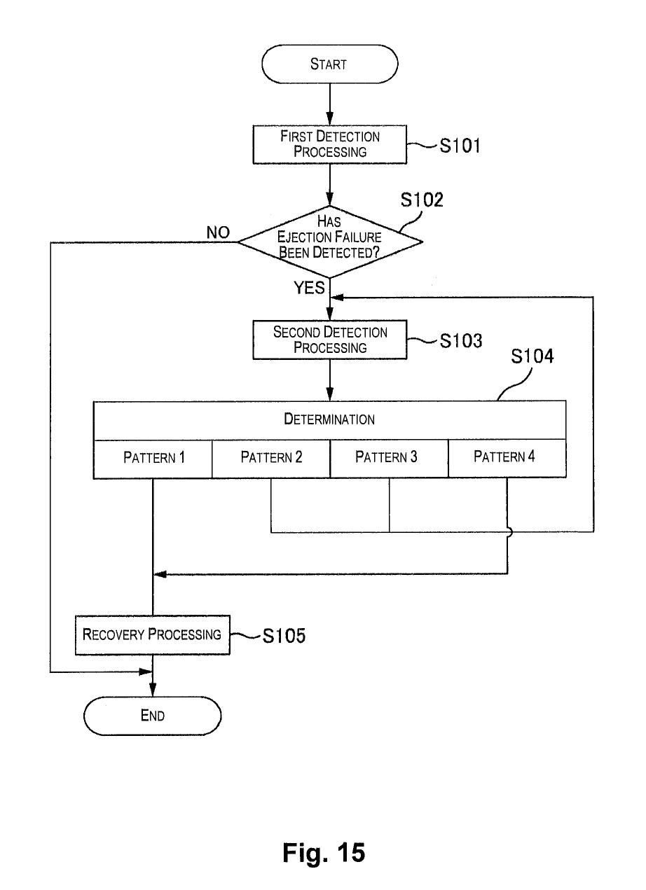

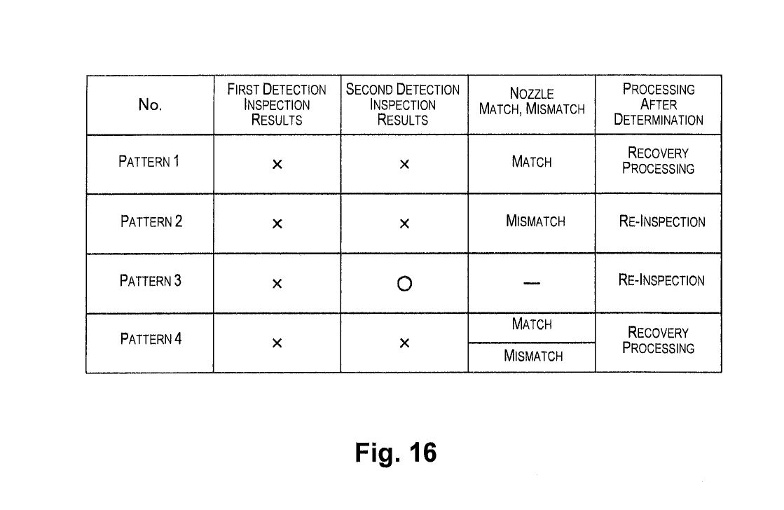

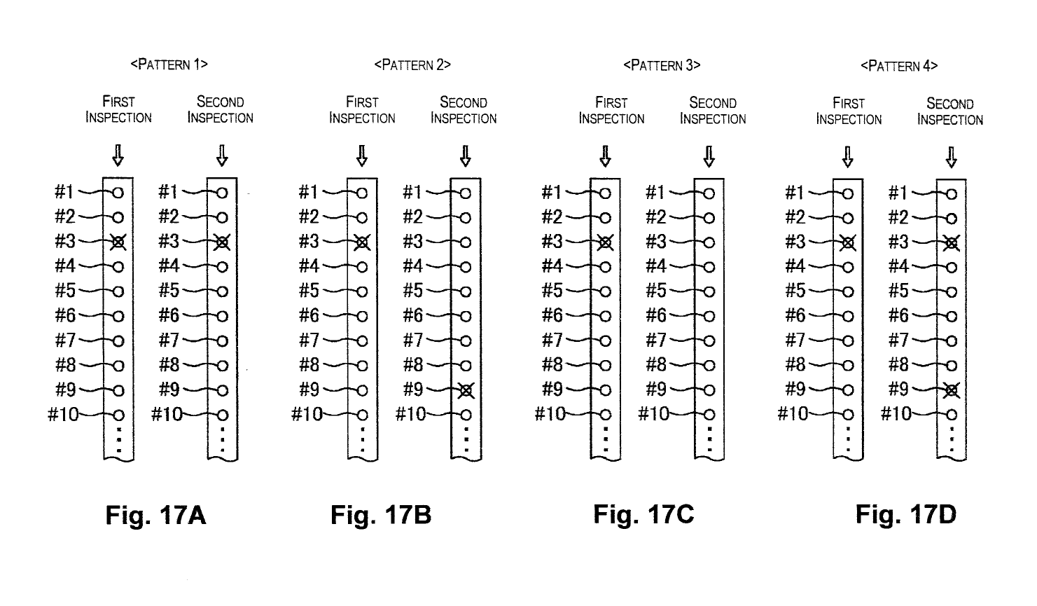

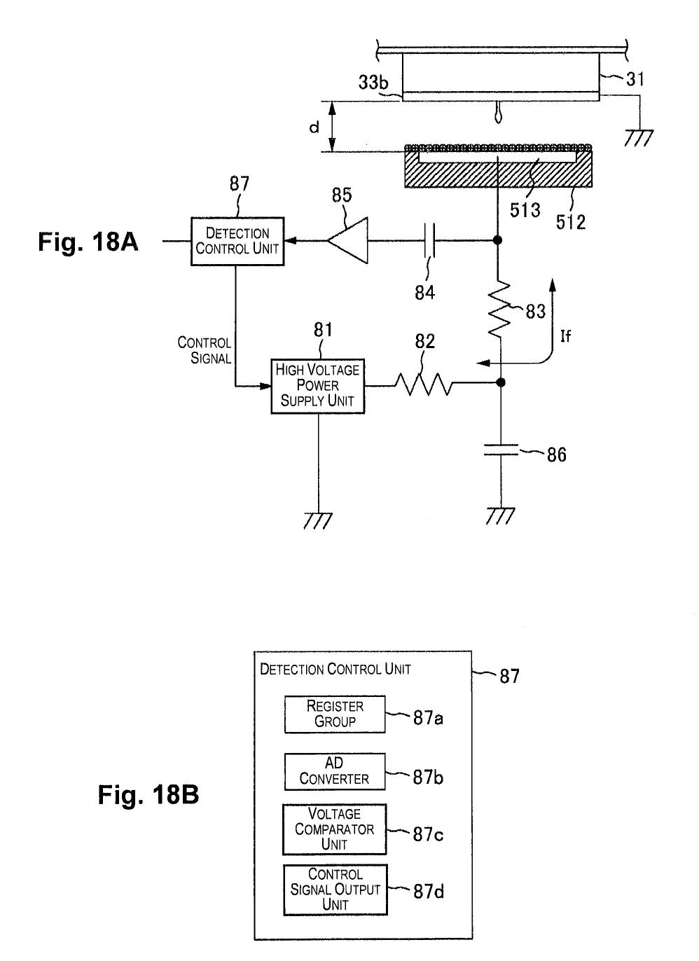

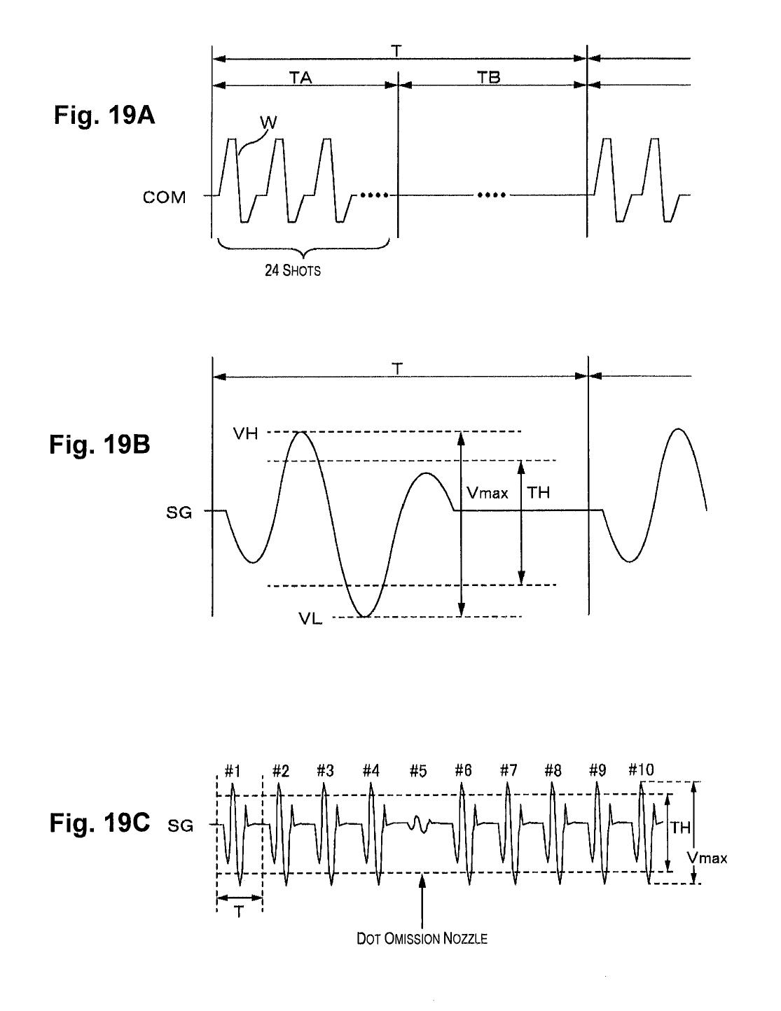

Next, we will describe the dot omission inspection operation using FIG. 14A to FIG. 14C, FIG. 15, FIG. 16, and FIG. 17A to FIG. 17D. FIG. 14A is a drawing showing the state with air bubbles mixed in. FIG. 14B is a drawing showing the state with the ink thickened and dried. FIG. 14C is a drawing showing the state with foreign matter such as paper dust or the like adhered to the nozzle. FIG. 15 is a flow chart showing an example of the dot omission inspection operation. FIG. 16 is a drawing for describing the determination conditions for the dot omission inspection operation. FIG. 17A to FIG. 171 are drawings showing a comparison of the arrangement of abnormal nozzles with the first detection processing, and the arrangement of abnormal nozzles with the second detection processing.

As shown in FIG. 15, first, the controller 100 performs the first detection processing (S101) in parallel with the print processing in a state with the head 31 positioned in the printing area (see FIG. 2).

With this first detection processing, the presence or absence of ejection failure (dot failure) due to ink drops not being ejected to outside the head is inspected by fetching the detection results of the first inspection unit 70. Then, with this first detection processing, the controller 100 fetches as the detection results of the first inspection unit 70 either of the results including that ink drops are ejected normally toward outside the head (no dot failure) or ink drops are not ejected normally toward outside the head (there is dot failure), and it is possible to estimate the abnormal nozzle corresponding to the nth read row for which there is dot failure.

Subsequently, the controller 100 determines whether or not there is dot failure (ejection failure) (S102) based on the detection results of the first inspection unit 70, and when it is determined that there is no dot failure (S102: No), since this is a normal state for which ejection failure is not occurring with the head 31, the processing ends as is, but when it is determined that there is dot failure (S102: Yes), the print processing is stopped, and the second detection processing is performed (S103).

With this second detection processing, the presence or absence of ejection failure (dot omission) due to the ink state within the head is inspected for each nozzle of each head 31 by fetching the detection results of the second inspection unit 80. Then, using this second detection processing, the controller 100 is able to fetch as the detection results of the second inspection unit 80 any of the results including that the ink state is normal (no dot omission), that ejection abnormality has occurred due to air bubbles mixing in (see FIG. 14A), that ejection abnormality has occurred due to ink thickening and drying (see FIG. 14B), and that ejection abnormality has occurred due to foreign matter such as paper dust or the like adhering to the nozzle Nz (see FIG. 14C). Specifically, the controller 100 can specify in particular terms the cause of the ejection failure as well as the abnormal nozzle which has the ejection failure. The “detection processing by the second sensor” noted in the claims includes the second detection processing of this embodiment 1.

Subsequently, from the detection results of the first inspection unit 70 fetched by the first detection processing and the detection results of the second inspection unit 80 fetched by the second detection processing, the controller 100 selects a suitable recovery operation according to the presence or absence of ejection failure (dot omission) based on the determination conditions. As shown in FIG. 16, the determination conditions are set such that a suitable recovery operation is selected for each combination of the first detection processing detection results and the second detection processing detection results.

With this embodiment 1, the determination based on the determination conditions is performed overall with tallying of the detection results for all the nozzles, but can also be performed for each nozzle.

In specific terms, when it is determined at step S104 that the determination result is pattern 1 from the combination of the first detection processing detection results and the second detection processing detection results, the controller 100 performs recovery processing (S105).

Specifically, as shown in FIG. 16, recovery processing is performed when the following determination conditions are satisfied: the first detection processing inspection results are abnormal (“X”: there is dot omission), and the second detection processing inspection results are abnormal (“X”: there is dot omission), and furthermore, the nozzle (nozzle number) estimated to be the abnormal nozzle from the first detection processing results and the nozzle (nozzle number) specified as the abnormal nozzle by the second detection processing results match.

For example, as shown in FIG. 17A, when a certain nozzle row is focused on, when “nozzle #3” is estimated as the abnormal nozzle based on the first detection processing detection results, and “nozzle #3” is specified as the abnormal nozzle based on the second detection processing detection results, both the abnormal nozzles are matched as “nozzle #3.” Because of this, recovery processing is performed on “nozzle #3” specified as the abnormal nozzle.

The recovery processing with this embodiment 1 is performed on the nozzle specified as the abnormal nozzle, rather than being performed on all the nozzles. In this way, by performing recovery processing on a portion of the nozzles (nozzles having ejection abnormality) among all the nozzles, it is possible to complete the recovery processing in a shorter time compared to when performing it on all the nozzles.

Of all the nozzle rows, it is also possible to perform recovery processing on the nozzle rows including abnormal nozzles. Also, when a head is provided for each ink color, it is possible to perform recovery processing on the head of the same color as the ink color of the abnormal nozzle. By doing this, it is possible to complete the recovery processing in a shorter time than when performing it on all the nozzle rows and all the heads.

Also, with this recovery processing, a suitable recovery operation is selected according to the cause of the ejection failure based on the second detection processing results. For example, when ejection failure occurs due to air bubbles being mixed in (see FIG. 14A), the recovery operation using the ink suction unit 50 is performed, and the air bubbles mixed inside the head are suctioned together with the ink inside the head. Also, when ejection failure due to ink thickening and drying occurs (see FIG. 14B), the recovery operation using the flushing unit 60 is performed, and the thickened ink is ejected to outside the head. Also, when ejection failure occurs due to foreign matter such as paper dust or the like adhering to the nozzle Nz (see FIG. 14C), the recovery operation by the wiping unit 55 is performed, and foreign matter such as paper dust or the like is removed from the nozzle surface. In this way, when it is determined that there is an ejection abnormality from the results of the first detection processing, by selecting the recovery operation based on the second detection processing results, a suitable recovery operation is performed according to the cause of the ejection failure, and it is possible to suppress wasted ink volume consumed for recovery.

After that, at step S104, when it is determined that the judgment results are pattern 2 or pattern 3 from the combination of the first detection processing detection results and the second detection processing detection results, the controller 100 returns to step S103 and performs re-inspection. This re-inspection is performed only on abnormal nozzles.

Specifically, as shown in FIG. 16, the second detection processing is performed again when the following determination conditions (pattern 2) are satisfied: the first detection processing inspection results are abnormal (“X”: there is dot omission), and the second detection processing inspection results are abnormal (“X”: there is dot omission), and furthermore, the nozzle (nozzle number) estimated to be the abnormal nozzle by the first detection processing results and the nozzle (nozzle number) identified as the abnormal nozzle by the second detection processing results do not match, or when the following determination conditions (pattern 3) are satisfied: the first detection processing inspection results are abnormal (“X”: there is dot omission), and the second detection processing inspection results are normal (“O”: no dot omission).

For example, as shown in FIG. 17B, when focusing on a certain nozzle row, when “nozzle #3” is estimated to be the abnormal nozzle with the first detection processing detection results, and “nozzle #9” is specified as the abnormal nozzle with the second detection processing detection results, the abnormal nozzles do not match with “nozzle #3” and “nozzle #9.”

Also, as shown in FIG. 17C, when focusing on a certain nozzle row, when “nozzle #3” is estimated to be the abnormal nozzle with the first detection processing detection results and all the nozzles are specified as normal nozzles with the second detection processing detection results, “nozzle #3” being the abnormal nozzle and the normal nozzles do not match.

In light of this, with this embodiment 1, when the second detection processing detection results are in contrast to the first detection processing detection results in this way, specifically, when including cases when nozzles estimated to be abnormal nozzles by the first detection processing detection results are regarded as normal nozzles by the second detection processing detection results, re-inspection is made to be performed. This is due to the following reasons.

The first detection processing stops at estimating the abnormal nozzle having ejection failure, but with the second detection processing, it is possible to distinguish whether or not there is ejection failure for each nozzle, so it is possible to specify the abnormal nozzle having ejection failure. Because of this, in a case when there is a contrast such as that noted above, when it is estimated that there is an abnormal nozzle by the first detection processing detection results with lower inspection precision than the second detection results, there is a possibility of erroneous detection, so first of all, re-inspection was made to be performed. By doing this, recovery processing is not performed immediately, so it is possible to save on ink consumption.

Then, when doing this re-inspection, only the second detection processing is performed, without performing the first detection processing. This is because when performing re-inspection, it is possible to improve the dot omission detection precision by performing the second detection processing which has higher detection precision than the first detection processing. Therefore, only the second detection processing is performed again on the “nozzle #3.”

After that, at step S104, the controller 100 performs recovery processing (S105) when it is determined that the determination results are pattern 4 from the combination of the first detection processing detection results and the second detection processing detection results.

Specifically, as shown in FIG. 16, recovery processing is done when the following determination conditions are satisfied: the first detection processing inspection results are abnormal (“X”: there is dot omission), and the second detection processing inspection results are abnormal (“X”: there is dot omission), and furthermore, the nozzle (nozzle number) estimated to be the abnormal nozzle by the first detection processing results and the nozzle (nozzle number) specified as the abnormal nozzle by the second detection processing results match, and when the following determination conditions are met: the first detection processing inspection results are abnormal (“X”: there is dot omission), and the second detection processing inspection results are abnormal (“X”: there is dot omission), and furthermore, the nozzle (nozzle number) estimated to be the abnormal nozzle by the first detection processing results and the nozzle (nozzle number) specified as the abnormal nozzle by the second detection processing results do not match.

For example, as shown in FIG. 17D, when focusing on a certain nozzle row, when “nozzle #3” is estimated as the abnormal nozzle by the first detection processing detection results, and “nozzle #3” and “nozzle #9” are specified as abnormal nozzles with the second detection processing detection results, though the abnormal nozzles match for “nozzle #3,” the abnormal nozzles do not match for “nozzle #9.”

In light of this, with this embodiment 1, when the second detection processing detection results contrast with the first detection processing detection results in this way, specifically, when it is determined with the second detection processing that there is an ejection failure with the abnormal nozzle estimated by the first detection processing, and when it is determined that there is ejection failure with the normal nozzles other than the abnormal nozzle estimated by the first detection processing, recovery processing was made to be performed on the abnormal nozzles of the second detection processing. This is because by emphasizing the results of the second detection processing which has higher detection precision than the first detection processing, recovery processing is performed immediately without performing re-inspection, so as to quickly recover the abnormal nozzles. Therefore, the “nozzle #3” that matches the results of the second detection processing is recovered, and also, the “nozzle #9” with an emphasis on the second detection processing results is also recovered.

As described above, with the dot omission inspection processing of this embodiment 1, when the first detection processing is performed and it is determined that there is ejection failure, the dot omission detection precision is increased by performing the second detection processing for each nozzle. In this way, performing the second detection processing after first performing the first detection processing is effective in terms of the following points.

For example, if only the first detection processing is performed without performing the second detection processing, it is always possible to check whether or not ejection failure occurred during printing, but because the detection precision is lower than with the second detection processing, even if it is possible to estimate the abnormal nozzle having the ejection failure, it is not possible to specify the abnormal nozzle by detecting the presence or absence of ejection failure for each nozzle of each head 31. Conversely, when only the second detection processing is performed, though it is possible to perform dot omission inspection with a higher detection precision than the first detection processing, since it is not performed in parallel with the print processing (because this is performed by suspending printing and moving the head unit 30 from the printing area to the maintenance area), it is not possible to always check whether or not ejection failure has occurred during printing, increasing the possibility of a missed detection occurring. To prevent missed detection, it is also possible to consider increasing the inspection frequency for performing the second detection processing, but since the number of times that printing is suspended would increase, it takes a longer time to complete printing. In contrast to this, with this embodiment 1, by performing the first detection processing in parallel with the print processing, the presence or absence of ejection failure is always checked during printing, and when it is determined that there is ejection failure, after printing has stopped, by performing the second detection processing, the presence or absence of ejection failure is checked for each nozzle of each head 31, thus specifying the abnormal nozzle having ejection failure. Because of that, it is possible to avoid producing a large volume of defective printed matter by continuing to print as is without detecting ejection failure during printing, and when ejection failure occurs during printing, by stopping printing immediately and performing the second detection processing, it is possible to specify the abnormal nozzle having the ejection failure, so by performing cleaning on the abnormal nozzle among all the nozzles and eliminating the cause of the ejection failure such as clogging or the like, it is possible to quickly restart printing.

Effectiveness of the Printer 1 of this Embodiment

As described above, the printer 1 of this embodiment 1 is equipped with a head 31 for forming a printed image by ejecting ink from nozzles onto the continuous form S, a first inspection unit 70 for reading the printed image formed by the head 31, a second inspection unit 80 for detecting the presence or absence of ejection failure of the ink for each nozzle, and a controller 100 that uses the first inspection unit 70 to read the printed image formed on the continuous form S in parallel with the print processing for forming the printed image, executing the first detection processing for detecting the presence or absence of ejection failure based on that read printed image, and when it is determined that there is ejection failure with the first detection processing, then the second detection processing is executed which detects the presence or absence of ejection failure for each nozzle based on the detection results of the second inspection unit 80.

When filling ink from the ink cartridge into the head and air bubbles mix in, when the ink thickens or dries because ink (liquid) has not been ejected from the nozzles Nz for a long time, or when foreign matter such as paper dust or the like adheres to the nozzles Nz, there are cases when the nozzles Nz become clogged. When a nozzle Nz becomes clogged in this way, ink is not ejected at the time ink should be ejected from the nozzle Nz, and dot omission occurs (ejection failure). Dot omission means the phenomenon of dots not being formed at locations dots should be originally formed by ejection of ink from the nozzle Nz. When dot omission occurs, this becomes a cause of image quality degradation. As described above, as one ejection inspection for detecting dot omission, there is ejection inspection by reading the printed image with a scanner, comparing the read data that was read by the scanner with reference data, and detecting ejection failure of the nozzles. However, though it is possible to perform the ejection inspection in real time during printing, due to effects of things such as the issue of reading printed images for which dots of each head 31 overlap, reading errors by the scanner, dust that adheres on the continuous form, the intensity of the illumination light and the like, it was not possible to specify the abnormal nozzle corresponding to a certain read row which has clot failure. Because of that, when recovering an abnormal nozzle, not only the abnormal nozzle, but also the normal nozzles are subject to the recovery processing. In light of this, with this embodiment 1, when the first sensor detects ejection failure during printing, by performing the second detection processing which can specify the abnormal nozzle that cannot be specified with the first detection processing, the disadvantages of the first detection processing were made to be compensated for, so it is possible to improve the ejection failure detection precision.

Also, with the second detection processing, among cases when there is and when there is not ejection failure, when it is determined that there is ejection failure, the controller 100 performs recovery processing that recovers the ejection of ink for the abnormal nozzle having ejection failure. Because of this, since recovery processing is performed on the abnormal nozzle, it is possible to suppress wasted ink consumption and to perform recovery processing in a short time.

Also, when the abnormal nozzle having ejection failure is estimated with the first detection processing, and it is determined with the second detection processing that there is ejection failure at normal nozzles other than the abnormal nozzle estimated with the first detection processing, the controller 100 performs recovery processing based on the second sensor detection results. Because of this, by emphasizing the detection results of the second sensor which has higher detection precision than the first sensor, it is possible to quickly perform recovery processing without performing re-inspection.

Also, when the abnormal nozzle having ejection failure is estimated with the first detection processing, and with the second detection processing, it is determined that there is no ejection failure for the abnormal nozzles estimated by the first detection processing, the controller 100 performs the second detection processing again. Because of this, the recovery operation does not have to be performed immediately, so it is possible to suppress wasted ink consumption. Also, when doing re-inspection, by performing the second detection processing which has higher detection precision than the first detection processing, it is possible to improve the ejection failure detection precision.

### Embodiment 2

### Liquid Ejection Inspection Device

The liquid ejection inspection device is used in a state incorporated in a printing device. It is also possible to constitute this as a dedicated device when used in-process. With embodiment 2 described hereafter, we will describe a liquid ejection inspection device incorporated in a printing device. In specific terms, we will describe this using an example of the inkjet printer 1 (hereafter also simply referred to as “the printer 1”). In this case, the printer 1 is an example of a printing device, and is also an example of a liquid ejection inspection device.

### Printer 1 Configuration Example

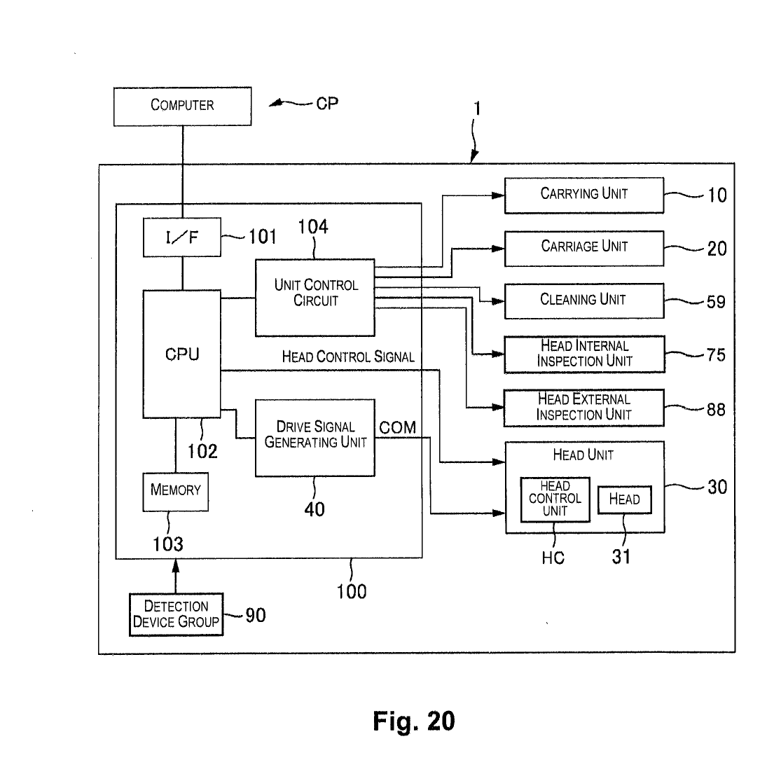

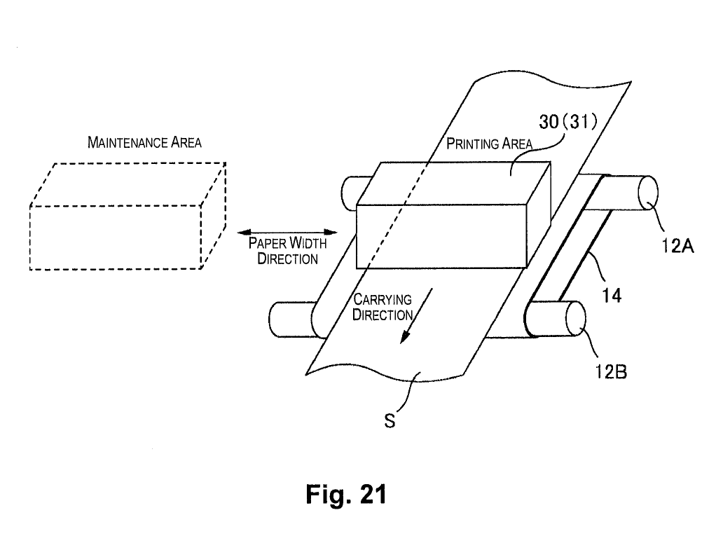

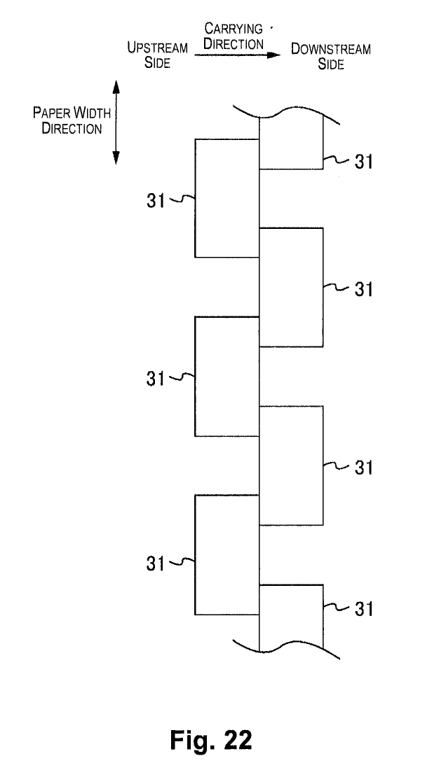

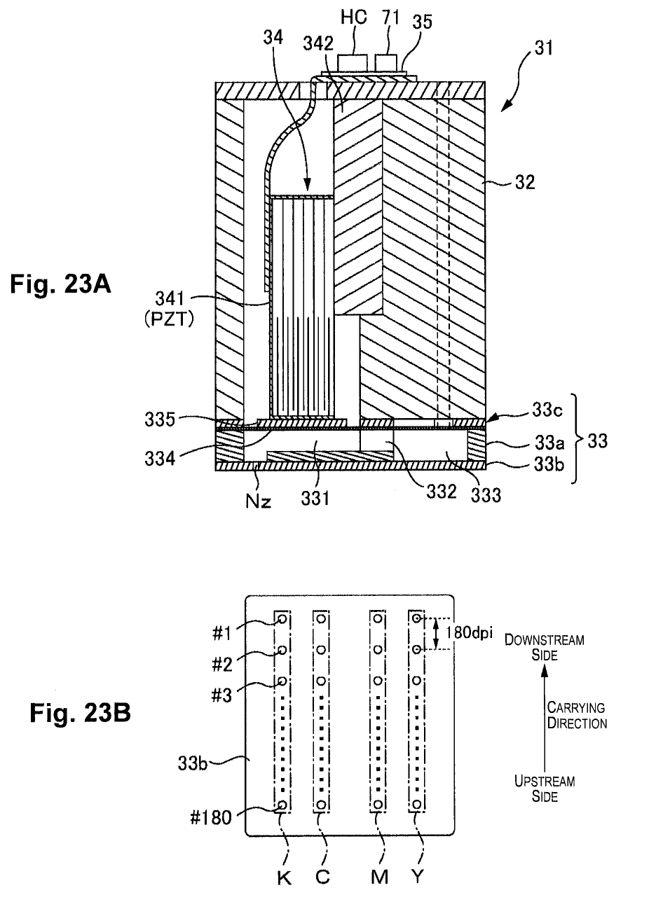

We will describe the printer 1 configuration example using FIG. 20 to FIG. 22, FIG. 23A, and FIG. 23B. FIG. 20 is a block diagram of the printer 1. FIG. 21 is a schematic diagram of the printer 1. FIG. 22 is a drawing showing the array of the plurality of heads 31. FIG. 23A is a cross section diagram of a head. FIG. 23B is a drawing showing a nozzle array.

The printer 1 ejects ink as an example of the liquid toward a medium such as paper, cloth, film or the like, and is connected so as to be able to communicate with the computer CP. In order to have an image printed by the printer 1, the computer CP is able to send printing data according to that image to the printer 1.

As shown in FIG. 20, the printer 1 of this embodiment has a carrying unit 10, a carriage unit 20, a head unit 30, a drive signal generating unit 40, a cleaning unit 59, a head internal inspection unit 75, a head external inspection unit 88, a detection device group 90, and a controller 100 for controlling these units and the like and managing the operation as the printer 1.

The carrying unit 10 is for carrying a medium (e.g. the continuous form S or the like) in a designated direction (hereafter called the “carrying direction”). As shown in FIG. 21, this carrying unit 10 has an upstream side roller 12A, a downstream side roller 12B, and a belt 14. When a carrying motor (not illustrated) rotates, the upstream side roller 12A and the downstream side roller 12B rotate, rotating the belt 14. The paper fed continuous form S is carried to an area at which it is possible to execute print processing, in other words, to the area facing opposite the head unit 30 (head 31) (hereafter referred to as the “printing area”). By the belt 14 carrying the continuous form S, the continuous form S moves in the carrying direction in relation to the head 31. The continuous form S which has passed through the printing area is carried toward the downstream side first inspection unit 75 (scanner 71) by the belt 14. The continuous form S being carried is electrostatically suctioned or vacuum suctioned to the belt 14. The carrying unit 10 of this embodiment 2 is not limited to being an item for which the continuous form S is carried by the belt 14, but can also have the continuous form S carried by a drum.

The carriage unit 20 is for carrying the head unit 30 (head 31). This carriage unit 20 has a carriage (not illustrated) supported so as to be able to move back and forth in the paper width direction of the continuous form S along the guide rail (not illustrated), and a carriage motor (not illustrated). The carriage is constituted so as to be an integrated unit with the head 31 and move by the driving of this carriage motor. The position of the carriage (head 31) on the guide rail (paper width direction position) can be found by the controller 100 detecting the rising edge and the falling edge of the pulse signals output from the encoder provided on the carriage motor and counting the edges. With this embodiment 2, when the recovery processing described later is performed, by moving the carriage in the paper width direction, the head 31 that had been positioned in the printing area is positioned in the maintenance area separated from there (area at which the recovery processing can be executed) (see FIG. 21).

The head unit 30 ejects ink toward the continuous form S that is being carried to the printing area by the carrying unit 10. The head unit 30 forms dots on the continuous form S by ejecting ink toward the continuous form S while it is being carried, and prints an image on the continuous form S.

The printer 1 of this embodiment 2 is a line printer, and the head unit 30 can form dots of the amount of a paper width at one time. Also, as shown in FIG. 22, the head unit 30 has a plurality of heads 31 aligned in zigzag form along the paper width direction, and a head control unit HC (see FIG. 20) for controlling the heads 31 based on the head control signals from the controller 100.

As shown in FIG. 23A, the head 31 has a case 32, a flow path unit 33, and a piezoelement unit 34. The case 32 is a member for housing and fixing the piezoelement PZT and the like, and for example is produced using a non-conductive resin material such as epoxy resin or the like.

The flow path unit 33 has a flow path forming substrate 33a, a nozzle plate 33b, and a vibration plate 33c. The nozzle plate 33b is joined to one surface on the flow path forming substrate 33a, and the vibration plate 33c is joined to the other surface. Formed on the flow path forming substrate 33a are the pressure chamber 331, the ink supply path 332, and the hollow part or groove that becomes the common ink chamber 333. This flow path forming substrate 33a is produced using a silicon substrate, for example. A nozzle group consisting of a plurality of nozzles Nz is provided on the nozzle plate 33b. This nozzle plate 33b is produced using a plate shaped member having conductivity, using a thin metal plate, for example. Also, the nozzle plate 33b is connected to a ground line and is at ground potential.

A diaphragm part 334 is provided at the part corresponding to each pressure chamber 331 with the vibration plate 33c. This diaphragm part 334 is deformed by the piezoelement PZT, and changes the capacity of the pressure chamber 331. By interposing a vibration plate 33c or an adhesive layer or the like, the piezoelement PZT and the nozzle plate 33b are in an electrically insulated state.

The piezoelement unit 34 has a piezoelement group 341 and a clamping plate 342. The piezoelement group 341 is in comb tooth form. Also, each individual comb tooth is a piezoelement PZT.

The tip end surface of each piezoelement PZT is adhered to the island part 335 that the corresponding diaphragm 334 has. The clamping plate 342 supports the piezoelement group 341 and is also the attachment part for the case 32. The piezoelement PZT is an example of an electromechanical conversion element, and when the drive signal COM is applied, it expands and contracts in the lengthwise direction, and a pressure change is given to the liquid inside the pressure chamber 331. The ink inside the pressure chamber 331 has pressure changes occur due to changes in the capacity of the pressure chamber 331. Using this pressure change, it is possible to eject ink drops from the nozzles Nz. Instead of the piezoelement PZT as the electromechanical conversion element, it is also possible to constitute this by ejecting ink drops by generating air bubbles according to the applied drive signal COM.

As shown in FIG. 23B, a plurality of nozzle rows for which N nozzles (for example #1 to #180) are aligned at designated intervals (e.g. 180 dpi) along the medium carrying direction are provided on the nozzle plate 33b. Each nozzle array ejects ink of respectively different colors, and for example four nozzle rows are provided on this nozzle plate 33b. In specific terms, these are a black ink nozzle row K, a cyan ink nozzle row C, a magenta ink nozzle row M, and a yellow ink nozzle row Y. Also, with this embodiment 2, it is acceptable to not provide one row each of the nozzle rows of each ink color, and it is acceptable to equip a plurality of rows each. It is also acceptable to equip a nozzle row of only one certain specified ink color.

The drive signal generating unit 40 is for generating drive signals COM. When the drive signal COM is applied to the piezoelement PZT, the piezoelement expands and contracts, and the capacity of the pressure chamber 331 corresponding to each nozzle Nz changes. Because of that, the drive signal COM is applied to the head 31 during print processing, during internal ejection inspection processing described later (also called during internal ejection detection processing) or during external ejection inspection processing (also called during external ejection detection processing), during flushing processing performed on dot omission nozzles Nz and the like.

When there is ejection failure in the nozzles Nz of the head 31, the cleaning unit 59 is for eliminating that ejection failure and recovering to a normal state. With this cleaning unit 59, in a state with the cap adhered to the bottom surface (nozzle surface) of the head 31, a suction pump (not illustrated) is operated, and by making the hollow space of the cap a negative pressure, the ink inside the head is suctioned together with the air bubbles mixed inside the head (inside the nozzles). By doing this, it is possible to recover dot omission nozzles.

The constitution of the cleaning unit 59 is not limited to this. For example, it is also possible have a wiper that can contact the nozzle surface of the head 31. Then, by moving the carriage (head 31) in the paper width direction by the driving of the carriage motor, the surface of the nozzle surface is cleaned (wiped) by the tip edge part of the wiper contacting the nozzle surface of the head 31 and bending. By doing this, the wiping unit 55 removes foreign matter such as paper dust or the like adhered to the nozzle surface, and it is possible to eject ink normally from nozzles which were clogged by that foreign matter.

It is also possible to perform a flushing operation. This flushing operation is an operation whereby drive signals unrelated to the image to be printed are applied to the drive element (piezoelement), and ink drops are forcibly continuously ejected from the nozzles. By doing this, it is possible to prevent thickening and drying of ink inside the head (inside the nozzles) resulting in the proper amount of ink not being ejected, so it is possible to recover clogged nozzles from a non-ejecting state.

The head internal inspection unit 75 is for inspecting the state of the ink inside the head 31. Specifically, this head internal inspection unit 75 functions as an internal sensor for detecting the ink state inside the head 31 when doing the internal ejection inspection described later. We will give a detailed description later regarding the specific constitution and the like of this head internal inspection unit 75. Also, “the second sensor” noted in the claims includes the internal sensor of this embodiment 2.

The head external inspection unit 88 is for inspecting whether or not the ink has been ejected to outside the head 31. Specifically, this head external inspection unit 88 functions as an external sensor for detecting ink ejection failure external to the head 31 during the external ejection inspection described later. We will give a detailed description later of the specific constitution and the like of this head external inspection unit 88. Also, “the first sensor” noted in the claims includes the external sensor of this embodiment 2.

The controller 100 is a control unit for performing control of the printer 1. As shown in FIG. 20, this controller 100 has an interface unit 101, a CPU 102, a memory 103, and a unit control circuit 104. The interface unit 101 is for performing sending and receiving of data between the host computer CP which is an external device and the printer 1. The CPU 102 is an arithmetic processing device for performing overall control of the printer 1. The memory 103 is for ensuring an area for storing the programs of the CPU 102, a work area, and the like. The CPU 102 controls each unit using the unit control circuit 104 according to the program stored in the memory 103.

The detection device group 90 is for monitoring the status inside the printer 1, and for example can be a rotary encoder used for controlling carrying of the medium or the like, a paper detection sensor for detecting the presence or absence of a carried medium, a linear encoder for detecting the movement direction position of the carriage (or head 31), or the like.

Head internal Inspection Unit 75

Here, we will describe the head internal inspection unit 75. The head internal inspection unit 75 is an internal sensor for detecting the state of the ink inside the head 31 during the internal ejection inspection which will be described later.

### Ejection Inspection Principle

As shown in FIG. 23A, when the drive signals COM are applied to the piezoelement PZT, the piezoelement PZT bends and the vibration plate 33c vibrates. Even when application of the drive signals COM to the piezoelement PZT is stopped, residual vibration occurs at the vibration plate 33c. When the vibration plate 33c vibrates due to the residual vibration, the piezoelement PZT vibrates and outputs signals according to the residual vibration of the vibration plate 33c.

Thus, by generating residual vibration at the vibration plate 33c, and detecting signals generated at the piezoelement PZT at that time, it is possible to find the characteristics (frequency characteristics) of each piezoelement PZT.

In specific terms, when the drive signals COM output from the drive signal generating unit 40 are applied to the corresponding piezoelement PZT, the vibration plate 33c in contact with that piezoelement PZT vibrates. The vibration of that vibration plate 33c does not stop right away, and residual vibration occurs. Because of this, the piezoelement PZT vibrates according to the residual vibration and outputs signals (reverse voltage). Then, that signal is input to the head internal inspection unit 75. The head internal inspection unit 75 detects the frequency characteristics of that piezoelement PZT based on the input signals. If this process is performed in sequence for the piezoelements PZT corresponding to each nozzle, it is possible to detect the frequency characteristics of each piezoelement PZT. The frequency characteristics detected in this way differ according to the state of the ink inside the head 31 (normal, air bubbles mixed in, ink thickening, paper dust adhesion). Specifically, the vibration pattern of the residual vibration differs according to the state of the ink inside the head 31 (normal, air bubbles mixed in, ink thickening, paper dust adhesion).

### Constitution

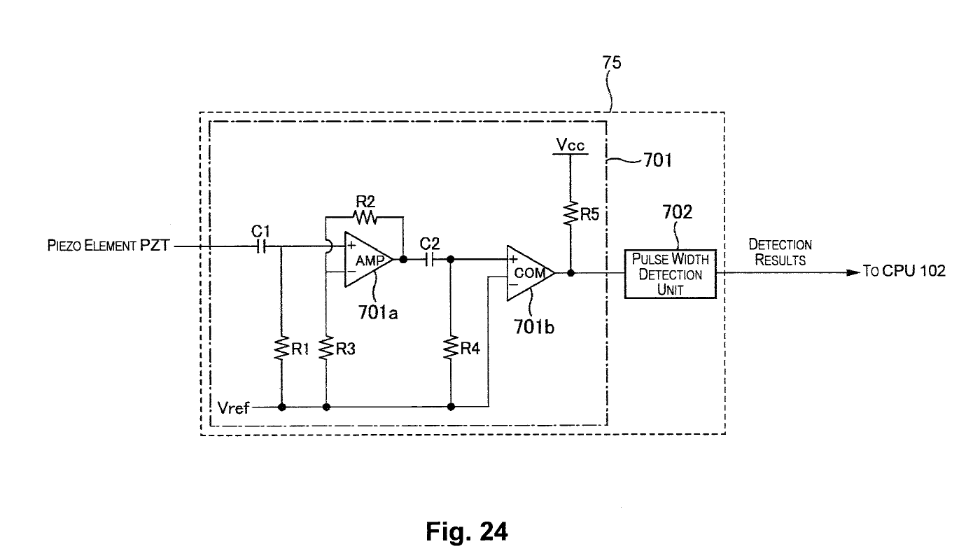

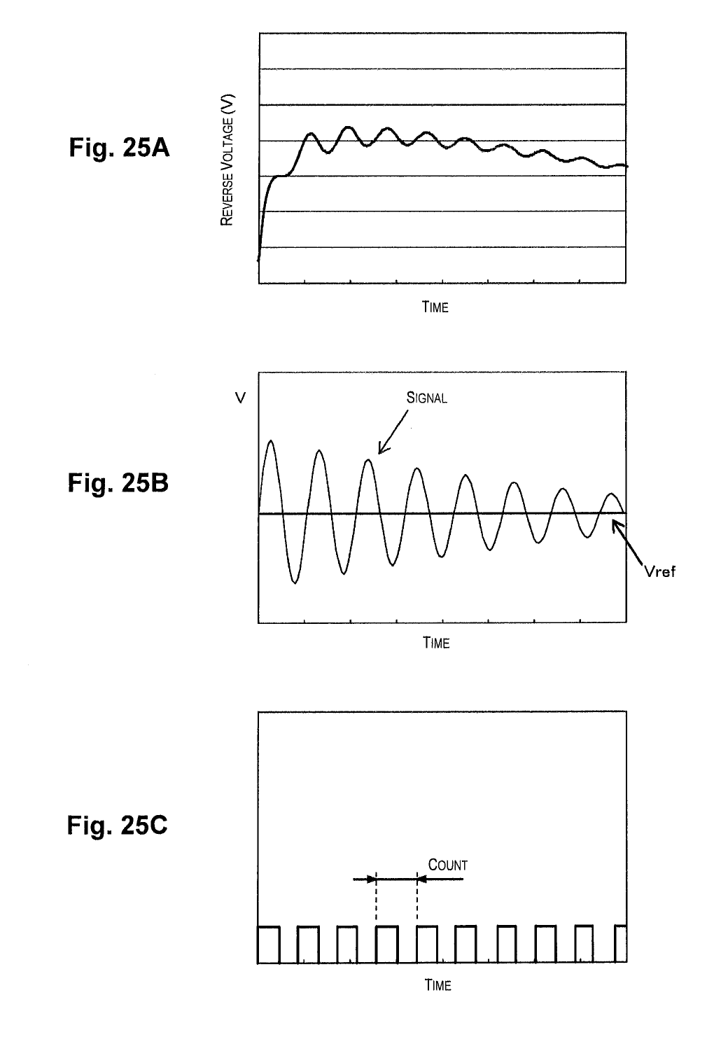

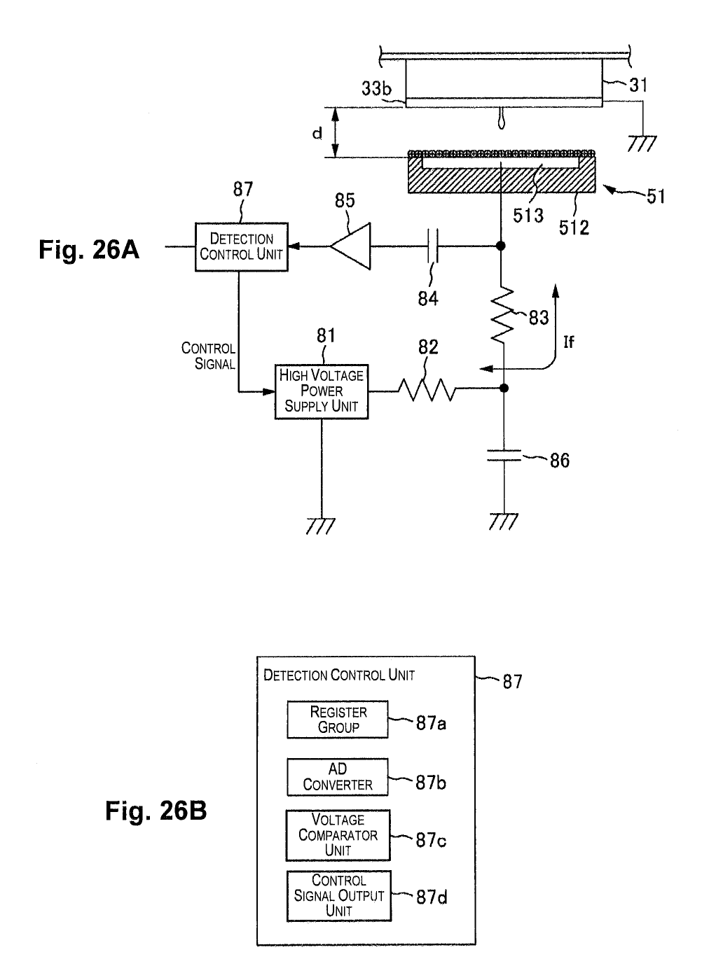

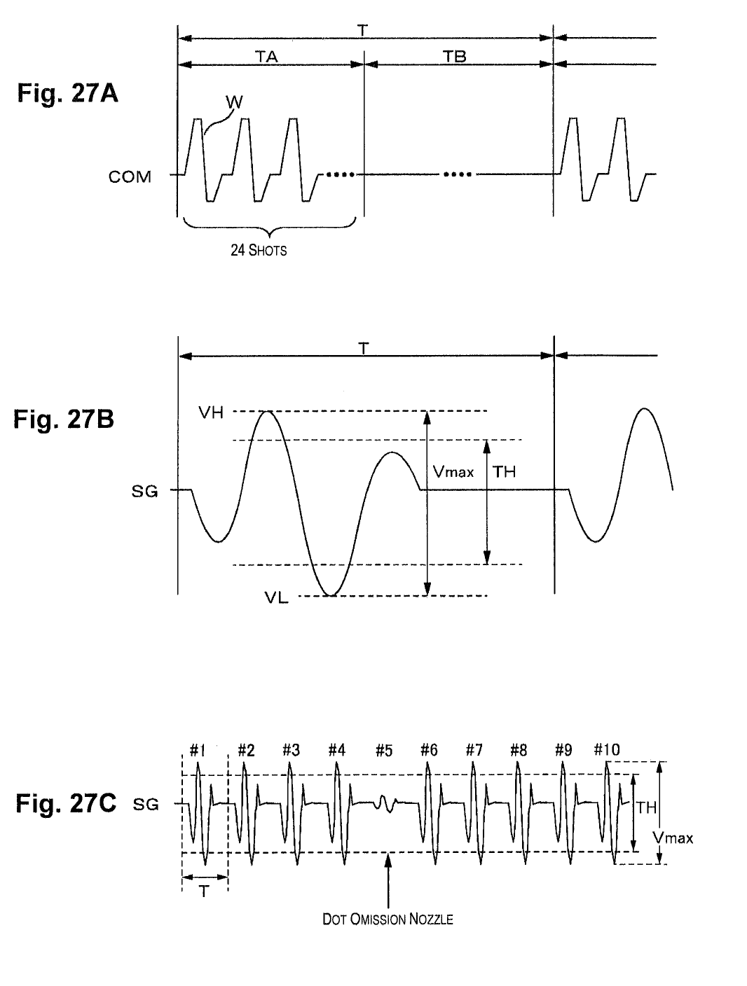

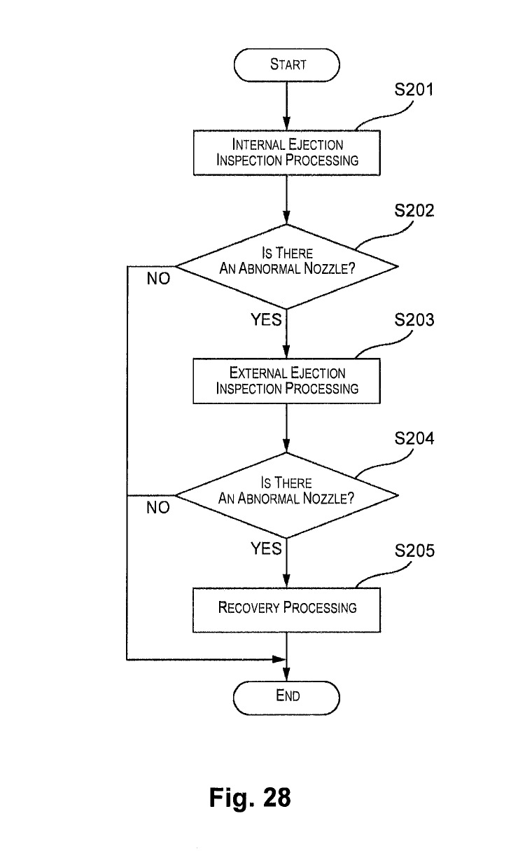

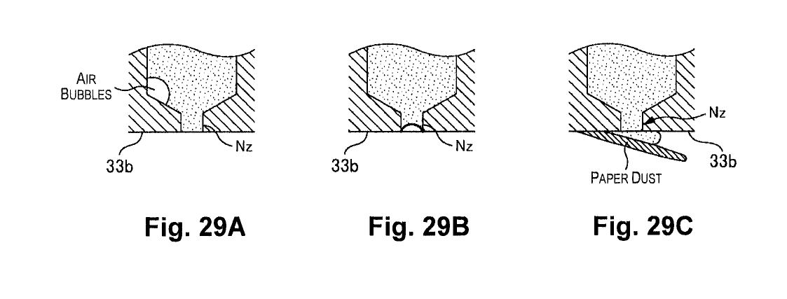

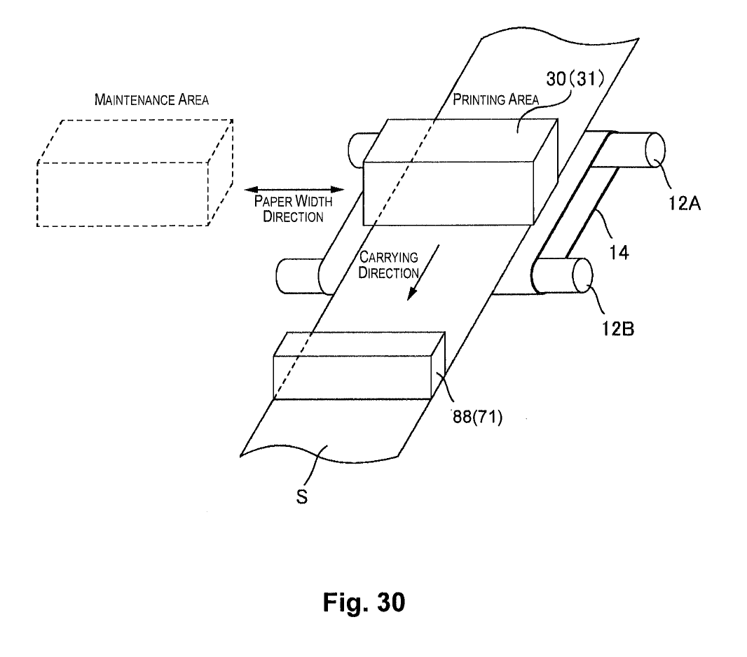

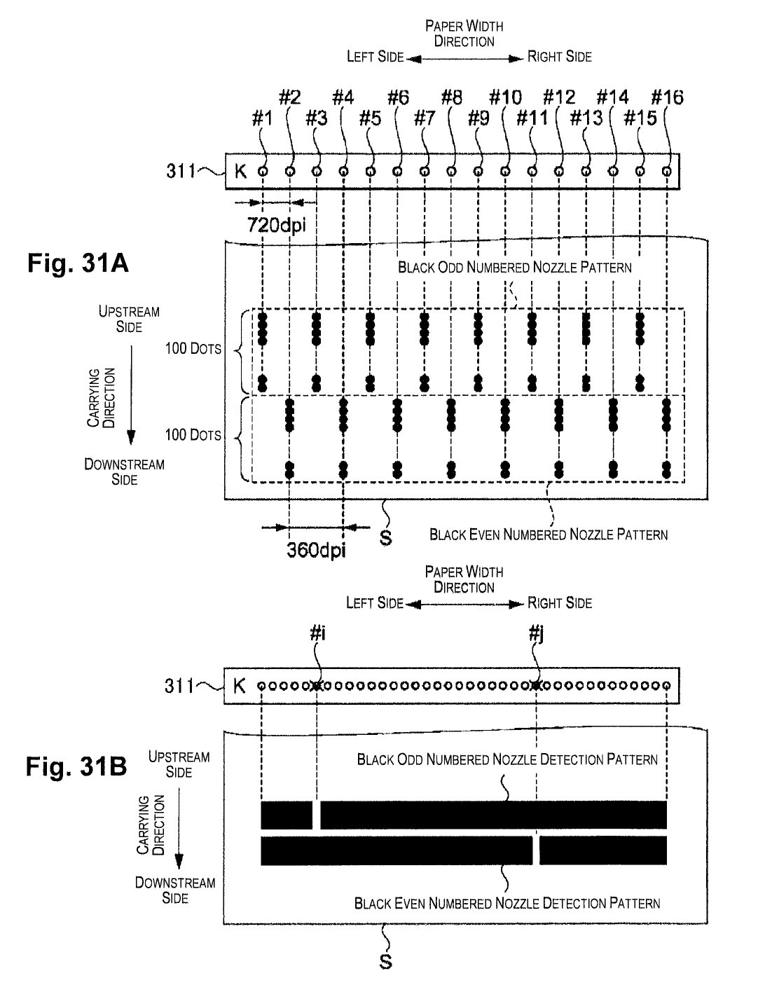

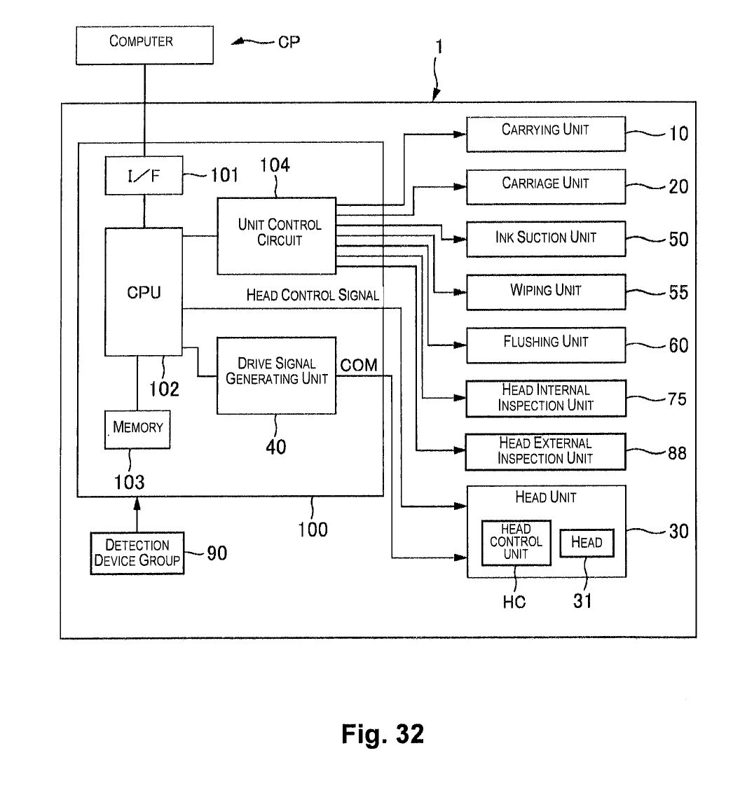

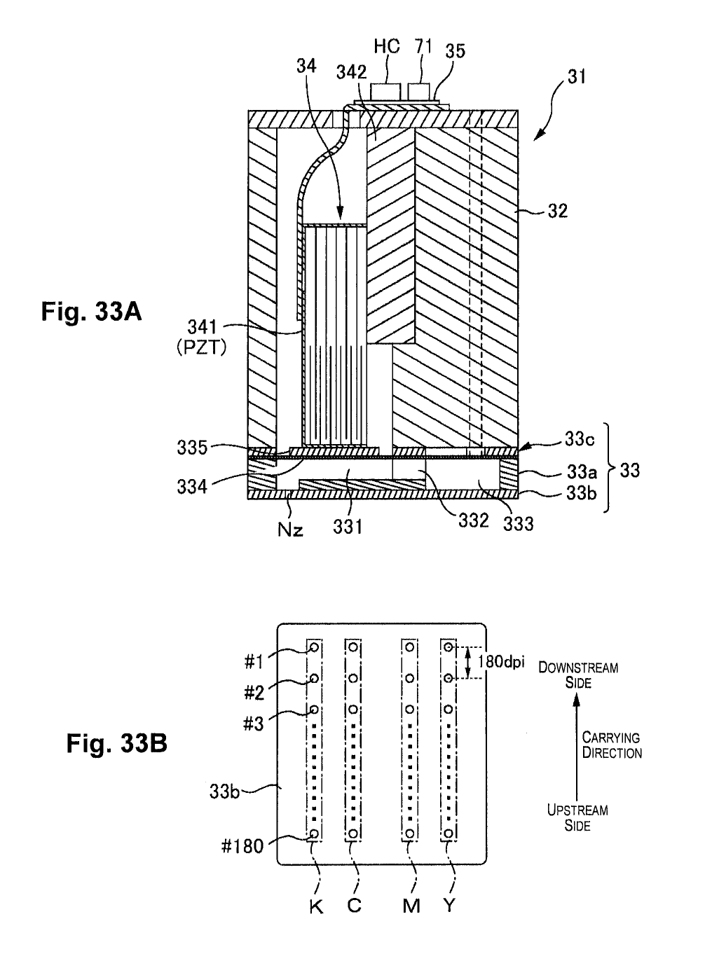

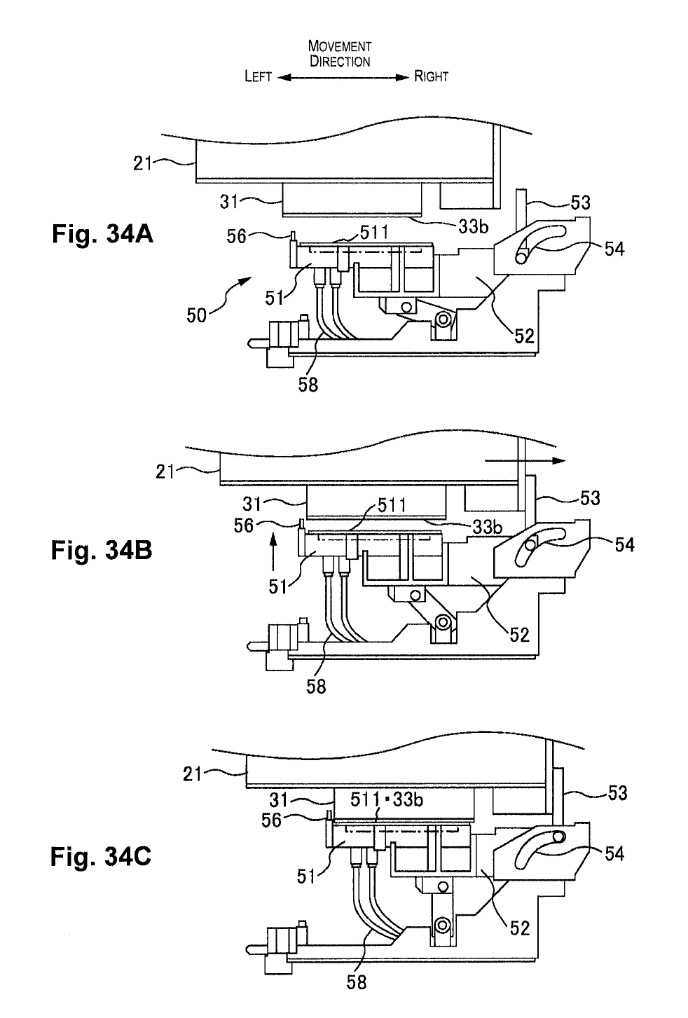

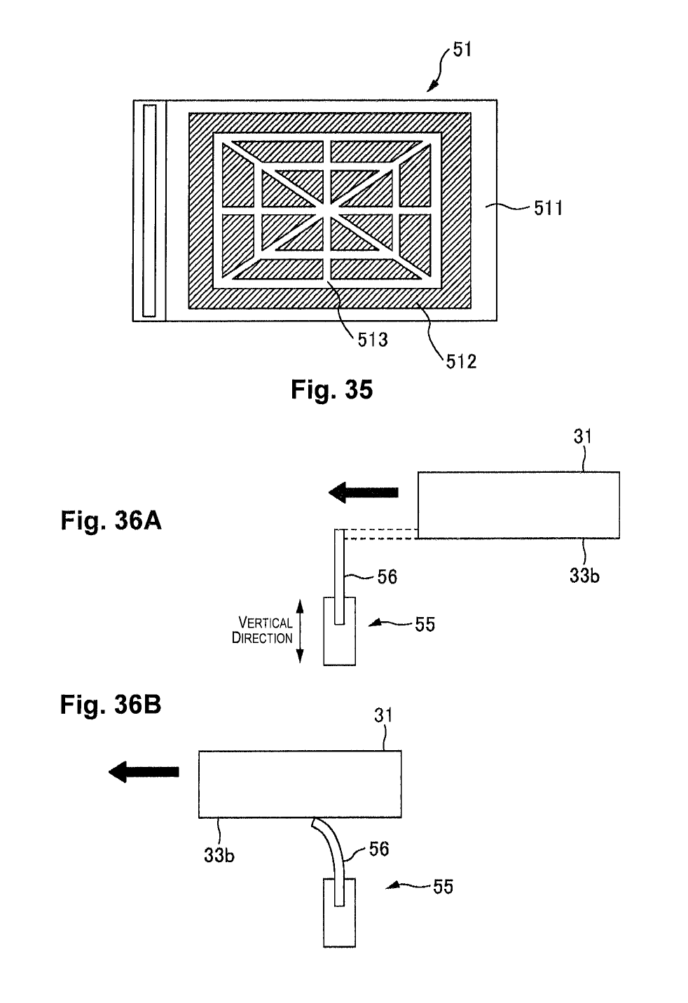

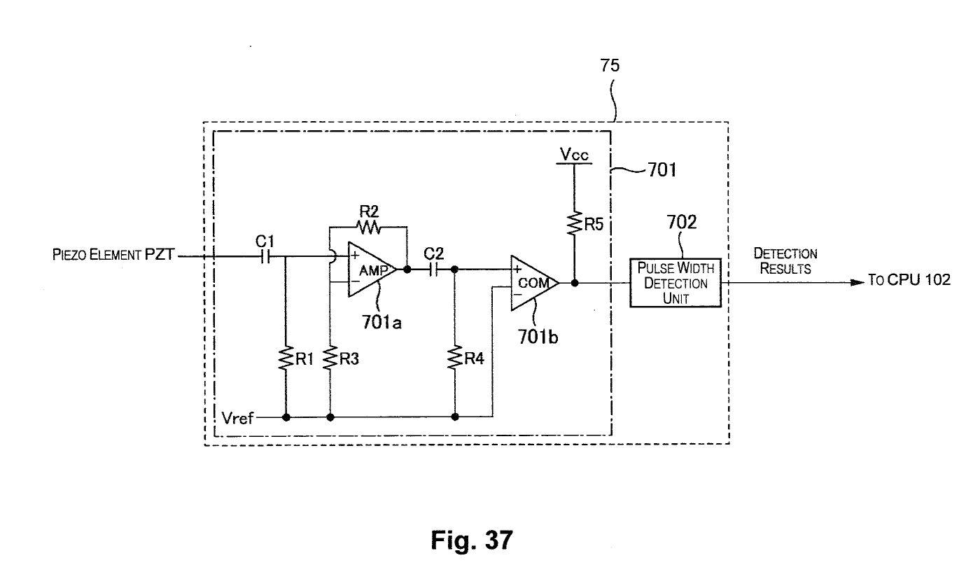

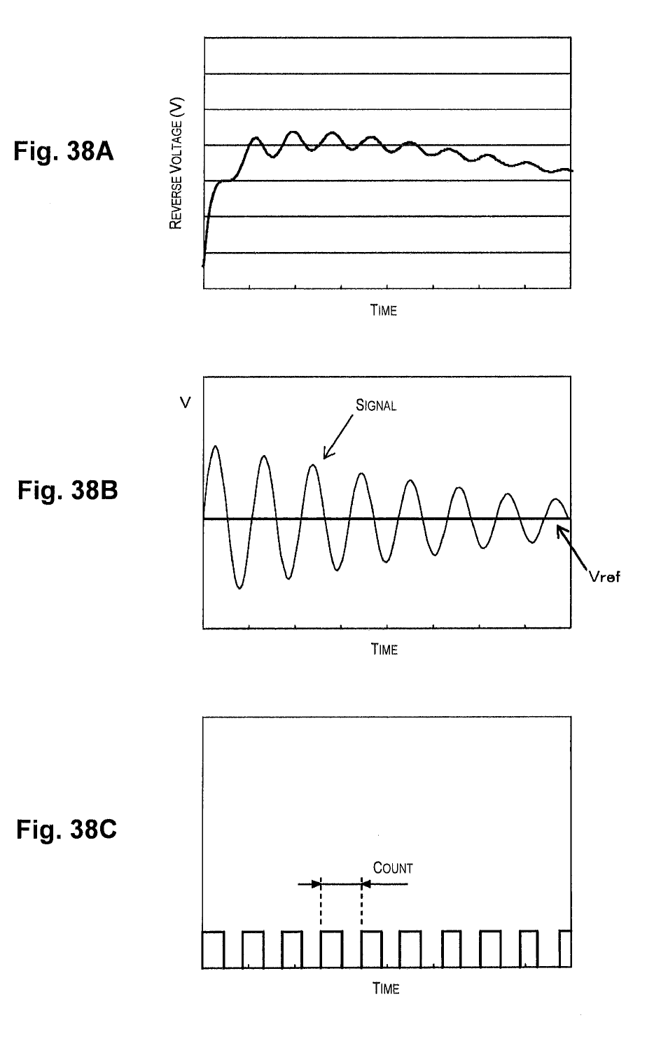

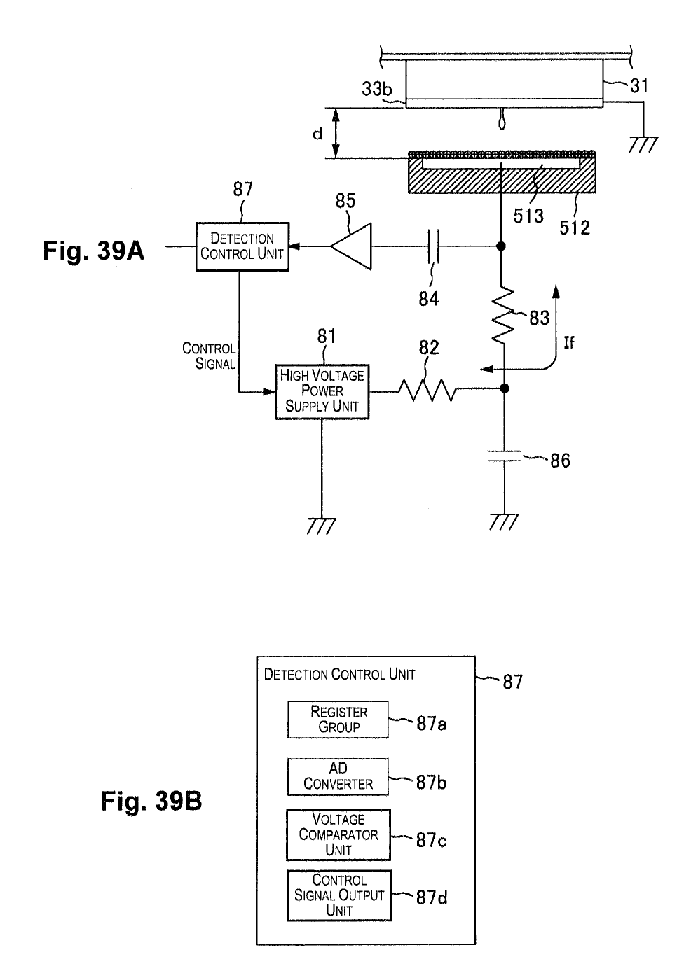

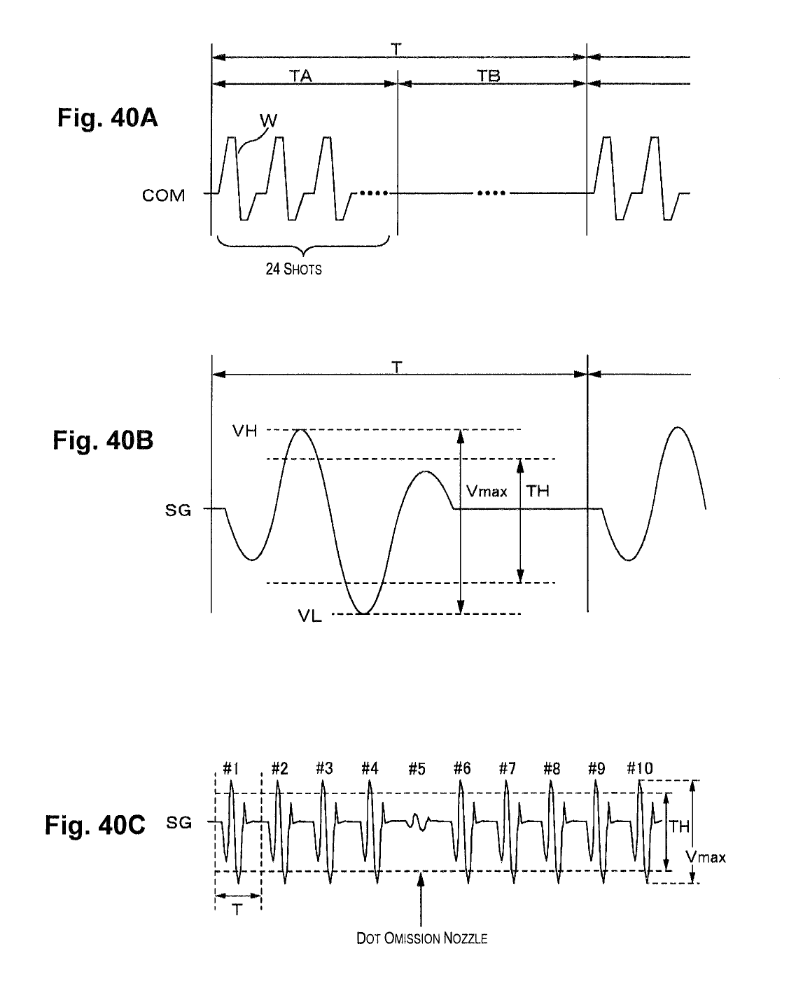

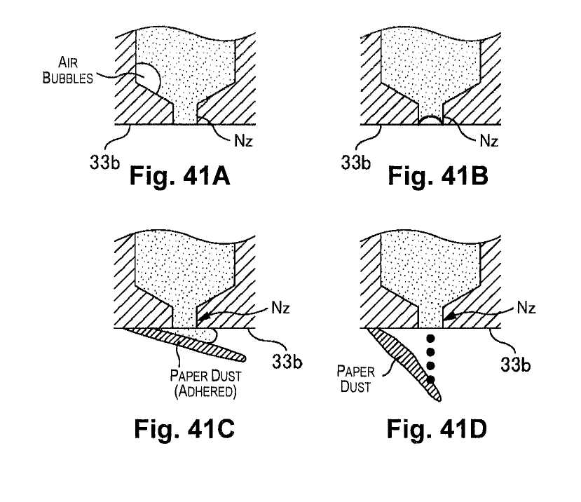

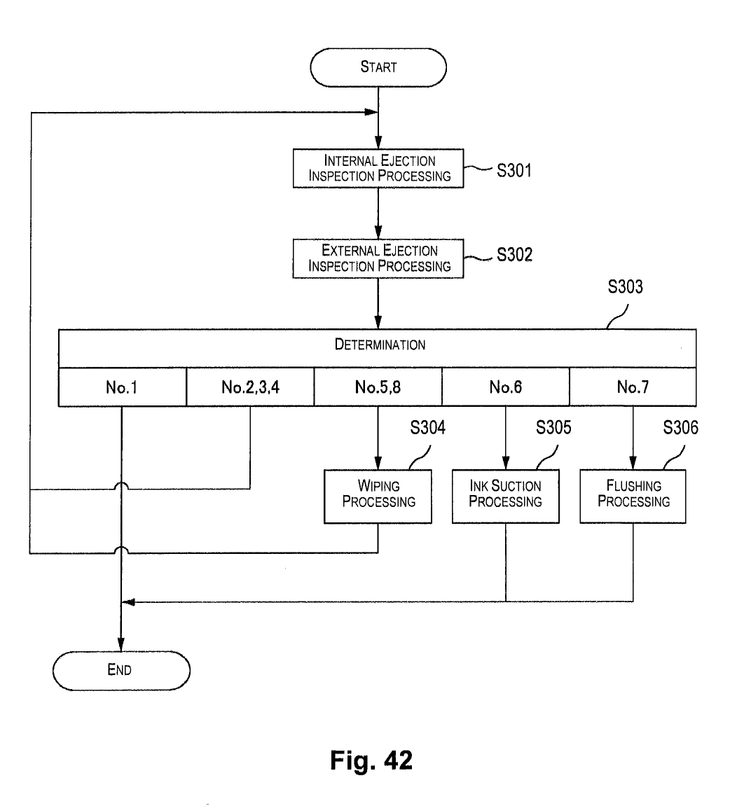

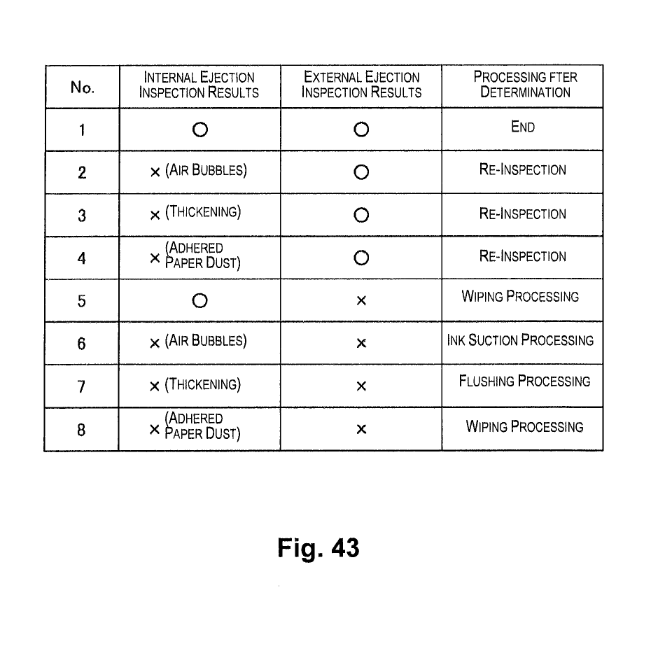

FIG. 24 is an explanatory drawing of the constitution of the head internal inspection unit 75. The head internal inspection unit 75 has an amplifier 701 and a pulse width detection unit 702.

With the amplifier 701, the low frequency elements included in the signals from the piezoelement 341 are removed by the high pass filter consisting of the capacitor C1 and the resistor R1, and this is amplified by a designated amplification rate by the operating amp 701. Next, by passing the output of the operating amp 701a through the high pass filter consisting of the capacitor C2 and the resistor R4, this is converted to a signal that vibrates vertically with the reference voltage Vref at the center. Then, this is compared to the reference voltage Vref using the comparator 701b, and the signal is binarized according to whether or not it is higher than the reference voltage Vref.

### Operation During Inspection

FIG. 25A is a drawing showing the signals output according to the residual vibration by the piezoelement PZT. The frequency characteristics differ according to the state of the ink inside the head (normal, air bubbles mixed in, ink thickened, paper dust adhered), so a unique voltage waveform (vibration pattern) is output corresponding to those respective ink states.

FIG. 25B is a drawing showing the signals after the output of the operating amp 701a passes through the high pass filter consisting of the capacitor C2 and the resistor R4 and the reference voltage Vref. Specifically, these are signals input to the comparator 701b.

FIG. 25C is a drawing showing the output signals from the comparator 701b. Specifically, these are signals input to the pulse width detection unit 702.

When the pulse shown in FIG. 25C is input, the pulse width detection unit 702 resets the count value at the rise of the pulse, increments the count value for each clock signal after that, and outputs the count value at the rise of the next pulse to the CPU 102 of the controller 100. The CPU 102 is able to detect the cycle of the signals output by the piezoelement PLT based on the count value output by the pulse width detection unit 702, specifically, based on the detection results output from the head internal inspection unit 75.

As described above, by the head internal inspection unit outputting a vibration pattern having frequency characteristics according to the residual vibration, the controller 100 is able to specify the ink state inside the head (normal, abnormality has occurred due to air bubbles mixing in inside the head, abnormality has occurred due to the ink thickening, abnormality has occurred due to an abnormality such as paper dust or the like adhering to the nozzle Nz), so it is possible to perform a suitable recovery operation corresponding to that respective ink state.

### Head External Inspection Unit 88

Next, we will describe an example of the constitution of the head external inspection unit 88. The head external inspection unit 88 is an external sensor that, during the external ejection inspection described later, actually ejects ink from each nozzle, and detects abnormal nozzles with dot omission by whether or not ink is ejected normally or not.

### Constitution

FIG. 26A is a drawing for describing the constitution of the head external inspection unit 88, and FIG. 26B is a block diagram for describing the detection control unit 87.

As shown in FIG. 26A, the head external inspection unit 88 has a detection electrode 513, a high pressure power supply unit 81, a first limiting resistor 82, a second limiting resistor 83, a detection capacitor 84, an amplifier 85, a smoothing capacitor 86, and a detection control unit 87. The nozzle plate 33b of the head 31 is grounded, and also functions as part of the head external inspection unit 88.

As shown in FIG. 26A, during the external ejection inspection process described later, the cap 51 is arranged to as to face opposite the nozzle surface with a designated gap d open. A moisture retention member 512 and a wire shaped detection electrode 513 are installed on the cap 51 provided for cleaning of the head 31. Because of this, the nozzle plate 33b and the detection electrode 513 are arranged so as to face opposite with a designated gap d left open.

This detection electrode 513 is set to a high potential of approximately 600 V to 1 kV during the external ejection inspection process described later. As the liquid (e.g. water) having conductivity of the ink solvent of this embodiment 2, when the detection electrode 513 is set to a high potential with the moisture retention member 512 in a wet state, the surface of the moisture retention member 512 is also at the same potential. In this respect, the area in which ink is ejected from the nozzles is charged uniformly across a broad scope.

The high voltage power supply unit 81 is a power supply that sets the detection electrode 513 inside the cap 51 to a designated potential. The high voltage power supply unit 81 of this embodiment 2 is constituted by a direct current power supply of approximately 600 V to 1 kV, and the operation is controlled by the control signals from the detection control unit 87.

The first limiting resistor 82 and the second limiting resistor 83 are arranged between the output terminals of the high voltage power supply unit 81 and the detection electrode 513, and these restrict the current that flows between the high voltage power supply unit 81 and the detection electrode 513. With this embodiment 2, the first limiting resistor 82 and the second limiting resistor 83 have the same low resistance (e.g. 1.6 MΩ), and the first limiting resistor 82 and the second limiting resistor 83 are connected serially. As shown in the drawing, one end of the first limiting resistor 82 is connected to the output terminal of the high voltage power supply unit 81, and the other end is connected to one end of the second limiting resistor 83, and the other end of the second limiting resistor 83 is connected to the detection electrode 513.

The detection capacitor 84 is an element for extracting the potential change element of the detection element 513, with one conductor connected to the detection electrode 513, and the other conductor connected to the amplifier 85. By interposing the detection capacitor 84 between these, it is possible to remove the bias element (direct current element) of the detection electrode 513, so it is possible to make it easy to handle the signals. With this embodiment 2, the capacity of the detection capacitor 84 is 4700 pF.

The amplifier 85 amplifies and outputs the signals (potential change) that appear at the other end of the detection capacitor 84. The amplifier 85 of this embodiment 2 is constituted by an item for which the amplification rate is a magnitude of 4000. As a result, it is possible to fetch the electric potential change element as voltage signals having a change width of approximately 2 to 3 V. A set of the detection capacitor 84 and the amplifier 85 correlates to one type of detection unit, and detects electrical changes that occur with the detection electrode 513 which occur due to ink drop ejection.

The smoothing capacitor 86 suppresses rapid changes in electric potential. With the smoothing capacitor 86 of this embodiment 2, one end is connected to a signal line connecting the first limiting resistor 82 and the second limiting resistor 83, and the other end is connected to ground. Also, the capacity is 0.1 μF.

The detection control unit 87 performs control of the head external inspection unit 88. As shown in FIG. 26B, this detection control unit 87 has a resistor group 87a, an AD converter unit 87b, a voltage comparator unit 87c, and a control signal output unit 87d. The resistor group 87a is constituted by a plurality of resistors. In each resistor is stored the determination results of each nozzle Nz or a voltage threshold value for determination or the like. The AD converter unit 87b converts voltage signals (analog signals) after amplification output from the amplifier 85 to digital values. The voltage comparator unit 87c compares the size of the amplitude value based on the voltage signal after amplification with a voltage threshold value. The control signal output unit 87d outputs the control signal for controlling the operation of the high voltage power supply unit 81.

### Ejection Inspection Principle

When ink is ejected from the nozzles of the nozzle plate 33b, the electric potential of the detection electrode 513 changes, the detection capacitor 84 and the amplifier 85 detect this electric potential change, and detection signals are output to the detection control unit 87. Even when an attempt is made to eject ink from the abnormal nozzle, ink is not ejected to outside the head 31, so the electric potential of the detection electrode 513 does not change, and electric potential changes do not appear in the detection signals.

In specific terms, the nozzle plate 33b is set to ground potential, and the detection electrode 513 arranged in the cap 51 is set to a high potential of approximately 600 V to 1 kV. The nozzle plate 33b is set to ground potential, so the ink drops ejected from the nozzles are also at ground potential. The nozzle plate 33b and the detection electrode 513 face opposite each other in a state with a designated gap d (see FIG. 26A) left open, and ink drops are ejected from nozzles subject to detection. When ink drops are ejected, electrical changes caused on the detection electrode 513 side due to this are fetched as voltage signals SG by the detection control unit 87 via the detection capacitor 84 and the amplifier 85. Then, the detection control unit 87 judges whether or not ink drops have been normally ejected from the nozzles subject to detection based on the amplitude value (electric potential changes) in the voltage signals SG.

Specifically, as shown in FIG. 26A, by arranging the nozzle plate 33b and the detection electrode 513 with a designated gap d left open, these members can be constituted so as to behave in the same manner as capacitors. It is known that typically, when the gap d of two conductors constituting a capacitor changes, the charge Q stored in the capacitor changes. When ink is ejected from the ground potential nozzle plate 33b toward the high potential detection electrode 513, the gap d between the ground potential ink drop and the detection electrode 513 changes, and as with when the gap d of the two conductors of the capacitors changes, the charge Q stored in the detection electrode 513 changes (the electrostatic capacity of the capacitors changes). Then when the electrostatic capacity of the capacitors becomes smaller, the volume of the charge that can be stored between the nozzle plate 33b and the detection electrode 513 decreases, so the surplus charge moves from the detection electrode 513 through each limiting resistor 82 and 83 to the high voltage power supply unit 81 side. Specifically, current flows toward the high voltage power supply unit 81.

Meanwhile, when the electrostatic capacity increases and the reduced electrostatic capacity returns, the charge moves from the high voltage power supply unit 81 through each limiting resistor 82 and 83 to the detection electrode 513 side. Specifically, current flows toward the detection electrode 513. By this kind of current (for convenience, this is also called ejection inspection current If) flowing, the potential of the detection electrode 513 changes. The change in electric potential of the detection electrode 513 also appears as an electric potential change of the other conductor in the detection capacitor 84 (conductor on the amplifier 85 side). Therefore, by observing the electric potential change of the other conductor, it is possible to determine whether or not ink drops were ejected.

### Operation During Inspection

FIG. 27A is a drawing showing an example of the drive signal COM used during ejection inspection, FIG. 27B is a drawing for describing the voltage signal SG output from the amplifier 85 when ink is ejected from the nozzles by the drive signal COM of FIG. 8A, and FIG. 27C is a drawing showing a voltage signal SG which is the ejection inspection result of a plurality of nozzles (#1 to #10). As shown in FIG. 27A, the drive signal COM has a plurality of drive waveforms W (e.g. 24) for ejecting ink from nozzles at the first half period TA of the repeated time T, and the intermediate electric potential at the latter half period TB is kept at a fixed electric potential. The drive signal generating unit 40 does repeated generation of a plurality of drive waveforms W (24 drive waveforms) for each repeated time T. This repeated time T correlates to the time required for one nozzle inspection.

First, drive signals COM are applied across the repeated time T to the piezoelements corresponding to certain nozzles among the inspection subjects. Having done that, at first half period TA, ink drops are continuously ejected from the nozzles that are ejection inspection subjects (e.g. 24 shots are fired). As a result, the electric potential of the detection electrode 513 changes, and the amplifier 85 outputs that electric potential change as the voltage signal SG (sine curve) shown in FIG. 27B to the detection control unit 87. The vibration of the voltage signal SG due to the ink drop of one shot portion is small, so it was made possible to obtain a voltage signal SG with a sufficient amplitude for inspection by continuously ejecting ink drops from the nozzle.

Then, the detection control unit 87 calculates the maximum amplitude Vmax (difference between the maximum voltage VH and minimum voltage VL) from the voltage signals SG of the inspection time (T) of the inspection subject nozzle, and compares the maximum amplitude Vmax and a designated threshold TH. If the ink is ejected from the inspection subject nozzle according to the drive signal COM, the electric potential of the detection electrode 513 changes, and the maximum amplitude Vmax of the voltage signal SG becomes larger than the threshold TH. Meanwhile, when ink is not ejected from the inspection subject nozzle, or the ejection volume is smaller due to clogging or the like, the electric potential of the detection electrode 513 does not change, or the amount of electric potential change is small, so the maximum amplitude Vmax of the voltage signal is the threshold TH or lower.

After the drive signal COM is applied to the piezoelement corresponding to a certain nozzle, as with the drive signals COM being applied across the repeated time T on the piezoelement corresponding to the next inspection subject nozzle, the drive signals COM are applied to the piezoelement corresponding to that nozzle across the repeated time T for each single nozzle subject to inspection. As a result, as shown in FIG. 27C, the detection control unit 87 is able to fetch the voltage signals SG for which sine curve electric potential changes occur for each repeated time T.

For example, with the results of FIG. 27C, the maximum amplitude Vmax of the voltage signal SG corresponding to the inspection time of the nozzle #5 is smaller than the threshold value TH, so the detection control unit 57 judges that the nozzle #5 is a dot omission nozzle (abnormal nozzle). The maximum amplitude Vmax of the voltage signals SG corresponding to each inspection time of the other nozzles (#1 to #4, #6 to #10) is the threshold value TH or greater, so the detection control unit 87 judges that the other nozzles are normal nozzles.

### Example of Printer 1 Operation

### Overall Operation

Here, we will describe the overall operation of the printer 1. With the printer 1 of this embodiment 2, the controller 100 controls the subjects of control (carrier unit 10, carriage unit 20, head unit 30, drive signal generating unit 40, cleaning unit 59, head internal inspection unit 75, and head external inspection unit 88) according to the computer program stored in the memory 103, and performs each process. Therefore, this computer program has codes for controlling the control subjects in order to execute these processes.

In specific terms, the controller 100 performs print processing and dot omission inspection processing. In specific terms, the controller 100 performs printing instruction receiving, the paper feeding operation, the dot formation operation, the carrying operation, the print end decision, the internal ejection inspection processing, the external ejection inspection processing, and the recovery operation. Following, we will give a brief description of each process.

The printing instruction receiving is a process of receiving printing instructions from the computer CP. With this process, the controller 100 receives printing instructions via the interface unit 101.

The paper feeding operation is an operation that moves the continuous form S which is subject to printing, and positions it in the printing start position (so-called cueing position). With this operation, the controller 100 moves the continuous form S by driving the carrying motor.

The dot forming operation is an operation for forming dots on the continuous form S. With this operation, the controller 100 outputs control signals to the head 31. At this time, by the drive signal COM generated by the drive signal generating unit 40 being applied to the piezoelement PZT, ink is ejected from the nozzle Nz. By doing this, ink is intermittently ejected from the nozzles Nz of the head 31, and dots are formed on the continuous form S.

The carrying operation is an operation of moving the continuous form S in the carrying direction. The controller 100 is able to form dots at positions different from the dots formed by the previous dot forming operation by driving the carrying motor.

The print end judgment is a judgment of whether or not to continue printing. The controller 100 performs the print end judgment based on the presence or absence of print data on the continuous form S which is the printing subject.

The dot omission inspection operation is an operation for inspecting the presence or absence of ejection failure (dot omission). The controller 100 performs the internal ejection inspection processing using the head internal inspection unit 75 in parallel with the printing process, and when there was an ejection failure from the detection results of the internal ejection inspection processing, it performs the external ejection inspection processing using the head external inspection unit 88. Then, the controller 100 performs a recovery operation according to the detection results of the external ejection inspection processing. We will give a detailed description of this dot omission inspection operation later.

The recovery operation is an operation of recovering a certain head 31 in an ejection failure state to a state in which it can eject ink normally. The controller 100 performs any of the operations including the flushing operation, the ink suction operation, and the wiping operation on a head in an ejection failure state by operating the cleaning unit 59.

### Dot Omission Detection Operation

Next, we will describe the dot omission inspection operation using FIG. 28, and FIG. 29A through FIG. 29C. FIG. 28 is a flow chart showing an example of the dot omission inspection operation. FIG. 29A is a drawing showing the state with air bubbles mixed in. FIG. 29B is a drawing showing the state with the ink thickened and dried. FIG. 29C is a drawing showing the state with foreign matter such as paper dust or the like adhered to the nozzle.

As shown in FIG. 28, first, the controller 100 performs internal ejection inspection processing (S201) in parallel with print processing in a state with the head 31 positioned in the printing area (see FIG. 21).

With this internal ejection inspection processing, by fetching the detection results of the head internal inspection unit 75, inspection is performed for each nozzle of whether the state of the ink inside the head is normal or abnormal. Then, according to this internal ejection inspection, as the detection results of the head internal inspection unit 75, the controller 100 is able to fetch any of the following results: an abnormality has occurred due to mixing in of air bubbles (see FIG. 29A), an abnormality has occurred due to the ink thickening and drying (see FIG. 29B), and an abnormality has occurred due to foreign matter such as paper dust or the like adhering to the nozzle Nz (see FIG. 29C). Specifically, the controller 100 is able to specify abnormal nozzles estimated to have ejection failure from the state of the ink inside the head (ejection failure cause) and the state of that ink. The “detection processing of the second sensor” noted in the claims includes the internal ejection inspection processing of this embodiment 2.

Subsequently, the controller 100, based on the detection results of the head internal inspection unit 75, determines the presence or absence of abnormal nozzles having ink state abnormalities (S202), and when it is determined that there are no abnormal nozzles (S202: No), the head 31 is in a normal state, so the processing ends as is, and when it is determined that there is an abnormal nozzle (S202: Yes), print processing is suspended, and external ejection inspection processing is performed (S203). At that time, the controller 100 moves the head unit 30 from the printing area to the maintenance area by operating the carriage unit 20, and after that, performs the external ejection inspection processing. Because of that, when performing this external ejection inspection, compared to the internal ejection inspection performed while forming a printed image on the continuous form S, separate time is spent for the ejection inspection which is different from the image forming time. Therefore, by first performing internal ejection inspection and moving to the external ejection inspection when an abnormal nozzle is detected, it is possible to reduce the frequency of performing the external ejection inspection which requires a great deal of time, so it is possible to perform dot omission inspection efficiently.

With this external ejection inspection processing, by fetching the detection results of the head external inspection unit 88, inspection is done of the presence or absence of ejection failure (dot omission) due to ink drops not being ejected to outside the head 31. Then, with this external ejection inspection, it is possible for the controller 100 to fetch as the detection results of the head external inspection unit 88 either of the following results: that the ink drops are being ejected normally to outside the head (no dot omission), or that the ink drops are not being ejected normally to outside the head (there is dot omission). The “detection processing by the first sensor” noted in the claims includes the external ejection inspection processing of this embodiment 2.

With this embodiment 2, external ejection inspection processing is performed on nozzles specified as abnormal nozzles with the previously performed internal ejection inspection processing. Because of this, inspection processing is performed on the minimum nozzles necessary, and it is possible to lower the information volume of the drive signals COM or the like generated by the drive signal generating unit 40, so it is possible to perform ejection inspection in a shorter time compared to when performing inspection processing (also called detection processing) on all the nozzles.

Subsequently, the controller 100 determines the presence or absence of abnormal nozzles having ejection failure (S204) based on the detection results of the head external inspection unit 88, and when it is determined that there are no abnormal nozzles (S204: No), though there is an ink state abnormality inside the head 31, normal printing is performed by ink drops actually being ejected on the continuous form S, so the processing ends as is without performing recovery processing, and print processing is restarted.

On the other hand, when the controller 100 determines that there are abnormal nozzles (S204: Yes), recovery processing is performed to recover the abnormal nozzles to normal nozzles (S205).

This recovery processing is performed when the head unit 30 is positioned in the maintenance area, so when an abnormal nozzle is detected using the external ejection inspection results, it is possible to perform recovery processing immediately. After that, when the recovery processing is completed, the controller 100 moves the head unit 30 from the maintenance area to the printing area, and restarts the print processing.

As described above, with this embodiment 2, the dot omission detection operation is performed while performing print processing, but in addition to this, it is possible to perform the dot omission detection operation even after print processing has ended.

For example, it is possible to perform the dot omission detection operation before the printer main unit power supply is shut off. It is also possible to perform the dot omission detection operation immediately after the power is turned on, before starting print processing.

Then, the dot omission detection operation in this case is set so that the external ejection inspection processing is performed without being based on the detection results of the internal ejection inspection processing, and recovery processing is performed according to the detection results of this external ejection inspection processing. This is because as described above, only when there is an abnormality in the ink state according to the detection results of the internal ejection inspection processing, when control is done so as to start the external ejection inspection processing, for example when the power supply is turned on or shut off or the like, when one wishes to ensure a state with no dot omission with the actual printed image (when one wishes to maintain the printed image quality), regardless of the fact that it is necessary to perform external ejection inspection because it is not possible to detect dot omission of the printed image with the internal ejection inspection, it becomes impossible to immediately start the external ejection inspection processing.

Also, performing dot omission inspection when the power is turned on or the power is shut off in this way has advantages such as those described hereafter. For example, after print processing ends, despite the fact that there is an abnormal nozzle with ejection failure, if the power is shut off without performing cleaning, the abnormal state of the abnormal nozzle is maintained as is. As a result, if the power of the printer 1 is turned on after that and print processing is started anew, defective printed materials will be created from the printing start. In contrast to this, by performing dot omission inspection even when the power is turned on or the power is shut off, it is possible to quickly start the print processing without creating defective printed matter from the start.

### Effectiveness of the Printer 1 of This Embodiment

As described above, the printer 1 of this embodiment 2 is equipped with a head 31 for performing printing by ejecting ink on a medium, a head internal inspection unit 75 for detecting the state of the ink inside the head 31, a head external inspection unit 88 for detecting an ink ejection failure outside the head 31, and a controller 100 for, based on the detection results of the head internal inspection unit 75, determining whether or not to perform detection of the head external inspection unit 88, and according to the detection results of the head external inspection unit 88, performing recovery processing to recover ejection of ink by the head 31.

When filling ink from the ink cartridge into the head and air bubbles mix in, when the ink thickens or dries because ink (liquid) has not been ejected from the nozzles Nz for a long time, or foreign matter such as paper dust or the like adheres to the nozzle Nz, clogging can occur with the nozzle Nz. When the nozzle Nz clogs in this way, ink is not ejected when ink is supposed to be ejected from the nozzle Nz, and dot omission occurs (ejection failure). Dot omission is a phenomenon whereby dots are not formed at the location at which dots are originally supposed to be formed when ink is ejected from the nozzle Nz. When dot omission occurs, it becomes a cause of image quality degradation. As described above, as one ejection inspection for detecting dot omission, there is the internal ejection inspection that uses an internal sensor. With this internal ejection inspection, the internal sensor detects the state of the ink inside the head, so even if the ink state is abnormal, it was not possible to detect whether or not ink drops are actually ejected to outside the head. In light of this, with this embodiment 2, to compensate for the disadvantages of the internal ejection inspection, external ejection inspection using an external sensor was made to be performed. Because of this, by performing external ejection inspection when it is determined that the ink state is abnormal by the detection results of the internal ejection inspection, it is possible to specify whether or not a printed image is formed without causing dot omission by actually ejecting ink drops to outside the head, making it possible to improve the ejection failure detection precision.

Also, with the dot omission inspection processing of this embodiment 2, the external ejection inspection is made to be performed after first performing internal ejection inspection. By doing this, the following points become effective. For example, if the external ejection inspection is performed first, though it is possible to immediately detect whether or not dot omission has actually occurred, since it is not performed in parallel with print processing (because this is performed by printing being suspended, and moving the head unit 30 from the printing area to the maintenance area), compared to internal ejection inspection performed while forming the printed image, separate time is spent for the ejection inspection which is different from the image forming time. In contrast to this, with this embodiment 2, the internal ejection inspection is performed, the abnormal nozzle having ejection failure is estimated, after that the process moves to the external ejection inspection, and by checking for the presence or absence of ejection failure using time that is different from the printing time, the abnormal nozzle for which there is a risk of actually affecting the printing quality is specified. By doing this, it is possible to reduce the frequency of external ejection inspections which require separate time for inspection, so it is possible to perform dot omission inspection efficiently.

Also, with the controller 100, internal ejection inspection processing is performed in parallel with the print processing for printing an image on the continuous form S, a determination is made of whether or not to perform external ejection inspection processing based on the detection results of the internal ejection inspection, and when it is determined to perform this, the external ejection inspection processing is performed, recovery processing is performed according to the detection results of the external ejection inspection, and when the power is turned on to supply power to the device main unit, or when that power is shut off, the external ejection inspection processing is performed without being based on the detection results of the internal ejection inspection, and recovery processing was made to be performed according to the detection results of the external ejection inspection. In this way, in contrast to during printing, when the power is turned on or shut off, it is possible to reliably perform external ejection inspection, so it is possible to detect whether or not there is an actual effect by the ejection failure on the printed image quality.

Also, with the controller 100, external ejection inspection was made to be performed using the head external inspection unit 88 (external sensor) on abnormal nozzles determined to have ejection failure by the detection results of the internal ejection inspection using the head internal inspection unit 75 (internal sensor). As a result, it is possible to perform external ejection inspection using an external sensor in a shorter time than when performing on all nozzles.

### Embodiment 3

The same as the printer 1 of the embodiment 2 described above, the printer 1 of the embodiment 3 has a carrier unit 10, a carriage unit 20, a head unit 30, a drive signal generating unit 40, a cleaning unit 59, a head internal inspection unit 75, a head external inspection unit 88, a detection device group 90, and a controller 100 that controls these units and the like and manages their operation as the printer 1.

However, with the printer 1 of embodiment 3, the constitution of the head external inspection unit 88 differs from that of the liquid ejection device 1 of embodiment 2. Also, the dot omission inspection operation with the printer 1 of embodiment 3 also differs from that of the printer 1 of embodiment 2.

Therefore, hereafter, we will give specific descriptions of the head external inspection unit 88 with its constitution differing from embodiment 2 and of the dot omission inspection operation differing from embodiment 2.

### Head External Inspection Unit 88

With embodiment 2 described above, as an example of the head external inspection unit 88 (external sensor), we will describe an item that ejects charged ink drops from a nozzle toward an electrode for detection, and detects electrical changes that occur with this electrode (see FIGS. 26A and 26B).

In contrast to that, with this embodiment 3, a reading device such as a scanner or the like is used as the external sensor, a detection pattern is printed on the blank space of the continuous form S so as not to overlap the printed image, and ejection failure detection is done by reading this detection pattern with a scanner. This will be described in detail hereafter. The “first sensor” noted in the claims includes the external sensor of this embodiment 3, and the “second sensor” noted in the claims includes the internal sensor of this embodiment 3.

### Constitution

FIG. 30 is a schematic drawing showing another constitutional example of the printer 1. The head external inspection unit 88 is provided at a position further downstream in the carrying direction than the head unit 30 (head 31), and has a scanner 71 that is able to read a continuous form S paper width amount of a printed image at one time. This scanner 71 has a light source unit for radiating illumination light on the continuous form S and a photosensitive unit for receiving the reflected light reflected by the continuous form S, and is able to read the printed image printed by the printer 1 for each scanner color. The light source unit has a substrate on which a plurality of white LEDs are arranged. The photosensitive unit has an image sensor such as a CCD or the like, and a lens for converging the reflected light on the image sensor, and outputs voltage of a size according to the intensity of the received reflected light.

### Summary of the Detection Pattern

FIG. 31A is a drawing showing a detection pattern for detecting abnormal nozzles. Here, a detection pattern formed by a black nozzle row (K) 311 is shown. Also, with the head unit 30, as shown in FIG. 23A, the heads 31 are arranged in zigzag form, but for the sake of explanation hereafter, as shown in FIG. 31A, nozzles are shown aligned in one row in the paper width direction on the bottom surface of the head unit 30. Also, the number of nozzles that the head unit 30 has is reduced, and lower numbers are given in sequence from the left side nozzles of the paper width direction.

By having ink ejected from even numbered nozzles on the continuous form S carried under the head unit 30, and after that, having ink ejected from the odd numbered nozzles, an inspection pattern corresponding to one nozzle row is formed. Because of that, the inspection pattern is constituted from a dot row along the carrying direction. Here, one dot row is constituted from 100 dots, for example. Then, to form dot rows at every other nozzle aligned in the paper width direction, dot row groups (area enclosed by the dotted line) aligned at designated gaps (for example 360 dpi) in the paper width direction are formed with two aligned in the carrying direction. One of these dot row groups is called a “failure detection pattern.” Also, with this embodiment 3, a failure detection pattern is formed with every other nozzle aligned in the paper width direction, and two failure detection patterns are formed for one nozzle row. Because of that, to distinguish the two failure detection patterns formed on the black nozzle row (K) 311, for example these are called the “black even numbered nozzle failure detection pattern” and the “black odd numbered nozzle failure detection pattern.”

FIG. 31B is a drawing with a macroscopic view of the failure detection pattern formed by the black nozzle row (K) 311. With FIG. 31A, for purposes of explanation, the dot row is enlarged for depiction, but when we macroscopically view the failure detection pattern constituted from a large number of minute dot rows, this is visible as a black band pattern as shown in FIG. 31B. In the drawing, nozzle #i and nozzle #j are abnormal nozzles, dot rows are not formed in the area on the continuous form S on which dot rows are supposed to be formed by the abnormal nozzles #i and #j, and a white band (continuous form S ground color) appears in the black failure detection pattern.

In other words, with this embodiment 3, based on the printing data for forming the failure detection pattern, the controller 100 has dot rows formed on each nozzle row, and has a failure detection pattern formed. Then, the nozzles for which dot rows were not formed correctly are detected as abnormal nozzles. For this, the failure detection pattern formed on the continuous form S is read to the external inspection unit 88 (scanner 71) positioned at the downstream side of the head unit 30. Then, the controller 100, based on the read results of the external inspection unit 88 (scanner 71) determines whether or not a white band such as that shown in FIG. 31B has occurred, and it detects the presence or absence of an abnormal nozzle, and the position of the abnormal nozzle (nozzle number) (details will be described later). The scanner 71 is a line sensor of the same or greater length than the nozzle rows aligned in the paper width direction, and the read resolution in the paper width direction of the scanner 71 is a dot row gap of 360 dpi or greater.

In this way, with this embodiment 3, a failure detection pattern is formed by forming dot rows along the carrying direction on each nozzle. Then, nozzles corresponding to areas on the continuous form S for which a suitable dot row was not formed are detected as abnormal nozzles.

Also, with this embodiment 3, one failure detection pattern is formed by every other nozzle in the paper width direction. This is because the nozzle pitch is minute (here, it is 720 dpi). If the failure detection pattern for which the dot row gap is the nozzle pitch (720 dpi) is formed with the dot rows by the odd numbered nozzles and the dot rows by the even numbered nozzles aligned in the paper width direction, there is the risk that the dot row formed by the adjacent nozzle can overlap. Also, depending on the paper (medium) on which the test pattern is printed, the ink can bleed easily, and there is the risk that dot rows can overlap. In this case, for example, it is possible that a portion of the dot row formed by the nozzle adjacent to the abnormal nozzle is formed in an area in which a dot row is supposed to be formed by a certain abnormal nozzle, and there could be an erroneous determination that the abnormal nozzle correctly formed a dot row.

In light of that, with this embodiment 3, a dot row is formed with every other nozzle of the nozzle rows aligned in the paper width direction, and the failure detection pattern is formed with the dot row of the adjacent nozzle displaced in the carrying direction. Specifically, the failure detection pattern by the odd numbered nozzles and the failure detection pattern by the even numbered nozzles are formed separately. By doing this, it is possible to suppress there being an effect on the dot row formed by adjacent nozzles, and it is possible to more accurately perform detection of failed nozzles. This is not limited to cases of forming different failure detection patterns with every other nozzle, and for example, it is also possible to have different detection patterns formed every two or every three nozzles with a head unit 30 for which the nozzle pitch is more narrow, for example. By doing this, it is possible to accurately perform detection of abnormal nozzles.

Also, by forming failure detection patterns for every alternate nozzle aligned in the paper width direction, and making the dot row gap in the paper width direction wider, it is possible to make the resolution in the paper width direction lower when the scanner 71 reads the failure detection pattern. Because of that, it is no longer necessary to provide a high performance scanner, making it possible to keep costs down.

### Operation During Inspection

First, based on the printing data, the controller 100 prints the failure detection pattern in the blank area of the continuous form S. For example, the failure detection pattern is printed in a blank part that does not overlap the printed image. Subsequently, the controller 100 has the failure detection pattern which is carried from the upstream side to the downstream side of the carrying direction by the carrying unit 10 read by the scanner 71, and fetches the read data. Subsequently, the controller 100 determines the presence or absence of the ejection failure by comparing the read data of the failure detection pattern and the reference data (data generated from the printing data), and also specifies abnormal nozzles having ejection failure.

### Dot Omission Detection Operation

Next, we will describe the dot omission inspection operation using FIG. 28, and FIG. 29A to FIG. 29C. Hereafter, there are parts of the inspection operation which are described briefly, but the details are the same as embodiment 2 described above.

As shown in FIG. 28, first, the controller 100 performs internal ejection inspection processing in parallel with the print processing (S201) in a state with the head 31 positioned in the printing area (see FIG. 21). The “detection processing by the second sensor” noted in the claims includes the internal ejection inspection processing of this embodiment 3.

Subsequently, based on the detection results of the head internal inspection unit 75, the controller 100 determines the presence or absence of abnormal nozzles having an ink state abnormality (S202), and when it is determined that there is no abnormal nozzle (S202: No), the head 31 is in a normal state, so processing ends as is, and when it is determined that there is an abnormal nozzle (S202: Yes), the print processing is suspended, and external ejection inspection processing is performed (S203). At this time, the controller 100 operates the head unit 30, suspends print processing for forming a printed image on the continuous form S, and forms a detection pattern in the blank area of the continuous form S. Thus, when this external ejection inspection is performed, it is necessary to form the detection pattern on the open space of the continuous form S, so compared to the internal ejection inspection performed in parallel with forming the printed image, separate time is consumed for the ejection inspection. Because of that, first, the internal ejection inspection is performed, and when an abnormal nozzle is detected, the process shifts to the external ejection inspection, and by doing this, it is possible to reduce the frequency of performing external ejection inspection for which separate time is required for inspection, so it is possible to perform dot omission inspection efficiently. Then, with this embodiment 3, external ejection inspection processing is performed on abnormal nozzles specified with the internal ejection inspection processing performed prior to that. The “detection processing by the first sensor” noted in the claims includes the external ejection inspection processing of this embodiment 3.

Subsequently, based on the detection results of the head external inspection unit 88, the controller 100 determines the presence or absence of the abnormal nozzles having the ejection failure (S204), and when it is determined there is no abnormal nozzle (S204: No), though the state of the ink inside the head 31 is abnormal, printing is actually performed normally on the printed image printed on the continuous form S without having any adverse effects (without causing dot failure locations having dot omission). Because of this, processing ends as is without performing recovery processing, and the print processing is restarted.

Meanwhile, when the controller 100 determines that there is an abnormal nozzle (S204: Yes), recovery processing is performed for recovering the abnormal nozzles for which dot omission has occurred to normal nozzles (S205). At this time, the controller 100 performs recovery processing after moving the head unit 30 from the printing area to the maintenance area by operating the carriage unit 20.

After that, when the recovery processing is completed, the controller 100 moves the head unit 30 from the maintenance area to the printing area, and restarts the print processing.

As described above, with this embodiment 3, the dot omission detection operation is performed while performing print processing, but in addition to that, it is possible to perform the dot omission detection operation even after the print processing is completed. For example, it is possible to perform the dot omission detection operation before shutting off the power of the printer main unit. It is also possible to perform the dot omission detection operation immediately after the power is turned on, before starting the print processing. This point is the same as with embodiment 2 described above.

### Effectiveness of the Printer 1 of This Embodiment

As described above, the printer 1 of this embodiment 3 is equipped with a head 31 for performing printing by ejecting ink on a medium, a head internal inspection unit 75 for detecting the state of the ink inside the head 31, a head external inspection unit 88 for detecting ejection failure of the ink outside the head 31, and based on the detection results of the head internal inspection unit 75, a controller 100 that determines whether or not to perform the detection of the head external inspection unit 88, and performs recovery processing to recover ink ejection of the head 31 according to the detection results of the head external inspection unit 88. Because of this, by performing the external ejection inspection when it is determined that there is an ink state abnormality according to the detection results of the internal ejection inspection, it is possible to specify whether or not there has actually been an adverse effect on the printed image quality, and it is possible to improve the ejection failure detection precision.

Also, by performing the external ejection inspection after performing the internal ejection inspection first, the following points become effective. For example, if the external ejection inspection is performed first, though it is possible to immediately detect whether there is actually dot omission in the printed image, it is necessary to form the detection pattern on a blank area of the continuous form S so as not to overlap the printed image, so compared to internal ejection inspection performed while forming the printed image, separate time is consumed for ejection inspection different from the image forming time. In contrast to this, with this embodiment 3, by performing the internal ejection inspection, estimating the abnormal nozzles having ejection failure, shifting to the external ejection inspection after that, and checking for the presence or absence of dot omission, the abnormal nozzle that is actually having an effect on the printed image quality is specified. By doing this, it is possible to reduce the frequency of the external ejection inspection that requires separate time for inspection, so it is possible to perform dot omission inspection efficiently.

Also, with the controller 100, internal ejection inspection using the head internal inspection unit 75 (internal sensor) is performed in parallel with print processing for printing an image on the continuous form S, and based on the detection results of the internal ejection inspection, a determination is made of whether to perform external ejection inspection using the head external inspection unit 88 (external sensor), and when it is determined to perform this, the external ejection inspection is performed, recovery processing is performed according to the detection results of the external ejection inspection, and when a power supply is turned on to supply power to the device main unit, or when that power supply is shut off, the external ejection inspection is performed without being based on the detection results of the internal ejection inspection, and the recovery processing was made to be performed according to the detection results of the external ejection inspection. In this way, in contrast to during printing, when turning the power supply on or shutting it off, it is possible to reliably perform the external ejection inspection, so it is possible to detect whether or not the ejection failure has an actual effect on the printed image.

Also, with the controller 100, external ejection inspection using the head external inspection unit 88 (external sensor) is made to be performed on abnormal nozzles determined to have ejection failure by the detection results of the internal ejection inspection using the head internal inspection unit 75 (internal sensor). By doing this, it became possible to perform the external ejection inspection using the external sensor in a shorter time than when performing it on all the nozzles.

### Embodiment 4

### Liquid Ejection Inspection Device

The liquid ejection inspection device is used in a state incorporated in the printing device. Also, when using in-process, it is also possible to constitute this as a dedicated device. With embodiment 4 described hereafter, we will describe the liquid ejection inspection device incorporated in the printing device. In specific terms, we will describe an example of an inkjet printer 1 (hereafter also simply called “printer 1”). In this case, the printer 1 is an example of a printing device, and is also an example of a liquid ejection inspection device.

### Constitution Example of Printer 1

We will describe the constitution example of the printer 1 using FIG. 32, FIG. 33A and FIG. 33B, FIG. 34A through FIG. 34C, FIG. 36A and FIG. 36B. FIG. 32 is a block diagram of the printer 1. FIG. 33A is a cross section diagram of the head. FIG. 33B is a drawing showing a nozzle array. FIG. 34A through FIG. 34C are drawings showing the positional relationship of the head 31 and the ink suction unit 50. FIG. 35 is a drawing seen from above the cap 51. FIG. 36A and FIG. 36B are drawings showing the positional relationship of the head 31 and the wiping unit 55.

The printer 1 ejects ink as an example of a liquid toward a medium such as paper, cloth, film or the like, and is connected so as to be able to communicate with the computer CP. The computer CP is able to send printing data according to an image to the printer 1 in order to have the image printed by the printer 1.

As shown in FIG. 32, the printer 1 of this embodiment has a carrying unit 10 for carrying the medium in the carrying direction, a carriage unit 20, a head unit 30, a drive signal generating unit 40, an ink suction unit 50, a wiping unit 55, a flushing unit 60, a head internal inspection unit 75, a head external inspection unit 88, a detection device group 90, and a controller 100 that controls these units and the like and manages the operation as the printer 1.

The carriage unit 20 is an item for moving the head unit 30 (head 31). This carriage unit 20 has a carriage 21 supported to be able to move back and forth in the movement direction along a guide rail, and a motor. The carriage 21 is constituted so as to move as an integrated unit with the head 31 by the driving of this motor (see FIG. 34A). The position of the carriage 21 (head 31) on the guide rail (movement direction position) can be found by the controller 100 detecting the rising edge and the falling edge of the pulse signals output from the encoder provided on the motor and counting the edges.

The head unit 30 is an item for ejecting ink on a medium carried on a platen by the carrying unit 10. This head unit 30 has a head 31 and a head control unit HC. The head 31 ejects ink toward the medium. The head control unit HC controls the head 31 based on the head control signal from the controller 100.

As shown in FIG. 33A, the head 31 has a case 32, a flow path unit 33, and a piezoelement unit 34. The case 32 is a member for housing and fixing the piezoelement PZT, and for example is produced using a non-conductive resin material such as epoxy resin.

The flow path unit 33 has a flow path forming substrate 33a, a nozzle plate 33b, and a vibration plate 33c. The nozzle plate 33b is joined on one surface of the flow path forming substrate 33a, and the vibration plate 33c is joined at the other surface. On the flow path forming substrate 33a are formed a pressure chamber 331, an ink supply path 332, and a hollow part or groove that becomes the common ink chamber 333. This flow path forming substrate 33a is produced using a silicon substrate, for example. A nozzle group consisting of a plurality of nozzles Nz is provided on the nozzle plate 33b. This nozzle plate 33b is produced using a plate shaped member having conductivity, such as a thin metal plate, for example. Also, the nozzle plate 33b is connected to a ground line and is at ground potential.

A diaphragm part 334 is provided at the part corresponding to each pressure chamber 331 of the vibration plate 33c. This diaphragm part 334 is deformed by the piezoelement PZT, and changes the capacity of the pressure chamber 331. By interposing the vibration plate 33c, an adhesion layer or the like, the piezoelement PZT and the nozzle plate 33b are in an electrically insulated state.

The piezoelement unit 34 has a piezoelement group 341 and a clamping plate 342. The piezoelement group 341 has a comb tooth shape. Then, each individual comb tooth is a piezoelement PZT.

The tip end surface of each piezoelement PZT is adhered to the island part 335 that the corresponding diaphragm part 334 has. The clamping plate 342 supports the piezoelement group 341, and also is an attachment part for the case 32. The piezoelement PZT is an example of an electromechanical conversion element, and when the drive signal COM is applied, it expands and contracts in the length direction, and gives a pressure change to the liquid inside the pressure chamber 331. Changes in pressure are caused for the ink inside the pressure chamber 331 due to changes in the capacity of the pressure chamber 331. Using this pressure change, it is possible to eject ink drops from the nozzles Nz. Instead of the piezoelement PZT as the electromechanical conversion element, it is also possible to constitute this by ejecting ink drops by generating air bubbles according to the applied drive signals COM.

As shown in FIG. 33B, a plurality of nozzle rows for which 180 nozzles (#1 to #180) are aligned with a gap of 180 dpi along the carrying direction of the medium are provided on the nozzle plate 33b. Each nozzle row ejects ink of respectively different colors, and for example four nozzle rows are provided on this nozzle plate 33b. In specific terms, these are the black ink nozzle row K, the cyan ink nozzle row C, the magenta ink nozzle row M, and the yellow ink nozzle row Y.

The drive signal generating unit 40 is an item for generating drive signals COM. When the drive signals COM are applied to the piezoelement PZT, the piezoelement expands and contracts, and the capacity of the pressure chamber 331 corresponding to each nozzle Nz changes. Because of that, the drive signals COM are applied to the head 31 during print processing, during internal ejection inspection processing or during external ejection inspection processing described later, during flushing processing performed on dot omission nozzles Nz and the like.

As shown in FIG. 34A to FIG. 34C and FIG. 35, the ink suction unit 50 has a cap 51 and a slider member 52 that supports the cap 51 and also can move in an inclined vertical direction. The cap 51 has a side wall part 511 that stands up from the bottom part of the rectangle (not illustrated) and the peripheral edge of the bottom part, and has a thin box shape for which the top surface is open facing opposite the nozzle plate 33b. A sheet shaped moisture retaining member produced using a porous member such as felt, a sponge or the like is arranged in the hollow part enclosed by the bottom part and the side wall part 511. A waste fluid tube 58 is connected to the bottom part of the cap 51, and a suction pump (not illustrated) is connected midway in the waste fluid tube 58.

As shown in FIG. 34A, in a state with the carriage 21 separated from the home position (here, this is the right side in the movement direction), the cap 51 is positioned at a position sufficiently lower than the surface of the nozzle plate 33b (hereafter also called the “nozzle surface”). Also, as shown in FIG. 34B, when the carriage 21 moves to the home position side, the carriage 21 contacts the contact part 53 provided on the slider member 52, and the contact part 53 moves to the home position side together with the carriage 21. When the contact part 53 moves to the home position side, the slider member 52 rises along the guiding slot 54, and the cap 51 rises along with that. Finally, as shown in FIG. 34C, when the carriage 21 is positioned in the home position, the side wall part 511 (porous member) of the cap 51 and the nozzle plate 33b are adhered. In other words, the opening edge of the cap 51 is in a state in contact with the nozzle surface.

Working in this way, when the side wall part 511 of the cap 51 and the nozzle surface are in an adhered state, the ink suction unit 50 is able to perform pump suction. Specifically, with the ink suction unit 50, when the suction pump (not illustrated) is operated in a state with the side wall part 511 of the cap 51 and the nozzle surface adhered, it is possible to make the empty space of the cap 51a negative pressure, so it is possible to suction the ink inside the head 31 together with the air bubbles mixed in inside the head (inside the nozzles). By doing this, it is possible to recover the dot omission nozzle.

The wiping unit 55 has a wiper that is able to contact the nozzle surface of the head 31. The wiper 56 is constituted from an elastic member having flexibility, and is provided on the end part of the cap 51 (see FIG. 34A). The wiper 56 of this embodiment 4, when the cap 51 is maintained in the state shown in FIG. 34B, is arranged in a state projecting further upward than the side wall part 511 of the cap 51. Specifically, as shown in FIG. 36A, the tip end part of the wiper 56 is positioned more to the upper side than the nozzle surface. After that, as shown in FIG. 36B, when the carriage 21 (head 31) is moved in the movement direction (arrow direction in the drawing) by the drive of the motor, the tip end part of the wiper 56 contacts the nozzle surface of the head 31 and bends, and cleans (wipes) the front surface of the nozzle surface. By doing this, the wiping unit 55 is able to remove foreign matter such a paper dust or the like adhered to the nozzle surface, so it is possible to eject ink normally from the nozzle that was clogged by that foreign matter.

The flushing unit 60 is an item for receiving and pooling ink ejected by the head 31 performing the flushing operation. As shown in FIG. 34B, this flushing operation is an operation whereby in a state with a slight gap left open between the nozzle surface and the opening edge of the cap 51, drive signals that are unrelated to the image to be printed are applied to the drive element (piezoelement), and ink is forcibly, continuously ejected from the nozzle. By doing this, it is possible to prevent the ink inside the head (inside the nozzles) from thickening and drying, and not being able to have a suitable volume of ink ejected, so it is possible to recover the clogged nozzles from their non-ejecting state.

The head internal inspection unit 75 is an item for inspecting the state of the ink inside the head 31. Specifically, this head internal inspection unit 75 functions as an internal sensor for detecting the state of the ink inside the head 31 during the internal ejection inspection described later. A detailed description will be given later regarding the specific constitution and the like of this head internal inspection unit 75. The “second sensor” in the claims includes the internal sensor of this embodiment 4.

The head external inspection unit 88 is an item for inspecting whether or not ink has been ejected to outside the head 31. Specifically, this head external inspection unit 88 functions as an external sensor for detecting ink ejection failure outside the head 31 during the external ejection inspection described later. A detailed description will be given later of the specific constitution and the like of this head external inspection unit 88. The “first sensor” in the claims includes the external sensor of this embodiment 4.

The controller 100 is a control unit for performing control of the printer 1. As shown in FIG. 32, this controller 100 has an interface unit 101, a CPU 102, a memory 103, and a unit control circuit 104. The interface unit 101 is an item for performing sending and receiving of data between the host computer CP which is an external device and the printer 1. The CPU 102 is an arithmetic processing device for performing overall control of the printer 1. The memory 103 is an item for ensuring an area for storing the programs of the CPU 102, a work area, and the like. The CPU 102 controls each unit using the unit control circuit 104 according to the program stored in the memory 103.

The detection device group 90 is an item for monitoring the status inside the printer 1, and for example is a rotary encoder used for control such as media carrying or the like, a paper detection sensor for detecting the presence or absence of a carried medium, a linear encoder for detecting the movement direction position of the carriage 21 (or head 31) or the like.

### Head Internal Inspection Unit 75

Here, we will describe the head internal inspection unit 75. The head internal inspection unit 75 is an internal sensor for detecting the state of the ink inside the head 31 during the internal ejection inspection described later.

### Ejection Inspection Principle

As shown in FIG. 33A, when the drive signals COM are applied to the piezoelement PZT, the piezoelement PZT is bent and the vibration plate 33c vibrates. Even when applying of the drive signals COM to the piezoelement PZT is stopped, residual vibration occurs with the vibration plate 33c. When the vibration plate 33c vibrates due to the residual vibration, the piezoelement PZT vibrates according to the residual vibration of the vibration plate 33c and outputs signals. Thus, residual vibration is generated at the vibration plate 33c, and by detecting the signals generated at the piezoelement PZT at that time, it is possible to find the characteristics (frequency characteristics) of each piezoelement PZT.

In specific terms, when drive signals COM output from the drive signal generating unit 40 are applied to the corresponding piezoelement PZT, the vibration plate 33c in contact with that piezoelement PZT vibrates. The vibration of that vibration plate 33c does not stop right away, and a residual vibration occurs. Because of this, the piezoelement PZT vibrates according to the residual vibration and outputs signals (reverse voltage). Then, those signals are input to the head internal inspection unit 75. The head internal inspection unit 75 detects the frequency characteristics of that piezoelement PZT based on the input signals. If that process is performed in sequence on the piezoelements PZT corresponding to each nozzle it is possible to detect the frequency characteristics of each piezoelement PZT. The frequency characteristics detected in this way differ according to the state of the ink inside the head 31 (normal, air bubbles mixed in, ink thickened, adherence of paper dust). Specifically, the vibration pattern of the residual vibration differs according to the state of the ink inside the head 31 (normal, air bubbles mixed in, ink thickened, adherence of paper dust).

### Constitution

FIG. 37 is an explanatory drawing of the constitution of the head internal inspection unit 75. The head internal inspection unit 75 has an amplifier 701 and a pulse width detection unit 702.

With the amplifier 701, the low frequency elements contained in the signals from the piezoelement 341 are removed by a high pass filter consisting of a capacitor C1 and a resistor R1, and amplification is done by the operating amp 701a at a designated amplification rate. Next, the output of the operating amp 701a is converted to signals that vibrate vertically with the reference voltage Vref at the center by passing through the high pass filter consisting of the capacitor C2 and the resistor R4. Then, this is compared with the reference voltage Vref by the comparator 701b, and the signal is binarized according to whether or not it is higher than the reference voltage Vref.

### Operation During Inspection

FIG. 38A is a drawing showing a signal output according to residual vibration by the piezoelement PZT. The frequency characteristics differ according to the state of the ink inside the head (normal, air bubbles mixed in, ink thickened, adherence of paper dust), so unique voltage waveforms (vibration pattern) corresponding to the respective ink states are output.

FIG. 38B is a drawing showing the signal after the output of the operating amp 701a passes through the high pass filter consisting of the capacitor C2 and the resistor R4, and the reference voltage Vref. Specifically, these are the signals input to the comparator 701b.

FIG. 38C is a drawing showing the output signals from the comparator 701b. Specifically, these are the signals input to the pulse width detection unit 702.

When the pulse shown in FIG. 38C is input, the pulse width detection unit 702 resets the count value with the rising edge of the pulse, increments the count value for each clock signal thereafter, and outputs the count value with the rising edge of the next pulse to the CPU 102 of the controller 100. Based on the count value output by the pulse width detection unit 702, specifically, based on the detection results output from the head internal inspection unit 75, the CPU 102 is able to detect the cycle of the signals output by the piezoelement PZT.

As described above, by the head internal inspection unit 75 outputting a vibration pattern having frequency characteristics according to the residual vibration, the controller 100 is able to specify the state of the ink inside the head (whether it is normal, whether an ejection failure is occurring due to mixing in of air bubbles inside the head, whether ejection failure is occurring due to ink thickening, or whether foreign matter such as paper dust or the like is adhering to the nozzle Nz), so it is possible to perform a suitable recovery operation corresponding to that respective ink state.

### Head External Inspection Unit 88

Next, we will describe an example of the constitution of the head external inspection unit 88. The head external inspection unit 88 is an external sensor that, during the external ejection inspection described later, actually ejects ink from each nozzle, and detects nozzles with dot omission by whether or not ink is ejected normally.

### Constitution

FIG. 39A is a drawing for describing the constitution of the head external inspection unit 88. FIG. 39B is a block diagram for describing the detection control unit 87.

As shown in FIG. 39A, the head external inspection unit 88 has a detection electrode 513, a high voltage power supply unit 81, a first limiting resistor 82, a second limiting resistor 83, a detection capacitor 84, an amplifier 85, a smoothing capacitor 86, and a detection control unit 87. The nozzle plate 33b of the head 31 is grounded, and functions as a portion of the head external inspection unit.

As shown in FIG. 34B and FIG. 39A, with the external ejection inspection processing described later, the cap 51 is arranged so as to face opposite the nozzle surface with a designated gap d left open. As shown in FIG. 35, inside the empty space enclosed by the side wall part 511 of the cap 51 are installed the moisture retention member 512 and the wire shaped detection electrode 513. Because of this, the nozzle plate 33b and the detection electrode 513 are arranged facing opposite with a designated gap d left open.

This detection electrode 513 is set to a high potential of approximately 600 V to 1 kV during the external ejection inspection processing described later. Then, as shown in FIG. 35, the detection electrode 513 has a frame part provided in a double rectangular shape, a diagonal line part connecting the opposite corners of the frame part, and a cross part that connects the center points of each side of the frame part. With this constitution, charge is implemented uniformly across a broad scope. Also, with a liquid having conductivity (e.g. water) as the ink solvent of this embodiment 4, when the detection electrode 513 is set to a high potential in a state with the moisture retaining member 512 in a retaining state, the front surface of the moisture retaining member 512 also has the same electric potential. At this point as well, the area for which ink is ejected from the nozzles is uniformly charged across a broad scope.

The high voltage power supply unit 81 is a power supply for which the detection electrode inside the cap 51 is set to a designated electric potential. The high voltage power supply unit 81 of this embodiment 4 is constituted by a direct current power supply of approximately 600 V to 1 kV, and the operation is controlled by the control signals from the detection control unit 87.

The first limiting resistor 82 and the second limiting resistor 83 are arranged between the output terminal of the high voltage power supply unit 81 and the detection electrode 513, and limit the current flowing between the high voltage power supply unit 81 and the detection electrode 513. With this embodiment 4, the first limiting resistor 82 and the second limiting resistor 83 have the same resistance value (e.g. 1.6 MΩ), and the first limiting resistor 82 and the second limiting resistor 83 are connected serially. As shown in the drawing, one end of the first limiting resistor 82 is connected to the output terminal of the high voltage power supply unit 81, the other end is connected to one end of the second limiting resistor 83, and the other end of the second limiting resistor 83 is connected to the detection electrode 513.

The detection capacitor 84 is a device for extracting electric potential change elements of the detection electrode 513, and one conductor is connected to the detection electrode 513, while the other conductor is connected to the amplifier 85. By interposing the detection capacitor 84 between these, it is possible to eliminate the bias element (direct current element) of the detection electrode 513, making it easier to handle signals. With this embodiment 4, the capacity of the detection capacitor 84 is 4700 pF.

The amplifier 85 amplifies signals that appear at the other end of the detection capacitor 84 (electric potential change) and outputs them. The amplifier 85 of this embodiment 4 is constituted by an item having an amplification rate of magnitude 4000. As a result, it is possible to fetch voltage signals having a change width of approximately 2 to 3 V for the potential change element. A set of the detection capacitor 84 and the amplifier 85 correlates to one type of detector unit, and detects electrical changes that occur with the detection electrode 513 occurring due to ink drop ejection.

The smoothing capacitor 86 suppresses rapid changes in electric potential. The smoothing capacitor 86 of this embodiment 4 has one end connected to the signal line that connects the first limiting resistor 82 and the second limiting resistor 83, and the other end is connected to ground. Also, the capacity is 0.1 μF.

The detection control unit 87 performs control of the head external inspection unit 88 based on control by the controller 100. As shown in FIG. 39B, this detection control unit 87 has a register group 87a, an AD converter 87b, a voltage comparator 87c, and a control signal output unit 87d. The register group 87a is constituted by a plurality of registers. Stored in each register are the determination results for each nozzle Nz, voltage threshold values for determination, and the like. The AD converter 87b converts voltage signals (analog values) after amplification output from the amplifier 85 to digital values. The voltage comparator 87c compares the size of the amplitude value based on the voltage signal after amplification with the voltage threshold value. The control signal output unit 87d outputs control signals for controlling the operation of the high voltage power supply unit 81.

### Ejection Inspection Principle

When ink is ejected from the nozzles of the nozzle plate 33b, the electric potential of the detection electrode 513 changes, the detection capacitor 84 and the amplifier 85 detect this electric potential change, and a detection signal is output to the detection control unit 87. Even when an attempt is made to eject ink from an abnormal nozzle, the ink is not ejected to outside the head 31, so the electric potential of the detection electrode 513 does not change, and a voltage change does not appear in the detection signal.

In specific terms, the nozzle plate 33b is set to ground potential, and the detection electrode 513 arranged in the cap 51 is set to a high potential of approximately 600 V to 1 kV. The nozzle plate 33b is set to ground potential, so the ink drops ejected from the nozzle are also at ground potential. The nozzle plate 33b and the detection electrode 513 are faced opposite in a state with a designated gap d (see FIG. 39A) left open, and ink drops are ejected from the detection subject nozzles. When ink drops are ejected, the electrical changes caused on the detection electrode 513 side due to this are fetched as voltage signals SG by the detection control unit 87 via the detection capacitor 84 and the amplifier 85. Then, the detection control unit 87 judges whether or not the ink drops were ejected normally from the detection subject nozzles based on the amplitude value (electric potential change) of the voltage signals SG.

Specifically, as shown in FIG. 39A, by the nozzle plate 33b and the detection electrode 513 being arranged with a designated gap d left open, these members can be constituted so as to behave in the same manner as capacitors. It is known that typically, when the gap d of two conductors constituting a capacitor changes, the charge Q stored in the capacitor changes. When ink is ejected from the ground potential nozzle plate 33b toward the high potential detection electrode 513, the gap d between the ground potential ink drop and the detection electrode 513 changes, and as with when the gap d of the two conductors of the capacitors changes, the charge Q stored in the detection electrode 513 changes (the electrostatic capacity of the capacitors changes). Then when the electrostatic capacity of the capacitors becomes smaller, the volume of the charge that can be stored between the nozzle plate 33b and the detection electrode 513 decreases, so the surplus charge moves from the detection electrode 513 through each limiting resistor 82 and 83 to the high voltage power supply unit 81 side. Specifically, current flows toward the high voltage power supply unit 81.

Meanwhile, when the electrostatic capacity increases and the reduced electrostatic capacity returns, the charge moves from the high voltage power supply unit 81 through each limiting resistor 82 and 83 to the detection electrode 513 side. Specifically, current flows toward the detection electrode 513. By this kind of current (for convenience, this is also called ejection inspection current If) flowing, the potential of the detection electrode 513 changes. The change in electric potential of the detection electrode 513 also appears as an electric potential change of the other conductor in the detection capacitor 84 (conductor on the amplifier 85 side). Therefore, by observing the electric potential change of the other conductor, it is possible to determine whether or not ink drops were ejected.

### Operation During Inspection

FIG. 40A is a drawing showing an example of the drive signal COM used during ejection inspection, FIG. 40B is a drawing for describing the voltage signal SG output from the amplifier 85 when ink is ejected from the nozzles by the drive signal COM of FIG. 40A, and FIG. 40C is a drawing showing a voltage signal SG which is the ejection inspection result of a plurality of nozzles (#1 to #10). As shown in FIG. 40A, the drive signal COM has a plurality of drive waveforms W (e.g. 24) for ejecting ink from nozzles at the first half period TA of the repeated time T, and the intermediate electric potential at the latter half period TB is kept at a fixed electric potential. The drive signal generating unit 40 does repeated generation of a plurality of drive waveforms W (24 drive waveforms) for each repeated time T. This repeated time T correlates to the time required for one nozzle inspection.

First, drive signals COM are applied across the repeated time T to the piezoelements corresponding to certain nozzles among the inspection subjects. Having done that, at first half period TA, ink drops are continuously ejected from the nozzles that are ejection inspection subjects (e.g. 24 shots are fired). As a result, the electric potential of the detection electrode 513 changes, and the amplifier 85 outputs that electric potential change as the voltage signal SG (sine curve) shown in FIG. 40B to the detection control unit 87.

Then, the detection control unit 87 calculates the maximum amplitude Vmax (difference between the maximum voltage VH and minimum voltage VL) from the voltage signals SG of the inspection time (T) of the inspection subject nozzle, and compares the maximum amplitude Vmax and a designated threshold TH. If the ink is ejected from the inspection subject nozzle according to the drive signal COM, the electric potential of the detection electrode 513 changes, and the maximum amplitude Vmax of the voltage signal SG becomes larger than the threshold TH. Meanwhile, when ink is not ejected from the inspection subject nozzle, or the ejection volume is smaller due to clogging or the like, the electric potential of the detection electrode 513 does not change, or the amount of electric potential change is small, so the maximum amplitude Vmax of the voltage signal is the threshold TH or lower.

After the drive signal COM is applied to the piezoelement corresponding to a certain nozzle, as with the drive signals COM are applied across the repeated time T on the piezoelement corresponding to the next inspection subject nozzle, the drive signals COM are applied to the piezoelement corresponding to that nozzle across the repeated time T for each single nozzle subject to inspection. As a result, as shown in FIG. 40C, the detection control unit 87 is able to fetch the voltage signals SG for which sine curve electric potential changes occur for each repeated time T.

For example, with the results of FIG. 40C, the maximum amplitude Vmax of the voltage signal SG corresponding to the inspection time of the nozzle #5 is smaller than the threshold value TH, so the detection control unit 57 judges that the nozzle #5 is a dot omission nozzle. The maximum amplitude Vmax of the voltage signals SG corresponding to each inspection time of the other nozzles (#1 to #4, #6 to #10) is the threshold value TH or greater, so the detection control unit 87 judges that the other nozzles are normal nozzles.

### Example of Printer 1 Operation

### Overall Operation

Here, we will describe the overall operation of the printer 1. With the printer 1 of this embodiment 4, the controller 100 controls the subjects of control (carrier unit 10, carriage unit 20, head unit 30, drive signal generating unit 40, ink suction unit 50, wiping unit 55, flushing unit 60, head internal inspection unit 75, and head external inspection unit 88) according to the computer program stored in the memory 103, and performs each process. Therefore, this computer program has codes for controlling the control subjects in order to execute these processes.

In specific terms, with print processing, the controller 100 performs printing instruction receiving, the paper feeding operation, the dot formation operation, the carrying operation, the paper ejection decision, and the print end decision, and with the dot omission inspection process, it performs the dot omission inspection operation and the recovery operation. Following, we will give a brief description of each process.

The printing instruction receiving is a process of receiving printing instructions from the computer CP. With this process, the controller 100 receives printing instructions via the interface unit 101.

The paper feeding operation is an operation that moves the medium which is subject to printing, and positions it in the printing start position (so-called cueing position). With this operation, the controller 100 moves the medium by driving the carrying motor.

The dot forming operation is an operation for forming dots on the medium. With this operation, the controller 100 drives the carriage 21 or outputs control signals to the head 31. At this time, by the drive signals COM generated by the drive signal generating unit 40 being applied to the piezoelement PZT, ink is ejected from the nozzle Nz. By doing this, ink is intermittently ejected from the nozzles Nz while the head 31 is moving, and dots are formed on the medium.

The carrying operation is an operation of moving the medium in the carrying direction. The controller 100 is able to form dots at positions different from the dots formed by the previous dot forming operation by driving the carrying motor.

The print end judgment is a judgment of whether or not to continue printing. The controller 100 performs the print end judgment based on the presence or absence of print data on the medium which is the printing subject.

The dot omission inspection operation is an operation for inspecting the presence or absence of ejection failure (dot omission). At a designated timing for which print processing has not been performed, the controller 100 fetches the detection results from the head internal inspection unit 75 and the detection results from the head external inspection unit 88, and based on a combination of these detection results, selects a suitable recovery operation from among a plurality of preset types of recovery operations. We will give a detailed description of this dot omission inspection operation later.

The recovery operation is an operation of recovering a certain head 31 in an ejection failure state to a state in which it can eject ink normally. The controller 100 performs any of the operations including the flushing operation, the ink suction operation, and the wiping operation according to the cause of the ejection failure.

Here, with the printer 1 of this embodiment 4, performing the recovery operation according to the cause of the ejection failure has advantages such as the following.

When respectively performing the flushing operation, the ink suction operation, and the wiping operation, the volume of ink consumed for recovery differs respectively. For example, since the wiping operation is an operation of cleaning (wiping) the nozzle surface with a wiper 56, the ink volume consumed for recovery is a minimum amount. On the other hand, since the flushing operation is an operation of spitting out ink within the head together with thickened and dried ink, the volume of ink consumed for recovery is greater than the consumed ink volume during the wiping operation. Also, the ink suction operation is an operation of suctioning the ink within the head together with the mixed in air bubbles, and the volume of ink consumed for recovery is even greater than the consumed ink volume during the flushing operation. Because of this, for example, when ejection failure occurs due to paper dust adhering to the nozzle surface, if the flushing operation or ink suction operation is selected despite being able to do recovery by selecting the wiping operation, there is a waste of ink volume consumed for recovery.

Because of this, with the printer 1 of this embodiment 4, when a suitable recovery operation is selected from among a plurality of preset types of recovery operation based on a combination of the head internal inspection unit 75 detection results and the head external inspection unit 88, it is possible to suppress wasted ink consumption.

### Dot Omission Detection Operation

Next, we will describe the dot omission inspection operation using FIG. 41A to FIG. 41D, FIG. 42, and FIG. 43. FIG. 41A is a drawing showing the state with air bubbles mixed in. FIG. 41B is a drawing showing the state with the ink thickened and dried. FIG. 41C is a drawing showing the state with foreign matter such as paper dust or the like adhered to the nozzle. FIG. 41D is a drawing showing the state with foreign matter such as paper dust or the like adhered near the nozzle. FIG. 42 is a flow chart showing an example of the dot omission inspection operation. FIG. 43 is a drawing for describing the determination conditions for the dot omission inspection operation.

As shown in FIG. 42, first, the controller 100 performs the internal ejection inspection processing (S301) on the head 31 in a state with the head 31 positioned in the home position (see FIG. 34C). With this internal ejection inspection processing, the presence or absence of ejection failure (dot omission) due to the ink state within the head is inspected by fetching the detection results of the head internal inspection unit 75. Then, using this internal ejection inspection, the controller 100 is able to fetch as the detection results of the head internal inspection unit 75 any of the results including that the ink state is normal (no dot omission), that ejection abnormality has occurred due to air bubbles mixing in (see FIG. 41A), that ejection abnormality has occurred due to ink thickening and drying (see FIG. 41B), and that ejection abnormality has occurred due to foreign matter such as paper dust or the like adhering to the nozzle Nz (see FIG. 41C). The “detection processing by the second sensor” noted in the claims includes the internal ejection inspection processing of this embodiment 4.

Subsequently, the controller 100 performs external ejection inspection processing (S302). With this external ejection inspection processing, by fetching the detection results of the head external inspection unit 88, inspection is done of the presence or absence of ejection failure (dot omission) due to ink drops not being ejected to outside the head. Then, with this external ejection inspection, it is possible for the controller 100 to fetch as the detection results of the head external inspection unit 88 either of the following results: that the ink drops are being ejected normally to outside the head (no dot omission), or that the ink drops are not being ejected normally to outside the head (there is dot omission). The “detection processing by the first sensor” noted in the claims includes the external ejection inspection processing of this embodiment 4.

Subsequently, from the detection results of the head internal inspection unit 75 fetched by the internal ejection inspection processing and the detection results of the head external inspection unit 88 fetched by the external ejection inspection processing, the controller 100 selects a suitable recovery operation according to the presence or absence of ejection failure (dot omission) based on the determination conditions. As shown in FIG. 43, the determination conditions are set such that a suitable recovery operation is selected for each combination of the internal ejection inspection detection results and the external ejection inspection detection results.

In specific terms, at step S303, with the controller 100, when it is determined from the combination of the internal ejection inspection detection results and the external ejection inspection detection results that the determination result is No. 1, specifically, when as shown in FIG. 43, it is determined that the following determination conditions have been met: the internal ejection inspection results are normal (“O”: No dot omission) and the external ejection inspection results are normal (“O”: No dot omission), this is a normal state for which ejection failure has not occurred at the head 31, so processing ends as is.

Subsequently, at step S303, with the controller 100, when it is determined that the determination results are any of No. 2, 3, or 4 from the combination of the internal ejection inspection detection results and the external ejection inspection detection results, then re-inspection is performed. Specifically, as shown in FIG. 43, when it is determined that any of the following determination conditions are satisfied: the determination conditions that the internal ejection inspection results are abnormal due to air bubbles being mixed in (“X (air bubbles)”: There is dot omission), and the external ejection inspection results are normal (“O”: No dot omission), the determination conditions that the internal ejection inspection results are abnormal due to ink thickening (“X (thickening)”: There is dot omission) and the external ejection inspection results are normal (“O”: No dot omission), or the determination conditions that the internal ejection inspection results are abnormal due to paper dust adherence (“X (paper dust adherence)”: There is dot omission) and the external ejection inspection results are normal (“O”: No dot omission), the process returns to step S301 and re-inspection is performed.

At this time, when it is determined that the determination result is No. 2, the controller 100 is able to detect that there is an abnormal state due to air bubbles being mixed in by the internal ejection inspection (see FIG. 41A), and to detect that there is a normal state by the external ejection inspection. Also, when it is determined that the determination result is No. 3, it is possible to detect that there is an abnormal state due to ink thickening by the internal ejection inspection (see FIG. 41B), and to detect that there is a normal state by the external ejection inspection. Also, when it is determined that the determination result is No. 4, it is possible to detect that there is an abnormal state due to paper dust adherence by the internal ejection inspection (see FIG. 41C), and to detect that there is a normal state by the external ejection inspection.

In this way, when it is determined that the determination result is any of No. 2, 3, or 4, in other words, when it is determined that the internal ejection inspection results are abnormal, and the external ejection inspection results are normal, there is a conflict of the respective results, so a re-inspection is set to be performed. As a result, it is possible to improve the dot omission inspection precision, and since a recovery operation does not have to be performed immediately, it is possible to suppress wasted ink consumption.

Subsequently, at step S303, with the controller 100, when it is determined that the determination result is either No. 5 or No. 8 from the combination of the internal ejection inspection detection results and the external ejection inspection detection results, the wiping process is performed (S304). Specifically, as shown in FIG. 43, when it is determined that any of the following are satisfied: the determination conditions that the internal ejection inspection results are normal (“O”: No dot omission), and the external ejection inspection results are abnormal (“X”: There is dot omission), or the determination conditions that the internal ejection inspection results are abnormal due to paper dust adherence (“X (paper dust adherence”: There is clot omission), and the external ejection inspection results are abnormal (“X”: There is dot omission), then the wiping process is performed. With this wiping process, the recovery operation is performed by the wiping unit 55 while moving the head 31 from the home position (see FIG. 34B, FIG. 36A, and FIG. 36B), and foreign matter such as paper dust or the like is removed from the nozzle surface.

At this time, with the controller 100, when it is determined that the determination result is No. 5, it is possible to detect that there is a normal state by the internal ejection inspection, and to detect that there is an abnormal state by the external ejection inspection.

Following is the reason why in this way, even when the internal ejection inspection results are normal, and the external ejection inspection results are abnormal, in other words, when there is a conflict of the respective detection results, the wiping operation is performed without performing re-inspection.

The reason is because it is possible to determine that the state is such that ink drops were not ejected to outside the head despite the state of the ink inside the head being normal according to the combination of the results, so it is possible to infer that foreign matter such as paper dust or the like (foreign matter such as paper dust which has not adhered to the nozzles Nz) has adhered near the nozzles Nz (see FIG. 41D).

Here, if only the external ejection inspection is performed, even if the controller 100 is able to detect that the external ejection inspection results are abnormal (even if it is possible to detect that an ejection failure has occurred), it is not possible to specify the cause of the ejection failure. In other words, it is not possible to distinguish between whether the head is attached in a state with paper dust adhered to the nozzle surface such as shown in FIG. 41C, or whether it is in a state for which paper dust is not adhered such as shown in FIG. 41D. Conversely, if only the internal ejection inspection is performed, then the controller 100 is not able to detect ejection failure despite ejection failure occurring because the internal ejection inspection results have been determined to be normal. In regards to these respective disadvantages, with this embodiment 4, by combining the external ejection inspection results and the internal ejection inspection results to make a determination, it is possible to specify that the ejection failure occurred due to paper dust being attached in a state not adhered to the nozzle surface (see FIG. 41D), so it is possible to compensate for the respective disadvantages of the internal ejection inspection and the external ejection inspection, and to improve the inspection precision.

On the other hand, with the controller 100, when it is determined that the determination result is No. 8, it is possible to detect that there is an abnormal state due to adherence of paper dust by the internal ejection inspection (see FIG. 41C), and that there is an abnormal state by the external ejection inspection.

In this way, when the internal ejection inspection result is abnormal and the external ejection inspection result is also abnormal, it is possible to specify that the cause of the ejection failure is in a state for which ink drops are not ejected to outside the head by the fact that it is in a state for which paper dust is adhered to the nozzle surface (see FIG. 41C), so a wiping operation is performed without performing re-inspection.

Therefore, when there is an abnormality in the external ejection inspection results, by selecting the recovery operation (wiping operation) based on the internal ejection inspection results (paper dust adherence), a suitable recovery operation is performed according to the cause of the ejection failure, and it is possible to suppress wasteful ink volume consumption for recovery.

Subsequently, when the wiping process at step 104 ends, the process returns to step S301 and re-inspection is performed. Having re-inspection performed after the wiping process ends in this way was done for the following reason.

The reason is because when wiping the paper dust attached to the nozzle surface with the wiping process, the meniscus of the ink is broken by the wiper 56 touching the nozzle Nz, and there is the risk of dot omission occurring. By performing re-inspection after the wiping process ends in this way, it is possible to improve the dot omission detection precision.

After that, at step S303, the controller 100 performs the ink suction process (S305) when it is determined that the determination result is No. 5 from the combination of the internal ejection inspection detection results and the external ejection inspection results. Specifically, as shown in FIG. 43, when it is determined that the following determination conditions are satisfied: the internal ejection inspection results are abnormal due to air bubbles being mixed in (“X (air bubbles)”: There is dot omission), and the external ejection inspection results are abnormal (“X”: There is dot omission), the ink suction process is performed. With this ink suction process, the recovery operation using the ink suction unit 50 is performed, and the air bubbles mixed in inside the head are suctioned together with the ink inside the head.

At this time, when it is determined that the determination result is No. 6, the controller 100 is able to detect that there is an abnormal state due to air bubbles being mixed in by the internal ejection inspection, and that there is an abnormal state by the external ejection inspection.

In this way, when the internal ejection inspection result is abnormal, and the external ejection inspection result is also abnormal, it is possible to specify the cause of ejection failure as being in a state for which ink drops are not ejected to outside the head because of being in a state with air bubbles mixed in (see FIG. 41A), so the ink suction operation is made to be performed without performing re-inspection.

Therefore, when the external ejection inspection results are abnormal, by selecting the recovery operation (ink suction operation) based on the internal ejection inspection results (air bubbles mixed in), a suitable recovery operation is performed according to the cause of the ejection failure, and it is possible to suppress wasted ink volume consumed for recovery.

Subsequently, with the controller 100, at step S303, when it is determined that the determination result is No. 7 from the combination of the internal ejection inspection detection results and the external ejection inspection detection results, the flushing process is performed (S306). Specifically, as shown in FIG. 43, when it is determined that the following determination conditions are satisfied: the internal ejection inspection results are abnormal due to ink thickening (“X (thickening)”: There is dot omission), and the external ejection inspection results are abnormal (“X”: There is dot omission), the head 31 is moved to a position displaced from the home position (see FIG. 34B), and the flushing process is performed. With this flushing process, the recovery operation using the flushing unit 60 is performed, and the thickened ink is ejected to outside the head.

At this time, with the controller 100, when it is determined that the determination result is No. 7, it is possible to detect that this is an abnormal state due to ink thickening by the internal ejection inspection, and that this is an abnormal state by the external ejection inspection.

In this way, when the internal ejection inspection results are abnormal, and the external ejection inspection results are also abnormal, it is possible to specify the cause of the ejection failure as being in a state with which the ink drops are not ejected to outside the head because it is in a state with the ink thickened (see FIG. 41B), so the flushing operation was made to be done without performing re-inspection.

Therefore, when there is an abnormality with the external ejection inspection results, by selecting the recovery operation (flushing operation) based on the internal ejection inspection results (ink thickening), a suitable recovery operation is performed according to the cause of the ejection failure, and it is possible to suppress wasted ink volume consumed for recovery.

### Effectiveness of the Printer 1 of This Embodiment

As described above, the printer 1 of this embodiment 4 is equipped with a head 31 for performing printing by ejecting ink on a medium, a head internal inspection unit 75 for detecting the state of the ink inside the head 31, a head external inspection unit 88 for detecting an ink ejection failure outside the head 31, and a controller 100 for, based on the detection results of the head internal inspection unit 75 and the head external inspection unit 88, selecting from among a plurality of preset types of recovery operations a recovery operation for recovering the ejection of ink by the head 31.

When filling ink from the ink cartridge into the head and air bubbles mix in, when the ink thickens or dries because ink (liquid) has not been ejected from the nozzles Nz for a long time, or foreign matter such as paper dust or the like adheres to the nozzle Nz, clogging can occur with the nozzle Nz. When the nozzle Nz clogs in this way, ink is not ejected when ink is supposed to be ejected from the nozzle Nz, and dot omission occurs (ejection failure). Dot omission is a phenomenon whereby dots are not formed at the location at which dots are originally supposed to be formed when ink is ejected from the nozzle Nz. When dot omission occurs, it becomes a cause of image quality degradation. As described above, there are various causes of dot omission, such as air bubbles mixing in, ink thickening and drying, foreign matter such as paper dust or the like, so there are cases when it is not possible to specify this with only the internal ejection inspection (head internal inspection unit 75) or the external ejection inspection (head external inspection unit 88).

For example, with the external ejection inspection, even if it is possible to detect an abnormal state of ink drops not being ejected from the nozzle to outside the head, it is not possible to distinguish the reason for that ejection failure as being due to paper dust that is adhered to the nozzle surface (see FIG. 41C) or due to paper dust that is not adhered to the nozzle surface (see FIG. 41D). Also, with the internal ejection inspection, from the inspection results, even if it is possible to distinguish that the cause of the ejection failure is due to air bubbles mixing in (see FIG. 41A), due to ink thickening and drying (see FIG. 41B), or due to paper dust that is adhered to the nozzle surface (see FIG. 41C), it is not possible to distinguish regarding items due to paper dust that is not adhered to the nozzle surface (see FIG. 41D).

In contrast to this, with this embodiment 4, by fetching not only the external ejection inspection detection results but also the internal ejection inspection results, based on the combination of the respective detection results, it is possible to distinguish whether the cause of the ejection failure is due to paper dust that is adhered to the nozzle (see FIG. 41C) or to paper dust that is not adhered to the nozzle surface (see FIG. 41D). In this way, with the invention of this embodiment 4, when a dot omission nozzle Nz (meaning dot omission nozzles and non-ejecting nozzles) is detected based on the detection results of the head internal inspection unit 75 and the head external inspection unit 88, in order to compensate for the mutual disadvantages of the internal ejection inspection and the external ejection inspection, from the combination of the respective inspection results, the dot omission cause is specified and by selecting a recovery operation suited to the respective cause, ink is made to be properly ejected from the dot omission nozzle. As a result, it is possible for the head internal inspection unit 75 (internal sensor) and the head external inspection unit 88 (external sensor) to mutually compensate for their respective disadvantages, making it possible to improve ejection failure detection precision and also to perform suitable recovery processing.

Also, with the controller 100, when it is determined from the head internal inspection unit 75 detection results that ink ejection failure has occurred based on the state of the ink inside the head, and it is determined from the head external inspection unit 88 detection results that ink ejection failure has not occurred, the detection results of the head internal inspection unit 75 and the head external inspection unit 88 are fetched again to determine whether or not ink ejection failure has occurred. In this way, when dot omission is detected by the internal ejection inspection, and dot omission is not detected by the external ejection inspection, since there is an abnormality in the head but ink is being ejected to outside the head, by performing re-inspection, a recovery operation does not have to be done immediately, so it is possible to suppress wasted ink consumption.

Also, with the controller 100, when it is determined from the head external inspection unit 88 detection results that ink ejection failure has occurred, a recovery operation is selected from among a plurality of types of recovery operation for which the liquid volume consumed during the recovery operation differs, based on the state of the ink detected by the head internal inspection unit 75. Specifically, when dot omission is detected by both internal ejection inspection and by external ejection inspection, because there is an abnormality inside the head, ink will not be ejected to outside the head, so the recovery operation is selected so as to eliminate the cause of the dot omission detected by the internal ejection inspection. Because of this, a suitable recovery operation is performed taking into consideration the cause of the ejection failure, making it possible to suppress wasted ink consumption.

### Other Embodiments

Most of what was noted in these embodiments 1 to 4 is regarding printing devices (liquid ejection inspection devices), but a disclosure of the liquid ejection inspection method and the like is also included. Also, these embodiments are for making the invention easy to understand, and these are not to be interpreted as limiting the invention. The invention can of course be modified and improved without straying from its key points, and includes equivalents thereto. In particular, the kind of embodiments noted below are also included in the invention.

### Printing Device

With the embodiments noted above, we described examples of an inkjet printer as the printing device, but the invention is not limited to this. For example, it is also possible to be a printing device that ejects a liquid other than ink. This can be appropriated for various types of printing device equipped with a liquid spray head for ejecting tiny volumes of liquid drops. Note that liquid drops means a liquid state item ejected from the aforementioned printing device, and includes grain shaped, tear shaped, and thread shaped items with a tail. Also, what is being called liquid here can be any material as long as it can be ejected by the printing device. For example, any item is acceptable as long as it is in a state with the substance in the liquid phase, and includes high viscosity or low viscosity liquid, sol, gel water, other fluid states items such as an inorganic solvent, organic solvent, solution, liquid resin, or liquid metal (metallic melt), and includes not only liquid as the state for the substance, but also items for which particles of a functional material consisting of a solid matter such as pigment, metal particles or the like is dissolved, dispersed, or blended in a solvent.

Also, representative examples of liquids include ink such as described with the embodiments noted above, liquid crystal, or the like. Here, ink means typical water based ink and oil based ink as well as items containing various types of liquid compositions such as shellac, hot melt ink or the like. As specific examples of the printing device, for example, this can be a printing device that ejects a liquid that contains in a dispersed or dissolved form a material such as an electrode material or coloring material used in manufacturing of an EL (electro luminescence) display, surface emitting display, color filter or the like, a printing device for ejecting a bioorganic substance used for manufacturing biochips, a printing device for ejecting liquid which is a sample used as a precision pipette, a textile printing device, micro dispenser or the like. Furthermore, it can also be used as a printing device for ejecting lubricating oil with a pinpoint for precision equipment such as clocks, cameras or the like, a printing device for ejecting onto a substrate a transparent resin liquid such as ultraviolet ray curing resin or the like for forming a micro hemispheric lens (optical lens) used for an optical communication element or the like, or a printing device for ejecting an acid or alkaline etching liquid for etching a substrate or the like. It is also possible to apply the invention to any one type of the printing devices among these.

### First Sensor

With the embodiments noted above, as examples of the first inspection unit 70 (first sensor), we described an item that records a printed image on the continuous form S based on image data, reads that printed image using the scanner 71, compares the read data that was read by the scanner 71 with reference data, and detects nozzle ejection failure, but the invention is not limited to this. For example, it is not limited to using a scanner 71, but can also use an imaging device such as a line sensor camera or the like.

Also, with the embodiments noted above, we described an item that generates read data by reading the printed image as is with the scanner 71, but the invention is not limited to this. For example, it is also possible to make it so that when printing an image on the continuous form S, an inspection pattern is printed in an empty area between two printed images, and to read this inspection pattern using the scanner 71. This inspection pattern is printed divided into each ink color, so compared to printed images for which the colors exist mixed, it is possible to make it easier to specify the abnormal nozzle for each ink color.

### Second Sensor

With the embodiments noted above, as an example of the second inspection unit 80 (second sensor), we described an item for which an actuator such as a piezoelement or the like made a vibration plate vibrate, and detected changes in the frequency characteristics (vibration pattern) of the residual vibration that occurs with this vibration plate (FIG. 12 and FIG. 13), but the invention is not limited to this.

For example, it is also possible to use a detection device having a light source and an optical sensor as the second sensor. In specific terms, this detection device detects the fact that ink drops ejected from the nozzle to outside the head passed between the light source and the optical sensor, and the light between the light source and the optical sensor was blocked. Then, when the ink drop blocked the light, it is judged that the ink was ejected normally, and when the ink drop did not block the light, it is determined that there is ejection failure (dot omission). Then, this determination is performed for each respective nozzle.

Also, as another example of the second inspection unit 80, it is possible to make it so that charged ink drops are ejected from the nozzle toward an inspection electrode, and the electrical changes that occur with this electrode are detected. Following, we will give a detailed description about this other example of the second inspection unit 80.

### Constitution

FIG. 18A is a drawing for describing another example of the constitution of the second inspection unit 80, and FIG. 18B is a block diagram for describing the detection control unit 87.

As shown in FIG. 18A, the second inspection unit 80 has the detection electrode 513, the high voltage power supply unit 81, the first limiting resistor 82, the second limiting resistor 83, the detection capacitor 84, the amplifier 85, the smoothing capacitor 86, and the detection control unit 87. The nozzle plate 33b of the head 31 is grounded, and also functions as a portion of the second inspection unit 80.

During the previously described second inspection processing, as shown in FIG. 18A, the nozzle plate 33b and the detection electrode 513 are arranged so as to face opposite with a designated gap d left open.

This detection electrode 513 is set to a high potential of approximately 600 V to 1 kV during the previously described second inspection processing.

The high voltage power supply unit 81 is a power supply for making the detection electrode 513 a designated electric potential. This high voltage power supply 81 is constituted by a direct current power supply of approximately 600 V to 1 kV, and the operation is controlled by control signals from the detection control unit 87.

The first limiting resistor 82 and the second limiting resistor 83 are arranged between the output terminal of the high voltage power supply unit 81 and the detection electrode 513, and these limit the current that flows between the high voltage power supply unit 81 and the detection electrode 513. Here, the first limiting resistor 82 and the second limiting resistor 83 have the same resistance value (e.g. 1.6 MΩ), and the first limiting resistor 82 and the second limiting resistor 83 are connected serially. As shown in FIG. 18A, one end of the first limiting resistor 82 is connected to the output terminal of the high voltage power supply unit 81, the other end is connected to one end of the second limiting resistor 83, and the other end of the second limiting resistor 83 is connected to the detection electrode 513.

The detection capacitor 84 is a device for extracting the electric potential change element of the detection electrode 513, where one conductor is connected to the detection electrode 513, and the other conductor is connected to the amplifier 85. By interposing a detection capacitor 84 between these, it is possible to remove the bias element (direct current element) of the detection electrode 513, and to make it possible to handle signals easily. With this embodiment, the capacity of the detection capacitor 84 is 4700 pF.

The amplifier 85 amplifies the signals (electric potential change) that appear at the other end of the detection capacitor 84 and outputs these. This amplifier 85 is constituted by an item with an amplification rate of magnitude 4000. As a result, it is possible to fetch the potential change element as a voltage signal having a change width of approximately 2 to 3 V. The set of this detection capacitor 84 and the amplifier 85 correlates to one type of detection unit, and it detects the electrical changes that occur with the detection electrode 513 that occur due to ink drop ejection.

The smoothing capacitor 86 suppresses rapid changes in the electric potential. With the smoothing capacitor 86 of this embodiment, one end is connected to the signal line that connects the first limiting resistor 82 and the second limiting resistor 83, and the other end is connected to ground. Also, the capacity is 0.1 μF.

The detection control unit 87 performs control of the second inspection unit 80. As shown in FIG. 18A, this detection control unit 87 has a register group 87a, an AD converter 87b, a voltage comparator unit 87c, and a control signal output unit 87d. The register group 87a is constituted from a plurality of registers. In each register are stored the determination results for each nozzle Nz, the determination voltage threshold value and the like. The AD converter 87b converts the voltage signal (analog value) after amplification output from the amplifier 85 to a digital value. The voltage comparator unit 87c compares the size of the amplitude value based on the voltage signal after amplification with the voltage threshold value. The control signal output unit 87d outputs control signals for controlling the operation of the high voltage power supply unit 81.

### Ejection Inspection Principle

When ink is ejected from the nozzles of the nozzle plate 33b, the electric potential of the detection electrode 513 changes, this electric potential change is detected by the detection capacitor 84 and the amplifier 85, and the detection signals are output to the detection control unit 87. Even when an attempt is made to eject ink from the abnormal nozzles, the ink is not ejected to outside of the head 31, so the electric potential of the detection electrode 513 does not change, and a voltage change does not appear in the detection signal.

In specific terms, the nozzle plate 33b is set to ground potential, and the detection electrode 513 arranged in the cap 51 is set to a high potential of approximately 600 V to 1 kV. Because the nozzle plate 33b is set to ground potential, the ink drops ejected from the nozzle are also at ground potential. The nozzle plate 33b and the detection electrode 513 are facing opposite in a state with a designated gap d (see FIG. 18A) left open, and the ink drops are ejected from the detection subject nozzles. When the ink drops are ejected, the electrical changes that occur on the detection electrode 513 side due to this are fetched as voltage signals SG by the detection control unit 87 via the detection capacitor 84 an the amplifier 85. Then, the detection control unit 87 judges whether or not the ink drops were ejected normally from the detection subject nozzle based on the amplitude value (electric potential change) of the voltage signal SG.

Specifically, as shown in FIG. 8A, by arranging the nozzle plate 33b and the detection electrode 513 with a designated gap d left open, it is possible to constitute these members to behave as a capacitor. Typically, when the gap d of the two conductors constituting the capacitor changes, it is known that the charge Q stored in the capacitor changes. When ink is ejected from the ground potential nozzle plate 33b toward the high potential detection electrode 513, as when the gap d of the ground potential ink drops and the detection electrode 513 changes, the gap d of the two conductors of the capacitor changes, and the charge Q stored in the detection electrode 513 changes (the electrostatic capacity of the capacitor changes). Then, when the electrostatic capacity of the capacitor becomes smaller, the charge volume that can be stored between the nozzle plate 33b and the detection electrode 513 is reduced, so the surplus charge moves from the detection electrode 513 through the limiting resistors 82 and 83 to the high voltage power supply unit 81 side.

Specifically, current flows toward the high voltage power supply unit 81. Meanwhile, when the electrostatic capacity increases or the reduced electrostatic capacity returns, the charge moves from the high voltage power supply unit 81 through the limiting resistors 82 and 83 to the detection electrode 513 side. Specifically, the current flows toward the detection electrode 513. By this kind of current (for convenience, this is also called ejection inspection current If) flowing, the electric potential of the detection electrode 513 changes. The change in electric potential of the detection electrode 513 also appears as an electric potential change in the other conductor with the detection capacitor 84 (conductor on the amplifier 85 side). Therefore, by monitoring the electric potential change of the other conductor, it is possible to determine whether or not ink drops have been ejected.

### Operation During Inspection

FIG. 19A is a drawing showing an example of the drive signal COM used during ejection inspection, FIG. 19B is a drawing for describing the voltage signal SG output from the amplifier 55 when ink is ejected from the nozzles using the drive signal COM of FIG. 19A, and FIG. 19C is a drawing showing the voltage signal SG which is the ejection inspection results of a plurality of nozzles (#1 to #10). As shown in FIG. 19A, the drive signal COM has a plurality of drive waveforms W (e.g. 24) for ejecting ink from the nozzles at first half period TA of the repeated time T, and a fixed potential is maintained with the intermediate electric potential with the latter half period TB. The drive signal generating unit 40 repeatedly generates at each repeated time T the plurality of drive waveforms W (24 drive waveforms). This repeated time T correlates to the time required to do one nozzle inspection.

First, the drive signals COM are applied across the repeated time T to the piezoelement corresponding to a certain nozzle among the inspection subjects. Having done this, ink drops are continuously ejected from the nozzle subject to ejection inspection at front half period TA (e.g. 24 shots are fired). By doing this, the electric potential of the detection electrode 513 changes, and the amplifier 85 outputs that electric potential change to the detection control unit 87 as the voltage signal SG (sine curve) shown in FIG. 9B. Since the amplitude of the voltage signal SG due to one shot volume of ink drop is small, it was made possible to obtain a voltage signal SG with a sufficient amplitude for inspection by continuously ejecting ink drops from the nozzle.

Then, the detection control unit 87 calculates the maximum amplitude Vmax (the difference between the maximum voltage VH and the minimum voltage VL) from the voltage signal SG of the detection time (T) of the inspection subject nozzle, and compares the maximum amplitude Vmax with a designated threshold value TH. If ink is ejected from the inspection subject nozzle according to the drive signal COM, the electric potential of the detection electrode 513 changes, and the maximum amplitude Vmax of the voltage signal SG is greater than the threshold value TH. Meanwhile, when ink is not ejected from the inspection subject nozzle or the volume of ejected ink is low due to clogging or the like, the electric potential of the detection electrode 513 can not change or the electric potential change can be small, so the maximum amplitude Vmax of the voltage signal SG is the threshold value TH or lower.

After the drive signal COM is applied to the piezoelement corresponding to a certain nozzle, as with drive signals COM applied across the repeated time T to the piezoelement corresponding to the next inspection subject nozzle, the drive signals COM are applied to the piezoelement corresponding to that nozzle across the repeated time T for each nozzle subject to inspection. As a result, as shown in FIG. 19C, the detection control unit 87 can fetch the voltage signal SG generated by the sine curve electric potential change for each repeated time T.

For example, with the results in FIG. 19C, since the maximum amplitude Vmax of the voltage signal SG corresponding to the inspection time of the nozzle #5 is smaller than the threshold value TH, the detection control unit 87 judges that the nozzle #5 is a nozzle with dot omission. The maximum amplitude Vmax of the voltage signals SG corresponding to each inspection time of the other nozzles (#1 to #4, #6 to #10) is the threshold value TH or greater, and the detection control unit 87 judges the other nozzles to be normal nozzles.

### Recovery Processing

With the embodiments noted above, as examples of recovery processing, we described ink suction processing, wiping processing, and flushing processing, but this is not limited to these. For example, rather than performing cleaning of the abnormal nozzle specified by the dot omission inspection results, it is also possible to eject the dark colored ink from the normal nozzles existing in the abnormal nozzle range, or eject an increased volume of ink to perform a process that compensates for the dot failure locations on the continuous form S.

Also, with the embodiments noted above, we described an example of a line printer as the printing device, but this is not limited to this. For example, it is also possible to apply this to a serial printer.

### Internal Sensor

With the embodiments noted above, as an example of the head internal inspection unit 75 (internal sensor), we described an example of an item for which an actuator such as a piezoelement or the like vibrates the vibration plate, and this item detects the change in the frequency characteristics (vibration pattern) of the residual vibration that occurs with this vibration plate (FIG. 24 and FIG. 25), but this is not limited to this. For example, this is not limited to being a vibration plate, and it is also possible to detect the frequency characteristics change of the residual vibration from the vibration of the actuator itself such as the piezoelement or the like.

Also, the internal sensor is acceptable as long as it is able to inspect the state of the ink inside the head 31 (or the state of the ink before being ejected from the head 31 via the nozzle), and as an internal sensor, the signals from the piezoelement PZT to which the drive signals COM are applied can be input to the head internal inspection unit 75, as an internal sensor, the signals from the piezoelement PZT to which drive signals COM are not applied can also be input to the head internal inspection unit 75, and as an internal sensor, a sensor other than a piezoelement PZT can also be used. Also, if it is before ejection from the nozzle, it is also possible to detect the phenomenon contributing to ejection.

### External Sensor

With the embodiments noted above, as an example of the head external inspection unit 88 (external sensor), we described an example of an item for which charged ink drops are ejected from the nozzle toward the detection electrode, and it detects the electrical changes that occur with this electrode (see FIG. 26A and FIG. 26B). For example, it is also possible to use a detection device having a light source and an optical sensor as the second sensor. In specific terms, this detection device detects the fact that ink drops ejected from the nozzle to outside the head have passed between the light source and optical sensor and blocked the light between the light source and the optical sensor. Then, when the ink drop has blocked the light, it is judged that the ink has been ejected normally, and when the ink drop has not blocked the light, it is determined that there is ejection failure (dot omission). Then, this determination is performed for each respective nozzle.

Also, it also possible to use a reading device (scanner or the like) or an imaging device (line sensor camera or the like) as the external sensor. In specific terms, it is also possible for an image to be printed on a medium based on image data, the image after printing to be read by a scanner (captured by a camera), the read data read by the scanner (imaging data captured by the camera) and image data to be compared, and to detect nozzle ejection failure. Alternatively, it is also possible to detect the state of the liquid after being ejected from the head 31 via the nozzle, and after being ejected from the head 31, to detect phenomena due to ejection.

### Dot Omission Detection Operation

With embodiment 4, we described an example when the dot omission detection operation is performed at a designated timing without performing the print processing, but this is not limited to this, and for example it is also possible to perform the dot omission detection operation midway while performing the print processing.

The entire disclosure of Japanese Patent Application No. 2011-257169, filed Nov. 25, 2011, 2011-257998, filed Nov. 25, 2011 and 2011-257999, filed Nov. 25, 2011 are expressly incorporated by reference herein.

What is claimed is:

1. A liquid ejection device, comprising:
a head being configured to eject liquid on a medium,
a first sensor being configured to detect liquid ejection of the head by using a first principle,
a second sensor being configured to detect the liquid ejection by using a second principle being different from the first principle
a recovery unit being configured to recover the liquid ejection of the head, and
a controller being configured to control the first sensor and the second sensor, and control the recovery unit based on a first detection result by the first sensor and a second detection result by the second detector.

2. The liquid ejection device according to claim 1, wherein
the controller is configured to determine, on the basis of the first detection result, whether or not the second sensor starts detecting the liquid ejection.

3. The liquid ejection device according to claim 2, wherein
the controller is configured to determine, on the basis of the second detection result, whether or not the recovery unit starts recovering the liquid ejection, and
the controller is configured to determine, on the basis of the second detection result, whether or not the second sensor starts detecting the liquid ejection for a second time.

4. The liquid ejection device according to claim 2, wherein
the controller is configured to control the second sensor to detect the liquid ejection for a second time when the first sensor confirms an abnormal nozzle, and when the second sensor confirms no abnormal nozzle in the first time.

5. The liquid ejection device according to claim 2, wherein
the controller is configured to control the recovery unit to recover the liquid ejection when both the first and second sensors confirm an abnormal nozzle, and when a position of the abnormal nozzle detected by the first sensor is matched to a position of the abnormal nozzle detected by the second nozzle.

6. The liquid ejection device according to claim 2, wherein
the controller is configured to control the second sensor to detect the liquid ejection for a second time when the first and second sensors confirm an abnormal nozzle, and when a position of the abnormal nozzle detected by the first sensor is matched to a position of the abnormal nozzle detected by the second nozzle.

7. The liquid ejection device according to claim 1, wherein
the controller is configured to determine whether or not the first sensor starts detecting the liquid ejection based on the second detection result.

8. The liquid ejection device according to claim 7, wherein
the controller is configured to determine whether or not the recovery unit recovers the liquid ejection based on the first detection result.

9. The liquid ejection device according to claim 7, wherein
the controller is configured to control the first sensor to detect the liquid ejection and the second sensor not to detect the liquid ejection when power is supplied to a device main unit.

10. The liquid ejection device according to claim 7, wherein
the controller is configured to control the first sensor to detect the liquid ejection and the second sensor not to detect the liquid ejection when power is supplied to a device main unit.

11. The liquid ejection device according to claim 1, wherein
the controller is configured to select a recovery process performed by the recovery unit from among a plurality of types of recovery processes for which liquid volume consumed during each of the recovery processes differs, based on the first and second detection results.

12. The liquid ejection device according to claim 11, wherein
the controller is configured to select a recovery process performed by the recovery unit from among a plurality of types of recovery processes based on the second detection result, when the first and second sensors confirm an abnormal nozzle.

13. The liquid ejection device according to claim 11, wherein
the controller is configured to control the recovery unit to recover the liquid ejection when the first sensor confirms an abnormal nozzle, and when the second sensor confirms no abnormal nozzle.

14. The liquid ejection device according to claim 11, wherein
the controller is configured to control the first sensor to detect the liquid ejection for a second time and the second sensor to detect the liquid ejection for a second time when the second sensor confirms in the first time an abnormal nozzle, and when the first sensor confirms in the first time no abnormal nozzle.

15. The liquid ejection device according to claim 1, wherein
the controller is configured to select a recovery process by the recovery unit from among a plurality of types of recovery processes for which volume of liquid consumed by each of the recovery processes differs, based on the second detection result.

16. The liquid ejection device according to claim 1, wherein
the controller is configured to determine whether or not the liquid ejection is suspended based on the first and second ejection results.

17. The liquid ejection device according to claim 1, wherein
the controller is configured to determine whether or not the liquid ejection is suspended based on only one of the first and second detection results.

18. The liquid ejection device according to claim 1, wherein
the controller is configured to control the first and second sensors to detect the liquid ejection in parallel with ejecting by the head.

19. The liquid ejection device according to claim 1, wherein
the controller is configured to control the second sensor to detect the liquid ejection in parallel with ejecting by the head, and control the first sensor not to detect the liquid ejection.

20. The liquid ejection device according to claim 1, wherein
the second sensor is configured to detect a state of liquid within the head.

21. The liquid ejection device according to claim 1, wherein
the first sensor is configured to detect a state of liquid after being ejected from the head.

22. A liquid ejection method, wherein
detecting liquid ejection by a head by using a first principle;
detecting the liquid ejection of the head by using a second principle different from the first principle; and
recovering the liquid ejection of the head based on a first detection result by the detecting with the first principle and a second detection result by the detecting with the second principle.

23. The liquid ejection method according to claim 22, further comprising
determining whether or not the detecting with the second principle is performed based on the first detection result.

24. The liquid ejection method according to claim 22, further comprising
determining whether or not the detecting with the first principle is performed based on the second detection result.

25. The liquid ejection method according to claim 22, wherein
the recovering is selected from among a plurality of types of recovering for which volume of liquid consumed during each of the plurality of recovering differs, based on the first and second detection results.
